(19) United States
(12) Patent Application Publication
(10) Pub. No.: US 2026/0273771 A1
(43) Pub. Date: Sep. 17, 2026

(54) DISHWASHER LOADING AND UNLOADING ROBOT

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/555,199

(22) Filed: Mar. 3, 2026

Related U.S. Application Data
(63) Continuation-in-part of application No. 19/315,315, filed on Aug. 29, 2025.
(60) Provisional application No. 63/688,607, filed on Aug. 29, 2024.

(51) Int. Cl. B25J 11/00; B25J 9/16

(52) U.S. Cl. CPC B25J 11/0085; B25J 9/163; A47L 2201/00

(57) ABSTRACT

A method and system for a tidying robot to learn and perform cleaning tasks. The method involves identifying objects and parts in an environment, detecting landmarks and affordance heatmaps to visualize manipulation points, determining tasks and evaluating attributes, selecting contact points, planning robot motions, recording task progress, and logging successes or failures. A learned skill is created by collecting successful demonstrations of a task and saving the robot's actions as a learned skill. The learned skill is then configured into a robotic control system of the tidying robot, which can be invoked to perform the learned task.

### CROSS-REFERENCE TO RELATED APPLICATIONS

This application is a continuation-in-part of U.S. application Ser. No. 19/315,315, filed on Aug. 29, 2025, and claims priority and benefit under 35 U.S.C. 119 to U.S. provisional application Ser. No. 63/688,607, filed on Aug. 29, 2024, each of which is incorporated herein by reference in its entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

### SUMMARY

A method for a tidying robot to perform tasks involves several steps. First, the robot identifies objects and parts of objects in its environment using a capture and containment system. The system includes a scoop, pusher pads, pusher pad arms, a gripper arm, and a lifting column.

The robot then detects distinctive points, called landmarks, on the objects and their parts, and highlights them using affordance heatmaps. This allows the robot to execute actions to manipulate the objects and their parts.

Next, the robot determines the tasks needed to complete a work strategy in the imaged environment. It evaluates the attributes of each task step, selects specific contact or manipulation points available under step constraints, and plans robot motions to perform the robot actions of the task step.

The robot records task progress and logs task step success or failure. The robot can also perform tasks autonomously by invoking a learned skill. To learn a skill, the robot collects a successful demonstration of the skill, saves the series of robot actions performed as a learned skill, and configures the robotic control system to perform the learned skill.

A tidying robot is equipped with a chassis, a capture and containment system, and a robotic control system. The capture and containment system includes a scoop, pusher pads, pusher pad arms, a gripper arm, and a lifting column. The robotic control system can be configured with learned skills, allowing the robot to perform tasks autonomously.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates task step action logic 100 in accordance with one embodiment.

FIG. 2 illustrates a routine 200 in accordance with one embodiment.

FIG. 3 illustrates a runtime task step action routine 300 in accordance with one embodiment.

FIG. 4 illustrates a task configuration routine 400 in accordance with one embodiment.

FIG. 5 illustrates an open_dishwasher task 500 in accordance with one embodiment.

FIG. 6 illustrates a transfer_plate_from_dishwasher_to_scoop task 600 in accordance with one embodiment.

FIG. 7 illustrates a move_pot_to_scoop task 700 in accordance with one embodiment.

FIG. 8 illustrates a carry_pot task 800 in accordance with one embodiment.

FIG. 9 illustrates a fold pants task 900 in accordance with one embodiment.

FIG. 10 illustrates a fold shirt task 1000 in accordance with one embodiment.

FIG. 11 illustrates learning loop training approaches 1100 in accordance with one embodiment.

FIG. 12 illustrates a routine 1200 in accordance with one embodiment.

FIG. 13 illustrates an inverse reinforcement learning routine 1300 in accordance with one embodiment.

FIG. 14 illustrates a vision-action model training routine 1400 in accordance with one embodiment.

FIG. 15 illustrates a vision-language-action model training routine 1500 in accordance with one embodiment.

FIG. 16A and FIG. 16B illustrate a tidying robot 1600 in accordance with one embodiment. FIG. 16A shows a side view and FIG. 16B shows a top view.

FIG. 17A and FIG. 17B illustrate a simplified side view and top view of a chassis 1602 of the tidying robot 1600, respectively.

FIG. 18A and FIG. 18B illustrate a left side view and a top view of a base station 1800, respectively, in accordance with one embodiment.

FIG. 19A illustrates a lowered scoop position and lowered pusher position 1900a for the tidying robot 1600 in accordance with one embodiment.

FIG. 19B illustrates a lowered scoop position and raised pusher position 1900b for the tidying robot 1600 in accordance with one embodiment.

FIG. 19C illustrates a raised scoop position and raised pusher position 1900c for the tidying robot 1600 in accordance with one embodiment.

FIG. 19D illustrates a tidying robot 1600 with pusher pads extended 1900d in accordance with one embodiment.

FIG. 19E illustrates a tidying robot 1600 with pusher pads retracted 1900e in accordance with one embodiment.

FIG. 20A illustrates a lowered scoop position and lowered pusher position 2000a for the tidying robot 1600 in accordance with one embodiment.

FIG. 20B illustrates a lowered scoop position and raised pusher position 2000b for the tidying robot 1600 in accordance with one embodiment.

FIG. 20C illustrates a raised scoop position and raised pusher position 2000c for the tidying robot 1600 in accordance with one embodiment.

FIG. 21A illustrates a lowered scoop position and lowered pusher position 2100a for the tidying robot 1600 in accordance with one embodiment.

FIG. 21B illustrates a lowered scoop position and raised pusher position 2100b for the tidying robot 1600 in accordance with one embodiment.

FIG. 21C illustrates a raised scoop position and raised pusher position 2100c for the tidying robot 1600 in accordance with one embodiment.

FIG. 22 illustrates a front dump action 2300 for the tidying robot 1600 in accordance with one embodiment.

FIG. 23 illustrates a tidying robot 1600 performing a front dump in accordance with one embodiment.

FIG. 24 illustrates a tidying robotic system interaction 2400 in accordance with one embodiment.

FIG. 25 illustrates an embodiment of a robotic control system 2500 to implement components and process steps of the system described herein.

FIG. 26A-FIG. 26E illustrate an item placement procedure 2600 in accordance with one embodiment.

FIG. 27A-FIG. 27D illustrate an item removal procedure 2700 in accordance with one embodiment.

FIG. 28A-FIG. 28H illustrate an item removal procedure 2800 in accordance with one embodiment.

FIG. 29 illustrates an item removal procedure 2900 in accordance with one embodiment.

FIG. 30A-FIG. 30C illustrate an item flipping procedure 3000 in accordance with one embodiment.

FIG. 31A-FIG. 31C illustrate an item flipping procedure 3100 in accordance with one embodiment.

FIG. 32 illustrates scoop walls 3200 in accordance with one embodiment.

FIG. 33A-FIG. 33I illustrate a cutlery removal and sorting procedure 3300 in accordance with one embodiment.

FIG. 34A-FIG. 34C illustrate a cutlery sorting procedure 3400 in accordance with one embodiment.

FIG. 35 illustrates an item loading procedure 3500 in accordance with one embodiment.

FIGS. 36A-36C illustrates a keypoint identification 3600 in accordance with one embodiment.

FIG. 37 illustrates a method 3700 in accordance with one embodiment.

FIG. 38 illustrates a method 3800 in accordance with one embodiment.

FIG. 39 illustrates a method 3900 in accordance with one embodiment.

FIG. 40 illustrates a method 4000 in accordance with one embodiment.

FIG. 41 illustrates a method 4100 in accordance with one embodiment.

FIG. 42 illustrates a method 4200 in accordance with one embodiment.

FIG. 43 illustrates sensor input analysis 4300 in accordance with one embodiment.

FIG. 44 illustrates robotic control system interfaces 4400 in accordance with one embodiment.

FIG. 45 illustrates a perception module 4500 in accordance with one embodiment.

FIG. 46 illustrates a navigation module 4600 in accordance with one embodiment.

FIG. 47 illustrates a robot brain 4700 in accordance with one embodiment.

FIG. 48 illustrates an action module 4800 in accordance with one embodiment.

FIG. 49A and FIG. 49B illustrate a robot brain flow diagram 4900 in accordance with one embodiment.

FIG. 50 illustrates a routine 5000 in accordance with one embodiment.

FIG. 51 illustrates a video-feed segmentation routine 5100 in accordance with one embodiment.

FIG. 52 illustrates a static object identification routine 5200 in accordance with one embodiment.

FIG. 53 illustrates a movable object identification routine 5300 in accordance with one embodiment.

FIG. 54 illustrates a tidyable object identification routine 5400 in accordance with one embodiment.

FIGS. 55A-55B illustrate object identification with fingerprints 5500 in accordance with one embodiment.

FIG. 56 illustrates a main navigation, collection, and deposition process 5600 in accordance with one embodiment.

FIG. 57 illustrates strategy steps for isolation strategy, pickup strategy, and drop strategy 5700 in accordance with one embodiment.

FIG. 58 illustrates process for determining an action from a policy 5800 in accordance with one embodiment.

FIG. 59 depicts another robotic process 5900 in accordance with one embodiment.

FIG. 60 depicts a state space map 6000 for a robotic system in accordance with one embodiment.

FIG. 61 depicts a robotic control algorithm 6100 for a robotic system in accordance with one embodiment.

FIG. 62 depicts a robotic control algorithm 6200 for a robotic system in accordance with one embodiment.

FIG. 63 illustrates a deep neural network 6300 in accordance with one embodiment.

FIG. 64A illustrates inference/training logic 6400a in accordance with one embodiment.

FIG. 64B illustrates inference/training logic 6400b in accordance with one embodiment.

FIG. 65 illustrates a basic deep neural network 6500 in accordance with one embodiment.

FIG. 66 illustrates an artificial neuron 6600 in accordance with one embodiment.

FIG. 67 illustrates a convolutional neural network 6700 in accordance with one embodiment.

FIG. 68 illustrates a convolutional neural network layers 6800 in accordance with one embodiment.

FIG. 69 illustrates a VGG net 6900 in accordance with one embodiment.

FIG. 70 illustrates a convolution layer filtering 7000 in accordance with one embodiment.

FIG. 71 illustrates a pooling layer function 7100 in accordance with one embodiment.

FIG. 72 illustrates a cloud computing node 7200 in accordance with one embodiment.

FIG. 73 illustrates a cloud computing environment 7300 in accordance with one embodiment.

FIG. 74 illustrates an item 7400 in accordance with one embodiment.

### DETAILED DESCRIPTION

A general purpose tidying robot may load cups, plates, cutlery, cooking dishes, and other cookware and tableware into a dishwasher, and may unload the dishwasher and return the cookware and tableware to the appropriate cabinets once they are clean. The following shows the general purpose tidying robot interacting with a dishwasher to load and unload various items.

At a high level, the tidying robot may operate as follows to facilitate a smooth interaction with a dishwasher machine having dishwasher trays that slide in and out to accept items to be washed and dried. When loading the dishwasher the robot should attempt to leave sufficient space between items to facilitate unloading after the wash cycle.

The tidying robot may unload items from the dishwasher rom front to back and left to right in order to minimize interference with the arms. For example, if it starts in the front-left corner then there will be empty space to the left and in front, allowing the pusher pads to more easily grab that corner item first. Putting away that item then makes room to pick up the next item. The tidying robot may move its pusher pads into position immediately above the target item being picked up and then using the primary vertical linear actuator to move the pusher pads vertically down to encapsulate the item. This might be needed in a situation where you have, for example, several plates arranged next to each other. In some cases, multiple thin/narrow objects, such as cutlery, may be picked up together with the pusher pads.

A general-purpose tidying robot may collect and load cups, plates, cutlery, cooking dishes, and other cookware and tableware into a dishwasher, and may unload the dishwasher and return the cookware and tableware to the appropriate cabinets once they are clean. The tidying robot may collect and load clothing into a washer and dryer, empty the washer and dryer, and fold clean clothing. Such a tidying robot may place food into an oven and remove food from an oven, set a table, and place food on a table. At a high level, the tidying robot may operate as follows to facilitate a smooth interaction with household appliances, furniture, and objects, to complete tidying tasks.

The tidying robot may unload items from the dishwasher from front to back and left to right in order to minimize interference with the arms. For example, if it starts in the front-left corner then there will be empty space to the left and in front, allowing the pusher pads to more easily grab that corner item first. Putting away that item then makes room to pick up the next item. The tidying robot may move its pusher pads into position immediately above the target item being picked up and then using the primary vertical linear actuator to move the pusher pads vertically down to encapsulate the item. This might be needed in a situation where you have, for example, several plates arranged next to each other. In some cases, multiple thin/narrow objects, such as cutlery, may be picked up together with the pusher pads.

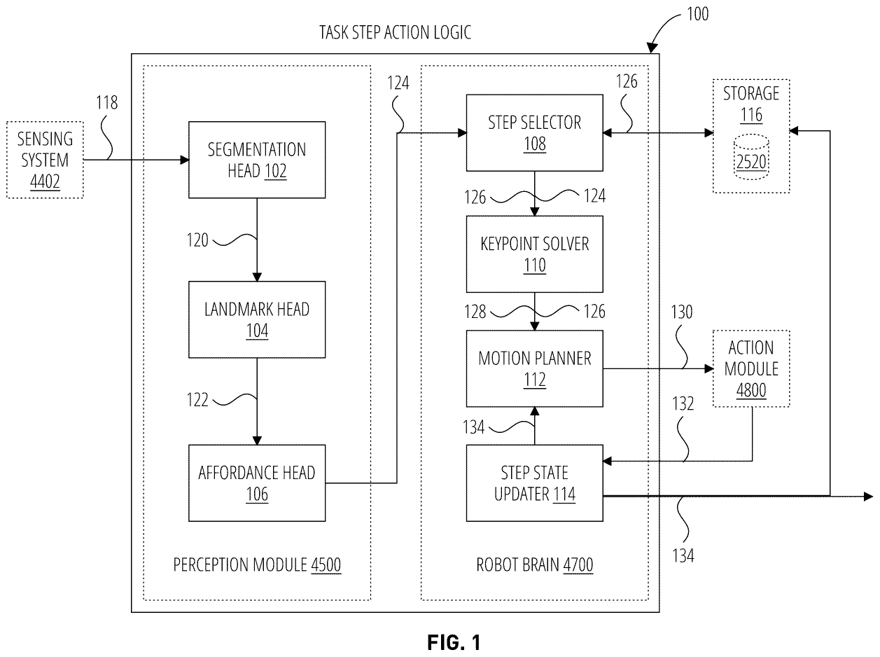

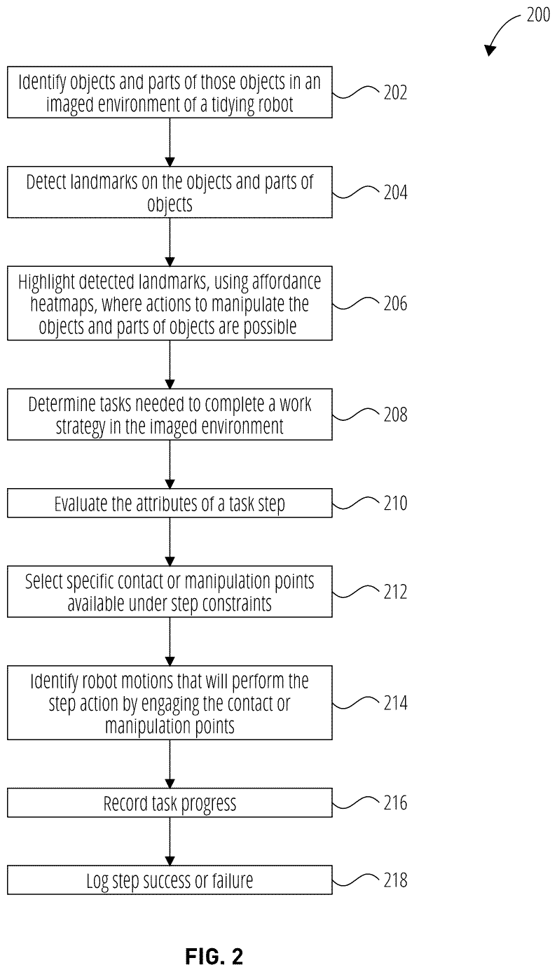

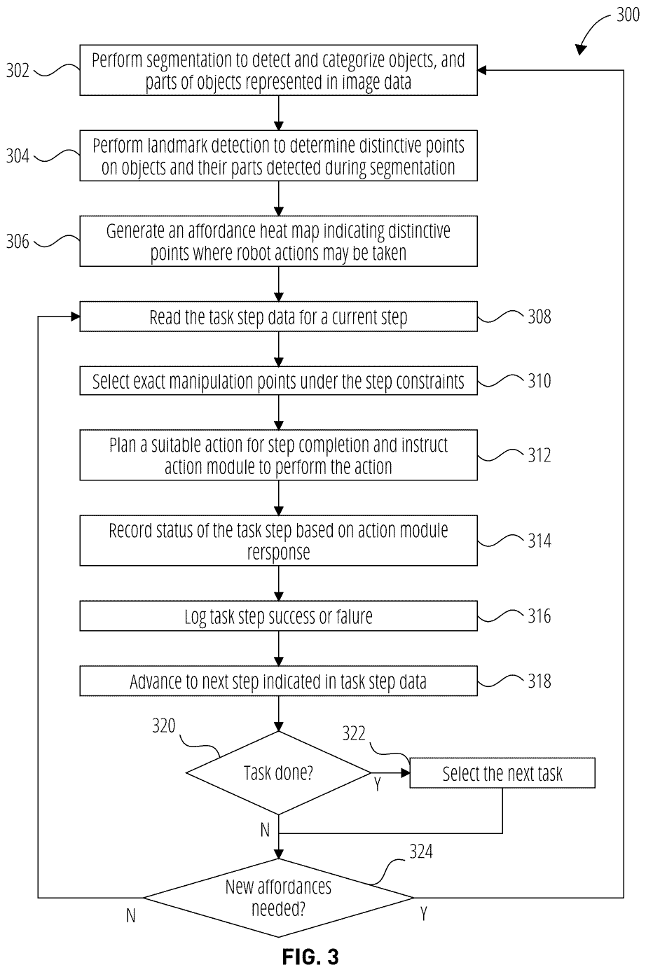

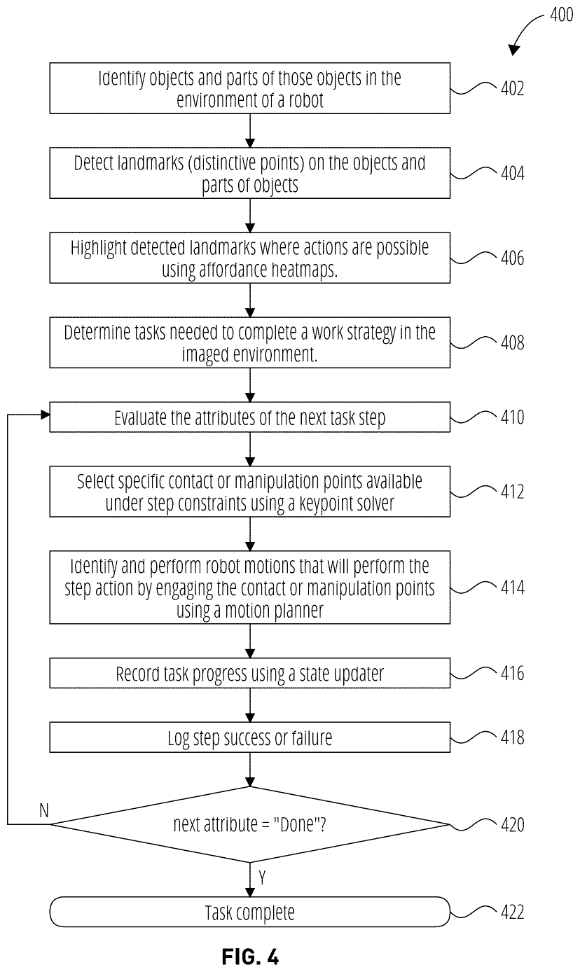

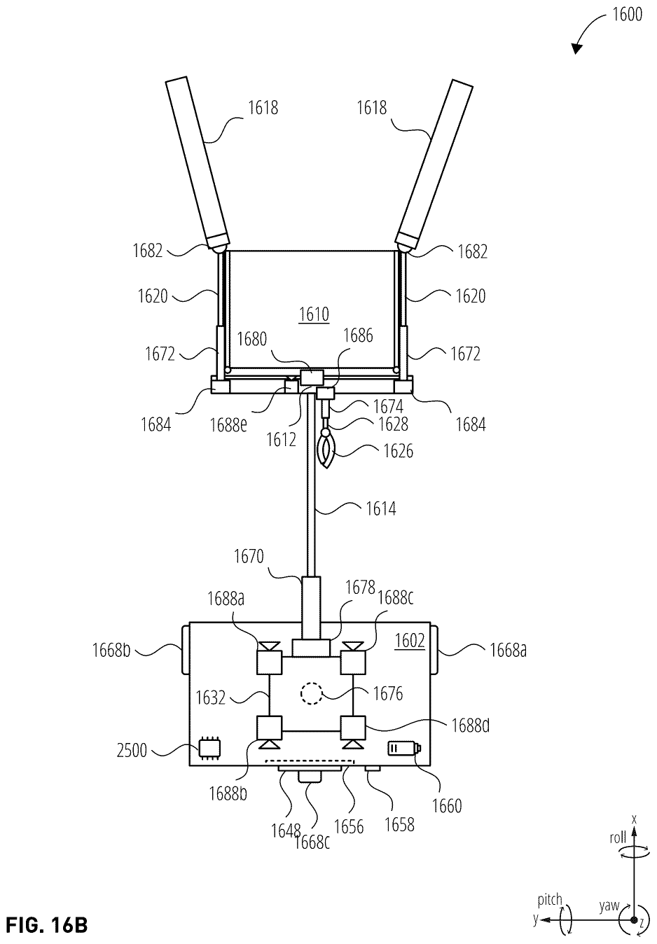

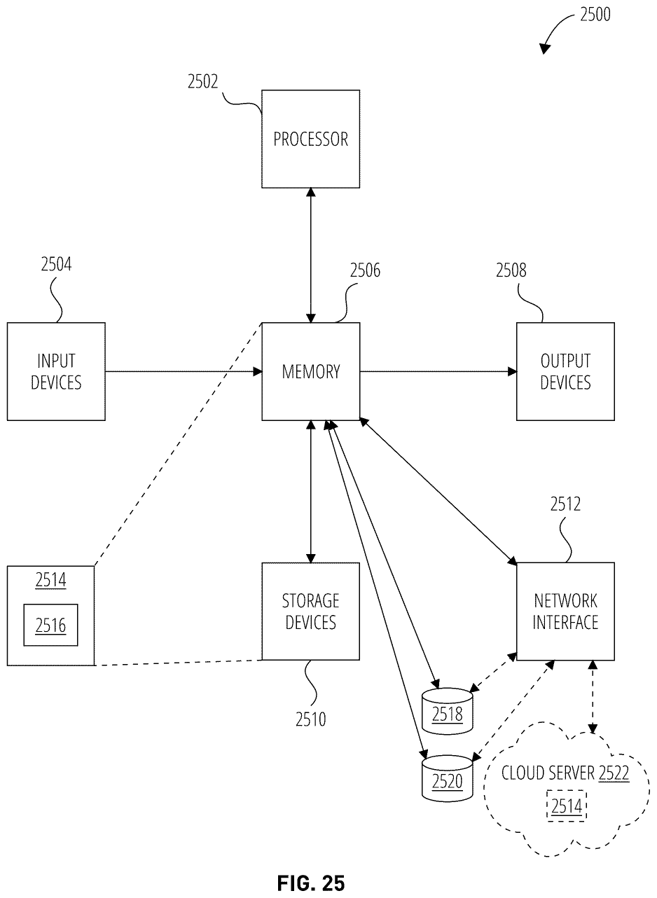

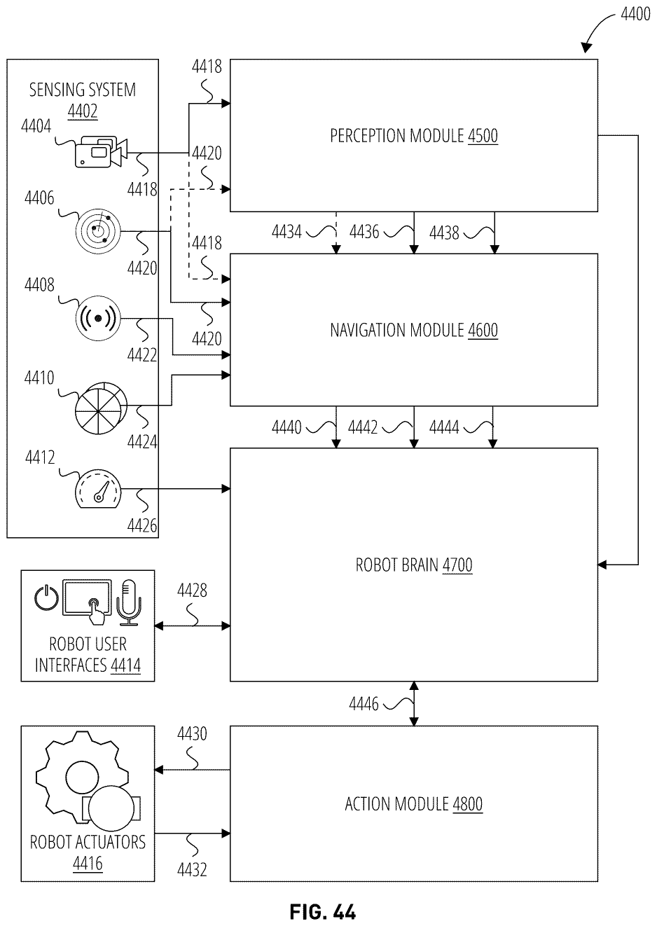

FIG. 1 illustrates task step action logic 100 in accordance with one embodiment. The task step action logic 100 may be configured to perform the routine 200 and the runtime task step action routine 300 described in greater detail below with respect to FIG. 2 and FIG. 3, respectively, as well as the task configuration routine 400 described with respect to FIG. 4. The task step action logic 100 may comprise a segmentation head 102, a landmark head 104, an affordance head 106, a step selector 108, a keypoint solver 110, a motion planner 112, and a step state updater 114. These elements may be implemented within the robotic control system interfaces 4400 described with respect to FIG. 44, which may be deployed within the robotic control system of a robot, such as is introduced in FIG. 16A and described in detail with respect to FIG. 25. These elements, individually or in combination, may be implemented as or may be augmented with artificial intelligence (AI) models and/or machine learning (ML) models.

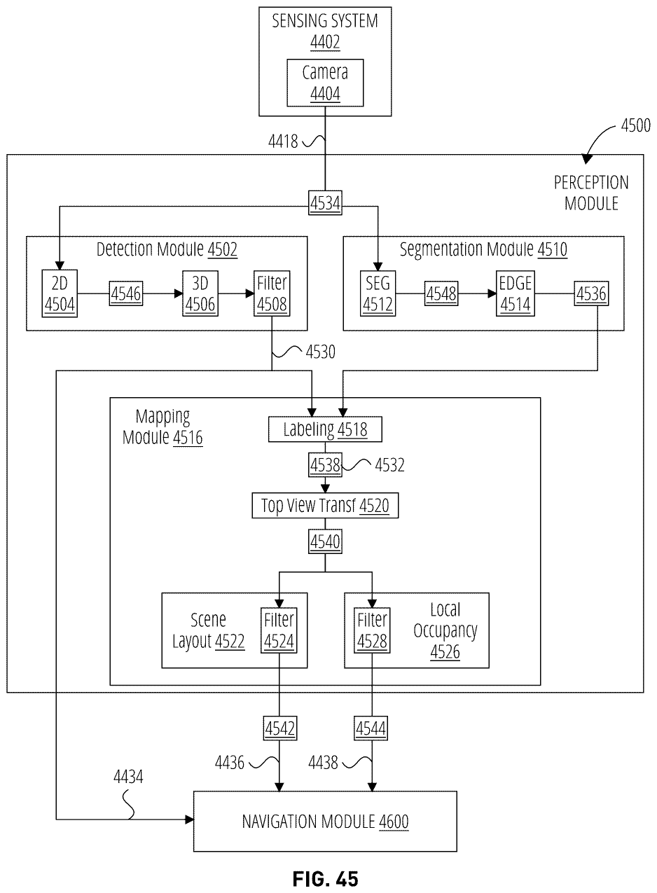

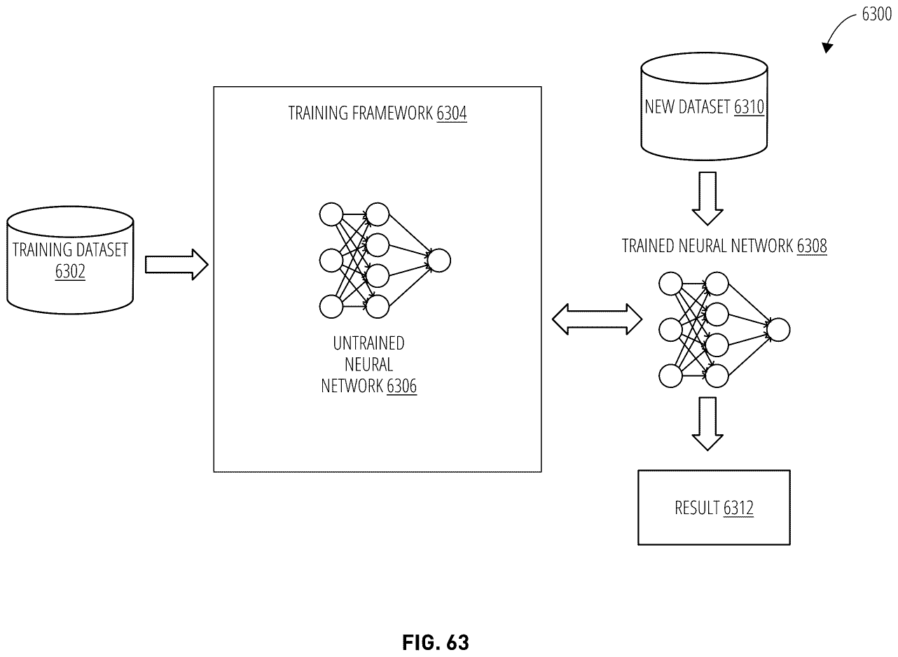

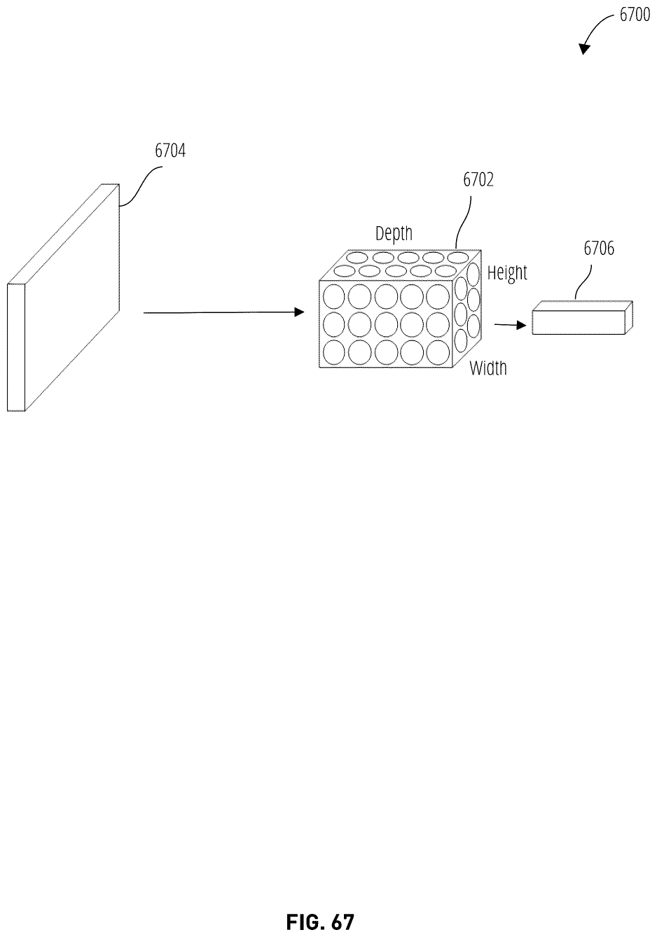

The segmentation head 102, landmark head 104, and affordance head 106 may be included in the perception module 4500 described in greater detail with respect to FIG. 45. One of ordinary skill in the art will appreciate that the segmentation head 102, landmark head 104, and affordance head 106 may be integrated within or operate alongside, and may perform their operations similarly to, the perception module 4500 elements described below. The segmentation head 102, landmark head 104, and affordance head 106, as well as, in some embodiments, the keypoint solver 110, may be implemented as multiple heads branching from a convolutional neural network (CNN), such as the convolutional neural network 6700 of FIG. 67, or some other type of deep neural network, such as the deep neural network 6300 of FIG. 63. This configuration represents a technical improvement over conventional solutions because of the efficiency achieved when the robot need run no more than one forward pass through these elements, and all perception tasks performed by these elements share the same features. This configuration further facilitates model training and runtime learning, since perception tasks such as segmentation, landmark identification, and affordance determination reinforce each other.

In one embodiment, the segmentation head 102 of the task step action logic 100 may accept input from sensing system 4402 such as is described in greater detail with respect to FIG. 44. This input may be in the form of image data 118. The segmentation head 102 may use this image data 118 to predict masks for objects and parts of objects represented in the image data 118. The segmentation head 102 may in this manner be able to isolate and categorize objects and their separate parts, and identify parts of the objects pertinent to various tasks. For example, the segmentation head 102 may detect that image data 118 has captured a shirt within the robot's environment, and may identify and clearly detect edges of and mask the body and sleeves of the shirt. Similarly, the segmentation head 102 may detect a pot and be able to clearly identify the pot, its lid, and a handle on the lid. The segmentation head 102 may send this data on identified objects and their parts 120 to the landmark head 104.

The landmark head 104 may take in the identified objects and their parts 120 and may predict anchor points such as object or part corners, handles, rims, etc. These distinctive points may provide anchors for task step actions such as “grip 10 cm from right corner,” even when the exact grip point is not visually unique. The landmark head 104 may send information on the distinctive points 122 it detects to the affordance head 106.

The affordance head 106 may be configured to predict heat maps that highlight suitable regions and distinctive target points where specific actions are possible through the interaction of the robot with target points on an object or object part. An affordance heat map may be a map showing which regions are suitable for an action like grip, hold, push, or align. These affordance heat maps thus highlight feasible zones for a robot to interact with an object to perform a step, helping the robot focus on where the action will succeed. The affordance head 106 may pass the motion planner 112 to the step selector 108.

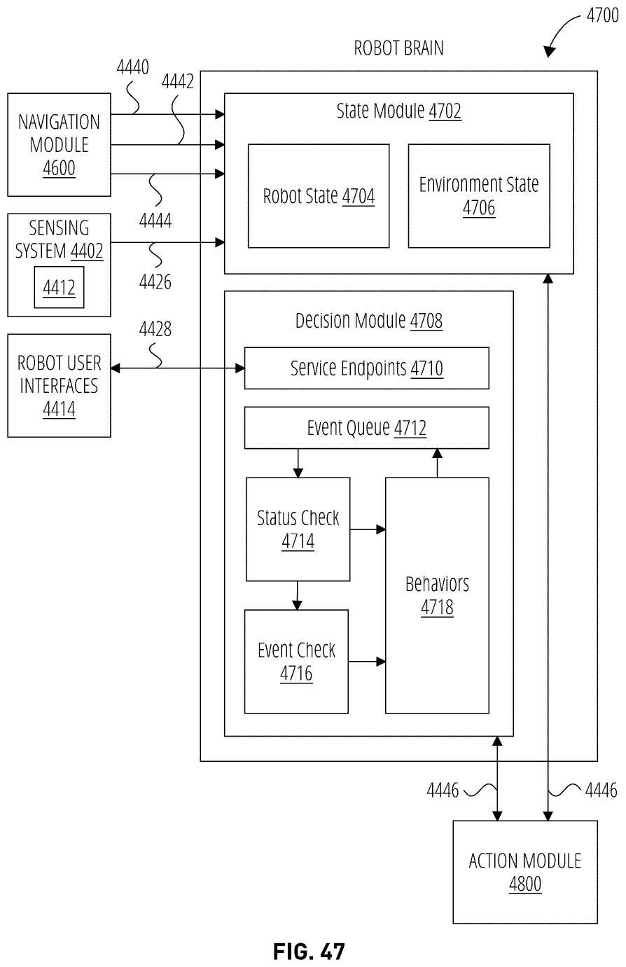

The step selector 108, keypoint solver 110, motion planner 112, and step state updater 114, may in one embodiment be deployed in robot brain 4700 logic that operates as described with respect to FIG. 47. These elements may be deployed alongside or integrated within the logical elements shown in FIG. 47, as will be readily understood by one of ordinary skill in the art. In this manner, these elements of the task step action logic 100 may operate as described below.

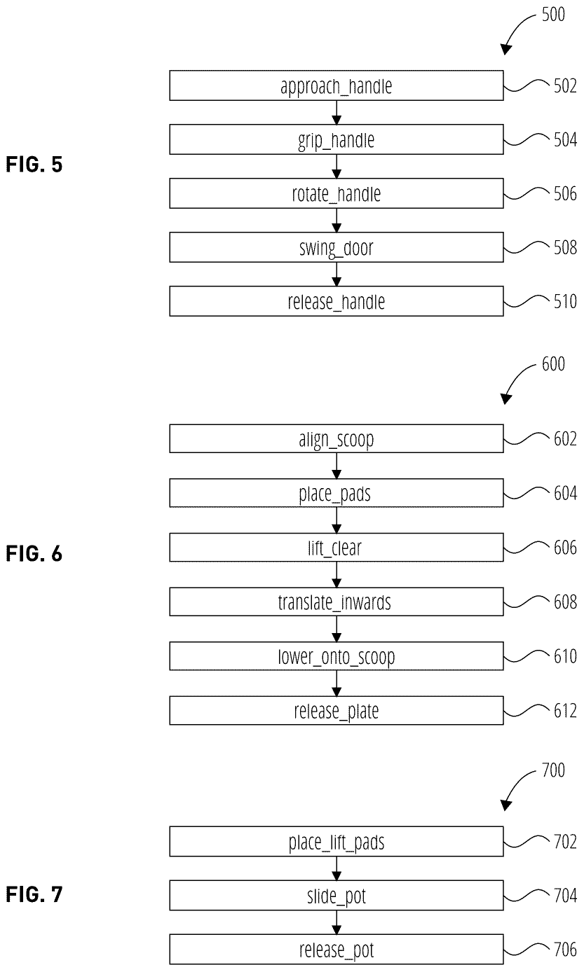

The step selector 108 may read a current step from a task in progress or, if there is no longer a task in progress (i.e., the last step in a task has been completed), may select as the current step a first step of a different task based on objects represented in the affordance heat map 124. The step selector 108 may be configured to interact with a robot instruction database 2520, which may be included in memory and storage devices 116 accessible to the task step action logic 100. The robot instruction database 2520 may include numerous task recipes (sets of steps) associated with objects or categories of objects that may be determined by the perception module 4500 and segmentation head 102 implemented using a control system such as the robotic control system 2500 of FIG. 25. Exemplary tasks and their steps are illustrated and described with respect to FIGS. 5-10. Robot tasks may be configured according to the task configuration routine 400 described below with respect to FIG. 4. The step selector 108 may provide the task step data 126 determined by the current step as well as the affordance heat map 124 indicating actionable points on detected objects and their parts, to the keypoint solver 110. In one embodiment, task step data 126 comprises step target point location, step constraints, and robot end effectors such as grippers, pusher pad, the scoop, etc., to be used in completing the step.

The keypoint solver 110 may select the exact or the optimal contact points that satisfy the step constraints for the current step, Indicated in the task step data 126. The keypoint solver 110 may be a control logic module that converts landmarks and affordance maps into precise contact points and orientations, including identifying the location of step target point based on the task step data 126 and the affordance heat map 124. The keypoint solver 110 may in one embodiment be a separate solver module that applies explicit rules and constraints (for example “choose a point on the hem edge offset from a corner” or “pick two symmetric points”). In one embodiment, the keypoint solver 110 may be a neural network head that directly predicts keypoints from shared features, in some instances in combination with a lightweight solver to enforce constraints. In this manner, the keypoint solver 110 may enforce step constraints such as “on an edge,” “a fixed offset from a landmark,” “symmetric pairs,” or “two opposing contact points,” ensuring the chosen keypoints are physically valid and task-appropriate. The keypoint solver 110 may provide this information as step target point locations 128 to the motion planner 112, along with the task step data 126, including robot end effectors identified in the task step data 126.

The motion planner 112 may determine the desired robot end effectors and the direction and extent of motions they should perform, in support of the robot's interaction with step target point locations 128. The motion planner 112 may send a step message 130 to the action module 4800 that instruct the action module 4800 to direct the robot actuators, as described below, to appropriately contact the step target point location 128 in compliance with the step constraints. The motion planner 112 may in this manner instruct the action module 4800 to translate selected keypoints into robot motion.

As a result of directing the robot actuators to complete the current step of a task, the action module 4800 may send a state message 132 to the step state updater 114. The state message 132 may include information from actuator force feedback sensors which the step state updater 114 may interpret in conjunction with other sensed data from the sensing system 4402 to determine the status of the step of the task: whether the step was completed successfully, what positions the target object and robot end effectors are in, etc.

Force feedback may be detected by robot actuators and/or the robot sensing system, and may be used by the actuators and/or robot control system logic to control how much pressure a robot applies when pushing objects with push pads, holding objects, gripping, pulling a handle, etc. This feedback may be obtained either indirectly by monitoring motor current (since motor current is proportional to applied torque and force) or directly through dedicated force or tactile sensors mounted in the gripper.

For example, when the robot closes its gripper on a handle, it continuously measures the estimated or sensed gripping force. If the force is too low, the handle may slip, but if it is too high, the handle or mechanism could be damaged. Using a feedback control loop, the robot adjusts the gripper motor commands in real time to maintain a target force. During the pulling motion, force feedback also allows the robot to detect resistance from an object such as a handle of a, drawer and adapt the applied pulling force accordingly, increasing it smoothly until the drawer starts moving while avoiding excessive loads. This results in a safe, robust, and human-like interaction with the environment.

The step state updater 114 may provide step statuses to a user through the robot user interface 4414, to other portions of the robotic control system, to a step status log stored in memory and storage devices 116, etc., in support of self- or user-directed training and continuous performance improvement. The step status 134 may include a task and step identifier and a completion condition such as “passed” or “failed.” Other data may be incorporated into the step status 134, as one of ordinary skill in the art will appreciate, in order to appropriately inform improvement and training. For example, should a particular step of a particular task have a failure rate above a predetermined threshold, the robotic control system may alert a user through the robot user interface 4414 that the robot needs human-assisted training on how to perform that particular step.

In one embodiment, the step state updater 114 may send the step status 134 to the motion planner 112 for use in planning the next motions the robot should take for ensuing task steps. For a pass-completed task, performed through known motions, the motion planner 112 may plan motions needed for the next step without additional reference to information derived from the image data 118, unless it is determined that the robot has moved and has moved its target object enough that reevaluation of the environment is needed. In this manner, the robot may perform numerous steps of a task in place without needing to capture and evaluate new image data between steps. This provides additional efficiency to task completion.

FIG. 2 illustrates a routine 200 in accordance with one embodiment. The routine 200 may be performed by a robotic control system incorporating the task step action logic 100 introduced in FIG. 1, as well as, in some embodiments, the robotic control system interfaces 4400 described in greater detail with respect to FIG. 44. Although the example routine 200 depicts a particular sequence of operations, the sequence may be altered without departing from the scope of the present disclosure. For example, some of the operations depicted may be performed in parallel or in a different sequence that does not materially affect the function of the routine 200. In other examples, different components of an example device or system that implements the routine 200 may perform functions at substantially the same time or in a specific sequence.

According to some examples, the method includes identifying objects and parts of those objects in an imaged environment of a tidying robot at block 202. The tidying robot may be configured with a chassis, a capture and containment system including a scoop, pusher pads including a first pusher pad and a second pusher pad, pusher pad arms including a first pusher pad arm and a second pusher pad arm, and a gripper arm. The tidying robot may be further configured with a lifting column configured to raise and lower the capture and containment system through extension and retraction of a lifting column linear actuator.

According to some examples, the method includes detecting landmarks on the objects and parts of objects at block 204. The landmarks may be distinctive points. According to some examples, the method includes highlighting detected landmarks, using affordance heatmaps, where actions to manipulate the objects and parts of objects are possible at block 206.

According to some examples, the method includes determining tasks needed to complete a work strategy in the imaged environment at block 208. According to some examples, the method includes evaluating the attributes of a task step at block 210. According to some examples, the method includes selecting specific contact or manipulation points available under step constraints at block 212. For example, the keypoint solver 110 illustrated in FIG. 1 may select specific contact or manipulation points available under step constraints.

According to some examples, the method includes identifying robot motions that will perform the step action by engaging the contact or manipulation points at block 214. For example, the motion planner 112 illustrated in FIG. 1 may identify robot motions that will perform the step action by engaging the contact or manipulation points.

According to some examples, the method includes recording task progress at block 216. For example, the step state updater 114 illustrated in FIG. 1 may record task progress. According to some examples, the method includes logging step success or failure at block 218.

FIG. 3 illustrates a runtime task step action routine 300 in accordance with one embodiment. The runtime task step action routine 300 may be performed by a robotic control system including the task step action logic 100 introduced above with respect to FIG. 1 as well as, in some embodiments, the robotic control system interfaces 4400 described with respect to FIG. 44. Although the example runtime task step action routine 300 depicts a particular sequence of operations, the sequence may be altered without departing from the scope of the present disclosure. For example, some of the operations depicted may be performed in parallel or in a different sequence that does not materially affect the function of the runtime task step action routine 300. In other examples, different components of an example device or system that implements the runtime task step action routine 300 may perform functions at substantially the same time or in a specific sequence.

According to some examples, the method includes performing segmentation to detect and categorize objects, and parts of objects represented in image data at block 302. For example, the segmentation head 102 illustrated in FIG. 1 may perform segmentation to detect and categorize objects, and parts of objects represented in image data. Image data may be captured by one or more cameras included in a robot's sensing system. According to some examples, the method includes performing landmark detection to determine distinctive points on objects and their parts detected during segmentation at block 304. For example, the landmark head 104 illustrated in FIG. 1 may perform landmark detection to determine distinctive points on objects and their parts detected during segmentation. According to some examples, the method includes generating an affordance heat map indicating distinctive points where robot actions may be taken at block 306. For example, the affordance head 106 illustrated in FIG. 1 may generate an affordance heat map indicating distinctive points where robot actions may be taken.

According to some examples, the method includes reading the task step data for a current step at block 308. For example, the step selector 108 illustrated in FIG. 1 may read the task step data for a current step. According to some examples, the method includes selecting exact manipulation points under the step constraints at block 310. For example, the keypoint solver 110 illustrated in FIG. 1 may select exact manipulation points under the step constraints. According to some examples, the method includes planning a suitable action for step completion and instruct action module to perform the action at block 312. For example, the motion planner 112 illustrated in FIG. 1 may plan a suitable action for step completion and instruct action module to perform the action.

According to some examples, the method includes recording status of the task step based on action module response at block 314. For example, the step state updater 114 illustrated in FIG. 1 may record status of the task step based on action module response. Progress may include which folds have been performed in a folding task, whether a pot lid has been removed or replaced, etc. According to some examples, the method includes logging task step success or failure at block 316. For example, the step state updater 114 illustrated in FIG. 1 may log task step success or failure. This data may be used during imitation learning, self-supervised learning, or reinforcement learning updates. According to some examples, the method includes advancing to next step indicated in task step data at block 318. For example, the step selector 108 illustrated in FIG. 1 may advance to next step indicated in task step data.

According to some examples, the method includes determining if the task is done at decision block 320. For example, the step selector 108 illustrated in FIG. 1 may determine the task is done. The task may be determined to be done if the next step attribute for the step just completed was “done” or some other task completion indicator. In one embodiment, the step status determined by the step state updater 114 may be used in determining if the task is done. If the step just performed failed, it may be returned to and retried, even though it's “next step” attribute indicates the task is complete once the step is performed.

According to some examples, if the task is determined to be done, the method includes selecting the next task at block 322. For example, the step selector 108 illustrated in FIG. 1 may select the next task. If the task is determined to not be complete at decision block 320, the method may proceed to decision block 324. According to some examples, the method includes determining if new affordances are needed to continue completing task steps at decision block 324. For example, the task step action logic 100 illustrated in FIG. 1 may determine that new affordances are needed, and the runtime task step action routine 300 may return to block 302. If new affordances are not needed, the runtime task step action routine 300 may return to block 308.

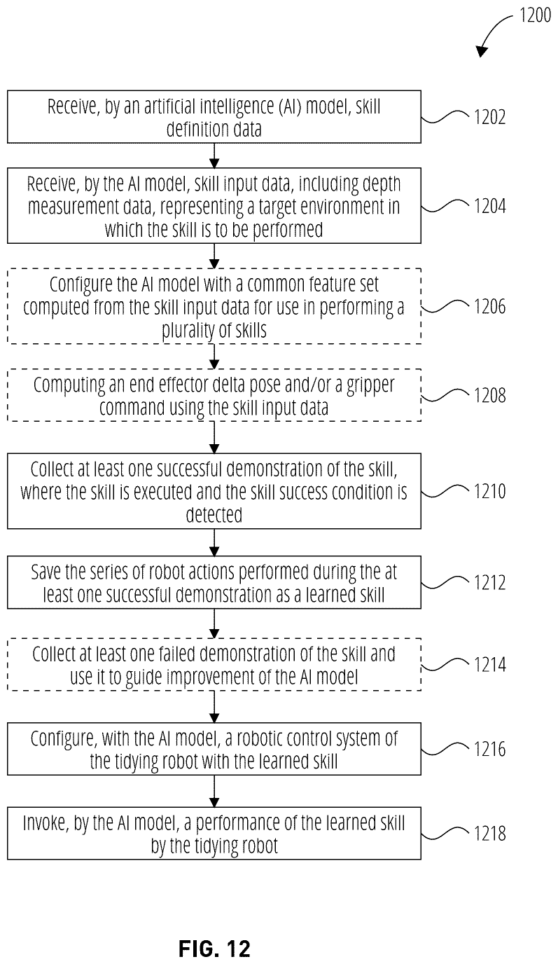

This task step-based approach may support the robot in being highly configurable. New tasks may be learned through access to a new recipe file and the synthesis of perception (segmentation, landmarks, and affordances) and step motion operations the robot has already trained on. Perception information may be reusable across tasks, and improvements in one aspect of perception as the robot trains may support improvements in all areas. The step-wise execution of tasks allows the robot to focus on its next action, reducing task-performance complexity at runtime. In one embodiment, the routine 200 may further comprise actions described with respect to the routine 1200 illustrated in FIG. 12.

A robotic control system incorporating the task step action logic 100 described above, as well as, in some embodiments, the robotic control system interfaces 4400 illustrated in FIG. 44, may configure a number of tasks for a robot to complete as part of its tidying strategy or other work strategy. FIG. 4 illustrates a task configuration routine 400 in accordance with one embodiment. The robotic control system may use information detected in the environment of a robot to perform the task configuration routine 400, dynamically generating the step-by-step tasks needed to direct the robot to perform its work. Such tasks may be stored in the memory structures of a robot control system, including memory, storage devices, robot instruction databases, etc., as are described in greater detail with respect to FIG. 25.

Although the example task configuration routine 400 depicts a particular sequence of operations, the sequence may be altered without departing from the scope of the present disclosure. For example, some of the operations depicted may be performed in parallel or in a different sequence that does not materially affect the function of the task configuration routine 400. In other examples, different components of an example device or system that implements the task configuration routine 400 may perform functions at substantially the same time or in a specific sequence.

According to some examples, the method includes identifying objects and parts of those objects in the environment of a robot at block 402. For example, a robotic control system may analyze images of the environment and identify a shirt and specifically, the sleeves of the shirt using image segmentation, such as may be performed by a panoptic segmentation model. In another case, the robotic control system may identify a dishwasher, a shelf holding books, etc.

According to some examples, the method includes detecting landmarks (distinctive points) on the objects and parts of objects at block 404. For example, hems and corners of a garment such as a shirt, may be detected as landmarks. A dishwasher may have a handle and corners of its door identified as landmarks. A pot may have handles, its rim, its lid, and a lid handle identified. Landmarks may also be identified through image segmentation.

According to some examples, the method includes highlighting detected landmarks where actions are possible using affordance heatmaps at block 406. Actions may be discrete activities the robot is capable of performing with one or more of its end effectors or other actuators. Actions may include gripping, holding, pushing, aligning, moving toward, or moving away from a target object identified in the environment. Affordance heat maps may highlight landmarks where such actions may be performed by the robot by gripping, holding, pushing, aligning, etc.

According to some examples, the method includes determining and configuring tasks needed to complete a work strategy in the imaged environment at block 408. The robotic control system may select from among wholly or partially preconfigured tasks, by determining which tasks are suitable to objects identified in the environment of robot. A task may be defined as a recipe comprising a set of steps, each configured with attributes that may be dynamically customizable based on the characteristics of objects detected and tidying activities or other work that may be performed with reference to those objects. Each step may include a name, number, or other unique identifier by which the step may be referenced. The step may identify an action type involved in the step, such as “grip,” “hold,” “lift,” “align,” etc. The step may identify a target object or target part of an object upon which the action is to be performed, such as a shirt hem, pant leg, pot lid, etc. Each step may include constraints associated with the object, parts, or landmarks, or with the desired action of the step. Constraints may include “on edge,” “10 cm from corner,” “symmetric pair,” etc. Each step may identify an end effector to perform the action of the step. End effectors may include a gripping mechanism associated with a gripper arm, pusher pads on the pusher pad arms, the scoop on its scoop arm(s), etc. Each step may include an identification of the next step in the task to be performed, what action is to follow when the action of the step is completed, or an indication that the task is complete after that step. In this manner, the determination of what to do (the task recipe) is separated from the determinations of how to see and act, which are determined by perception as described above and the keypoint solver, described below.

According to some examples, the method includes evaluating the attributes of the next task step at block 410. This may be performed by a step planner configured to read the current and/or the next step from a recipe. In initiating a task, this would be the first step of the task. After the action of the first step is complete, the identified next step would be evaluated, and so on.

According to some examples, the method includes selecting specific contact or manipulation points available under step constraints using a keypoint solver at block 412. Step constraints may include an offset from a corner needed to appropriately grip or contact that corner, a symmetry of action needed to keep an object appropriately balanced as the robot interacts with it, a similar need to perform an action, exert a pressure, etc. At opposing sides of the object, and similar demands imposed by the object, the desired task, the environment, and other conditions.

According to some examples, the method includes identifying and performing robot motions that will perform the step action by engaging the contact or manipulation points using a motion planner at block 414. The motion planner logic may transform selected keypoints into robot motions which the robot may be directed to perform.

According to some examples, the method includes recording task progress using a state updater at block 416. For example, the state updater may keep track of which fold is complete in a shirt folding task, whether a lid is removed from a pot, whether a door is open, etc. The step planner logic, motion planner logic, and state updater logic may be configured within the robotic control system memory structures, to be executed by the processor(s) of the robotic control system.

According to some examples, the method includes logging step success or failure at block 418. Logged successes and failures may be used to reinforce learning through imitation, self-supervised learning, or reinforcement learning updates. The robot or robotic control system may improve in task performance over time through the implementation of three complementary approaches. Imitation learning (IL) may allow the robot to learn initial behaviors from human demonstrations, providing a fast way to bootstrap new skills. For example, a human may demonstrate to the robot how to open a dishwasher or fold a shirt. Self-supervised learning may involve the robot interacting with objects in its environment and learning from the outcome. For example, the robot may pull on cloth with a pusher pad and a then a gripper mechanism to see how the cloth moves and resists motion by the end effector. This may improve the robot's perception functions and allow it to generalize without the need for human labeling. Reinforcement learning with human corrections may reward the robot for task success, such as neat folding or stable support of a lifted pot. Human corrections may guide the robot to improve without the need to repeat a full demonstration. This allows the robot to refine skills beyond what was demonstrated.

According to some examples, if next attribute=“done” at decision block 420, task configuration routine 400 includes recognizing the task is complete at done block 422. Otherwise, task configuration routine 400 includes returning to block 410.

In this manner, a set of preconfigured tasks may be configured and expanded upon. New tasks may use a new set of steps or may be configured by applying known steps in orders indicated by the characteristics of objects detected. Perception-based information, such as objects, parts of objects, landmarks, and affordances, may be used across multiple steps and tasks. This routine supports performance improvement over time, as a robot succeeds or fails at the action of a step. The step-wise execution allows the robot to focus on each action individually, reducing the complexity of task performance. The task configuration routine 400 thus allows the robot to continuously improve in the physical performance of actions while taking less human training time and allowing continuous optimization and reuse of task steps.

In one embodiment, a robotic control system may perform the task configuration routine 400 to generate the tasks described with respect to FIGS. 5-10. These granular tasks may be developed as part of a tidying strategy that includes emptying a dishwasher. The robotic control system may perform the task configuration routine 400 to dynamically create the open_dishwasher task 500 upon detecting a clean or dirty indicator on the front of a dishwasher that indicates the dishes within are clean. The task configuration routine 400 may be used to create the transfer_plate_from_dishwasher_to_scoop task 600 upon opening the dishwasher following the open_dishwasher task 500 and detecting plates within the dishwasher. Additional tasks may be configured and performed similarly.

FIG. 5 illustrates an open_dishwasher task 500 in accordance with one embodiment. Although the example open_dishwasher task 500 depicts a particular sequence of operations, the sequence may be altered without departing from the scope of the present disclosure. For example, some of the operations depicted may be performed in parallel or in a different sequence that does not materially affect the function of the open_dishwasher task 500. In other examples, different components of an example device or system that implements the open_dishwasher task 500 may perform functions at substantially the same time or in a specific sequence.

According to some examples, the method includes approach_handle at step 502. This step may direct the robot to move its gripper arm toward the dishwasher handle. This step may include the following attributes:

```
  step: approach_handle
  action: move
  target: dishwasher_handle
  constraints: { approach_axis: front, scoop_clearance: true
}
  end_effector: accessory_gripper
  next: grip_handle
```

According to some examples, the method includes grip_handle at step 504. This step may direct the robot to grip the dishwasher handle. This step may include the following attributes:

```
  step: grip_handle
  action: grip
  target: dishwasher_handle
  constraints: { grip_orientation: horizontal, force: light
}
  end_effector: accessory_gripper
  next: rotate_handle
```

According to some examples, the method includes rotate_handle at step 506. This step may direct the robot to rotate the dishwasher handle, disengaging it from a latching mechanism that may be holding it shut. This step may include the following attributes:

step: rotate_handle
action: rotate
target: dishwasher_handle
constraints: { rotation: downward, gripper_pitch: down }
end_effector: accessory_gripper
next: swing_door

According to some examples, the method includes swing_door at step 508. This step may direct the robot to pull on the handle in an arcing motion in order to open the dishwasher door. This step may include the following attributes:

```
  step: swing_door
  action: coordinate
  target: dishwasher_door
  constraints: { door_axis: bottom_hinge, linear_actuator:
follow, scoop_clearance: true }
  coordination:
    accessory_gripper: maintain_grip
    vertical_actuator: lower_as_door_rotates
    base_motion: back_up_as_door_opens
  end_effector: accessory_gripper
  next: release_handle
```

According to some examples, the method includes release_handle at step 510. This step may direct the robot to release the dishwasher handle from engagement with its gripper mechanism. This step may include the following attributes:

step: release_handle
action: release
target: dishwasher_handle
constraints: { door_open_angle: full }
end_effector: accessory_gripper
next: done

FIG. 6 illustrates a transfer_plate_from_dishwasher_to_scoop task 600 in accordance with one embodiment. Although the example transfer_plate_from_dishwasher_to_scoop task 600 depicts a particular sequence of operations, the sequence may be altered without departing from the scope of the present disclosure. For example, some of the operations depicted may be performed in parallel or in a different sequence that does not materially affect the function of the transfer_plate_from_dishwasher_to_scoop task 600. In other examples, different components of an example device or system that implements the transfer_plate_from_dishwasher_to_scoop task 600 may perform functions at substantially the same time or in a specific sequence.

According to some examples, the method includes align_scoop at step 602. This step may direct the robot to align its scoop with the detected plate to be transferred. This step may include the following attributes:

```
  step: align_scoop
  action: move_and_align
  target: scoop_surface
  constraints: { flush_with: rack_front, height_match:
plate_bottom }
  end_effector: scoop_vertical_actuator
  next: place_pads
```

According to some examples, the method includes place_pads at step 604. This step may direct the robot to place its pusher pads at opposite edges of the plate to contact or grip the plate:

```
  step: place_pads
  action: hold
  target: plate_edges
  constraints: { two_points_opposite: true, contact_height:
midplate }
  end_effector: left_pad+right_pad
  next: lift_clear
```

According to some examples, the method includes lift_clear at step 606. This step may direct the robot to lift the plate clear of the dishwasher tray:

```
  step: lift_clear
  action: rotate_up
  target: plate
  constraints: { pusher_arms: upward_rotation,
maintain_vertical: true, clearance: above_prongs }
  end_effector: left_pad+right_pad
  next: translate_inwards
```

According to some examples, the method includes translate_inwards at step 608. This step may direct the robot to move the plate inwards toward and above the scope:

step: translate_inwards
action: translate
target: over_scoop
constraints: { scoop_aligned: true, keep_vertical: true }
end_effector: left_pad+right_pad
coordination: { pusher_arms: hold_plate }
next: lower_onto_scoop

According to some examples, the method includes lower_onto_scoop at step 610. This step may direct the robot to lower the plate onto the scoop:

```
  step: lower_onto_scoop
  action: rotate_down
  target: plate
  constraints: { pusher_arms: downward_rotation, contact:
scoop_surface }
  end_effector: left_pad+right_pad
  next: release
```

According to some examples, the method includes releasing at step 612. This step may direct the robot to release the plate from the pusher pads:

step: release
action: release
target: plate
constraints: { stable_on: scoop_surface }
end_effector: left_pad+right_pad
next: done

FIG. 7 illustrates a move_pot_to_scoop task 700 in accordance with one embodiment. FIG. 7 illustrates an example move_pot_to_scoop task 700. Although the example move_pot_to_scoop task 700 depicts a particular sequence of operations, the sequence may be altered without departing from the scope of the present disclosure. For example, some of the operations depicted may be performed in parallel or in a different sequence that does not materially affect the function of the move_pot_to_scoop task 700. In other examples, different components of an example device or system that implements the move_pot_to_scoop task 700 may perform functions at substantially the same time or in a specific sequence.

According to some examples, the method includes place_lift pads at step 702. This step may direct the robot to move its pusher pads into position with respect to a detected pot in order to perform a lift of the pot. This step may include the following attributes:

step: place_lift_pads
action: hold
target: pot_rim
constraints: { two_points_opposite: true }
end_effector: pads
next: slide_pot

According to some examples, the method includes slide_pot at step 704. This step may direct the robot to move its pusher pads in a manner that slides the pot onto the scoop:

```
  step: slide_pot
  action: translate
  target: scoop_surface
  constraints: { path: countertop_to_scoop, scoop_aligned:
true }
  end_effector: pads
  next: release_pot
```

According to some examples, the method includes release_pot at step 706. This step may direct the robot to move its pusher pads such that the pot is released onto the scoop:

step: release_pot
action: release
target: pot
constraints: { stable_on: scoop_surface }
end_effector: pads
next: done

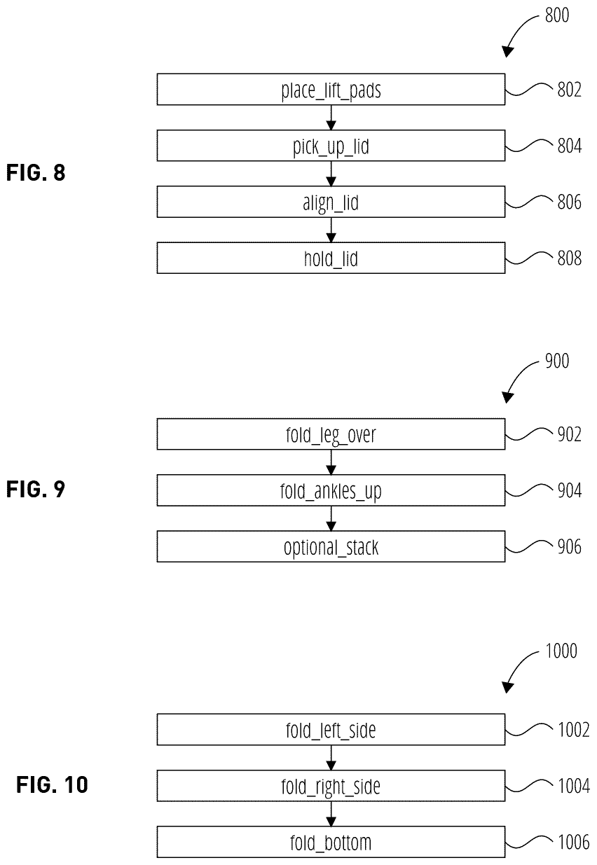

FIG. 8 illustrates a carry_pot task 800 in accordance with one embodiment. FIG. 8 illustrates an example carry pot task 800. Although the example carry_pot task 800 depicts a particular sequence of operations, the sequence may be altered without departing from the scope of the present disclosure. For example, some of the operations depicted may be performed in parallel or in a different sequence that does not materially affect the function of the carry pot task 800. In other examples, different components of an example device or system that implements the carry pot task 800 may perform functions at substantially the same time or in a specific sequence.

According to some examples, the method includes place_lift pads at step 802. This step may direct the robot to move its pusher pads into position with respect to a detected pot in order to perform facilitate placing a detected lid on the pot. This step may include the following attributes:

step: place_lift_pads
action: hold
target: pot_rim
constraints: { two_points_opposite: true }
end_effector: pads
next: remove_lid

According to some examples, the method includes pick_up_lid at step 804. This step may direct the robot to move its gripper arm in order to grip and lift a pot lid:

step: remove_lid
action: grip
target: pot_lid_knob
constraints: { landmark: knob }
end_effector: gripper
next: align_lid

According to some examples, the method includes align_lid at step 806. This step may direct the robot to move its gripper arm to align the pot lid above the pot rim:

step: align_lid
action: align
target: pot_rim
constraints: { align_points: [rim_point1, rim_point2] }
end_effector: gripper
next: hold_lid

According to some examples, the method includes hold_lid at step 808. This step may direct the robot to move its gripper arm in a manner that hold the pot lid onto the rim of the pot so as to carry it safely with all contents of the pot intact:

step: hold_lid
action: hold
target: pot_lid_knob
constraints: { stable_on: pot_rim }
end_effector: gripper
next: done

FIG. 9 illustrates a fold pants task 900 in accordance with one embodiment. FIG. 9 illustrates an example fold_pants task 900. Although the example fold_pants task 900 depicts a particular sequence of operations, the sequence may be altered without departing from the scope of the present disclosure. For example, some of the operations depicted may be performed in parallel or in a different sequence that does not materially affect the function of the fold_pants task 900. In other examples, different components of an example device or system that implements the fold_pants task 900 may perform functions at substantially the same time or in a specific sequence.

According to some examples, the method includes fold_leg_over at step 902. This step may direct the robot to operate its gripper arm in order to fold one pants leg over the other, folding the pants in half. This step may include the following attributes:

step: fold_leg_over
action: grip
target: pant_leg
constraints: { fold_over: other_leg }
end_effector: gripper
next: fold_ankles_up

According to some examples, the method includes fold_ankles_up at step 904. This step may direct the robot to move its its gripper arm to fold pant ankles up toward the pant waist:

step: fold_ankles_up
action: grip
target: pant_ankles
constraints: { fold_towards: waist }
end_effector: gripper
next: optional_stack

According to some examples, the method includes optional_stack at step 906. This step may direct the robot to operate its gripper arm to fold the pants once more from knee to waist:

step: optional_stack
action: grip
target: folded_pants
constraints: { fold_towards: half_height }
end_effector: gripper
next: done

FIG. 10 illustrates a fold_shirt task 1000 in accordance with one embodiment. FIG. 10 illustrates an example fold_shirt task 1000. Although the example fold_shirt task 1000 depicts a particular sequence of operations, the sequence may be altered without departing from the scope of the present disclosure. For example, some of the operations depicted may be performed in parallel or in a different sequence that does not materially affect the function of the fold shirt task 1000. In other examples, different components of an example device or system that implements the fold_shirt task 1000 may perform functions at substantially the same time or in a specific sequence.

According to some examples, the method includes fold_left_side at step 1002. This step may direct the robot to move its gripper arm such that the left side of the shirt is folded inward. This step may include the following attributes:

```
  step: fold_left_side
  action: grip
  target: shirt_hem
  constraints: { offset_from_corner: 10cm, edge_aligned:
true }
  end_effector: gripper
  next: fold_right_side
```

According to some examples, the method includes fold_right side at step 1004. This step may direct the robot to move its gripper arm such that the right side of the shirt is folded inward:

step: fold_right_side
action: grip
target: shirt_hem
constraints: { symmetric_to: fold_left_side }
end_effector: gripper
next: fold_bottom

According to some examples, the method includes fold_bottom at step 1006. This step may direct the robot to move its gripper arm such that the bottom hem of the shirt is folded up to the collar:

step: fold_bottom
action: grip
target: shirt_hem
constraints: { fold_towards: collar }
end_effector: gripper
next: done

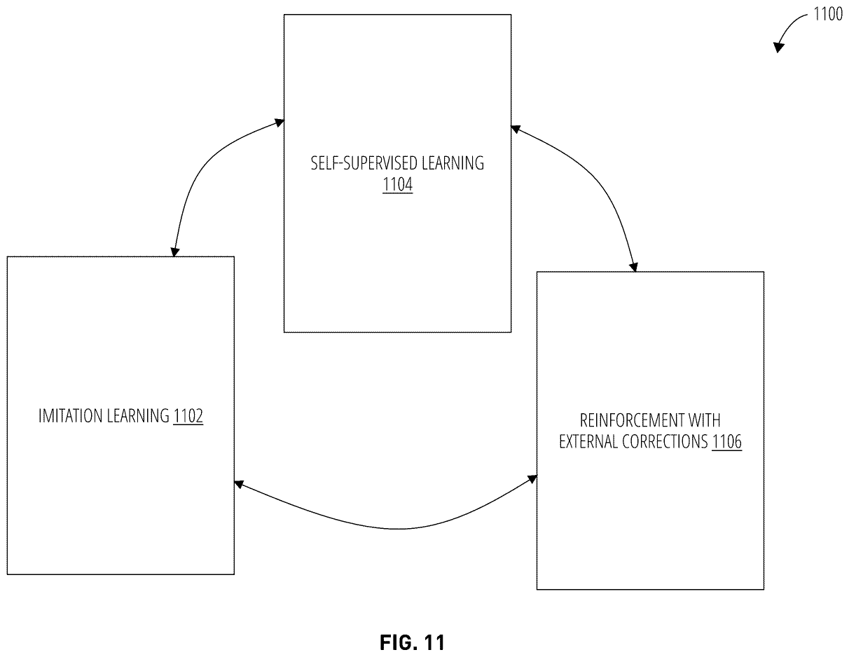

FIG. 11 illustrates learning loop training approaches 1100 in accordance with one embodiment, through which a robot may improve in performance of tasks and their steps over time. The learning loop training approaches 1100 may include imitation learning 1102, self-supervised learning 1104, and reinforcement with external corrections 1106.

Imitation learning 1102 allows the robot to learn initial behaviors from observing human demonstrations, or demonstrations by other robots that are more thoroughly trained. This provides a fast method to bootstrap a number of skills into the robot's repertoire. Self-supervised learning 1104 is performed as the robot interacts with objects and learns from outcomes. For example, the robot may pull on a piece of clothing to see how the fabric moves in response. This allows the robot to improve its perception and generalization as it perform task steps without needing human labeling or interaction. Reinforcement with external corrections 1106 supports the robot's training with rewards for successful tasks, such as performing a neat fold or a stable pot lift. These conditions may be observable by robot sensors and may be captured in the step status 134 introduced with respect to FIG. 1. External corrections, such as from a thresholding alert system or human intervention, may guide the robot in improving without a the need for a full demonstration as in imitation learning 1102. This may allow the robot to refine its skills beyond what is demonstrable through direct or remote control by a human operator.

In a robotic tidying system that includes a tidying robot configured with the task step action logic 100 disclosed herein as part of its robotic control system, one effective way to support quick deployment is to include a human user in the control loop, especially for purposes of training artificial intelligence and/or machine learning implemented in the robotic control system, such as through imitation learning 1102. Initially, a human operator may control the robot directly, either in person or via remote operations, to perform tidying tasks in a target environment. This allows the robot to operate productively even before it has fully autonomous capabilities. Remote teleoperation may be especially valuable because it may support deployed of one or more robots while relying on skilled human operators to handle situations the robots are not yet capable of solving on their own, ensuring that tasks are completed even in early stages of robot deployment and operation when additional training may still be needed.

During this initial phase, the robot may gather data from the environment, including camera images, depth information, joint states, force readings, and action commands. The data may capture real world variability in layouts, objects, and interactions that are difficult to model comprehensively in advance. In addition to fully manual control, the robot may offer a set of semi-autonomous skills such as picking up a cup, opening a dishwasher, placing a cup inside, closing the dishwasher, driving to a location, etc. A human operator may instruct the robot to execute these individual skills, rather than controlling every motion, improving efficiency and reliability.

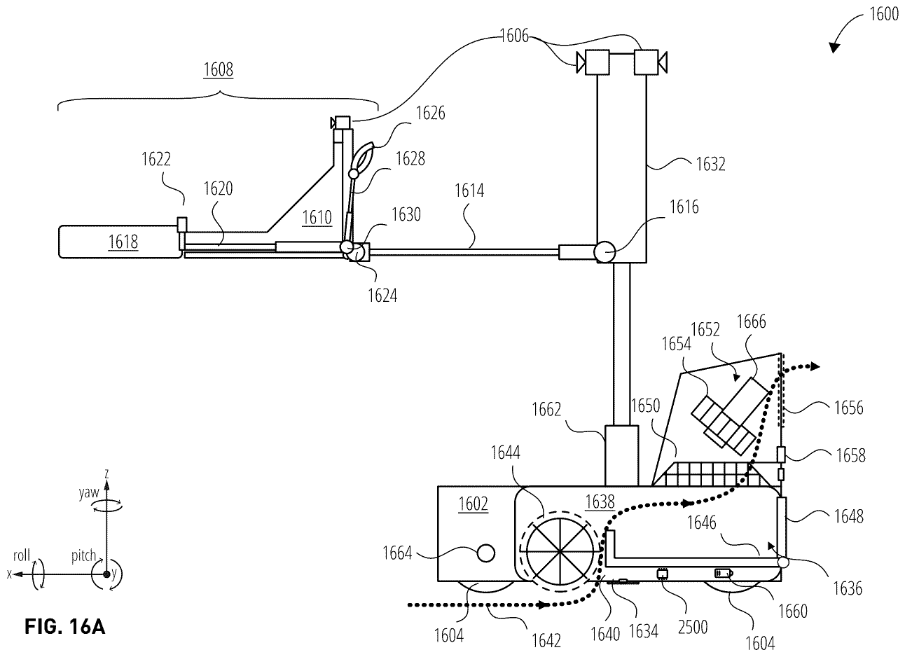

Human operators may also teach the robot new skills. A skill may be demonstrated through teleoperation or by physically guiding the robot through the task. These demonstrations may be used for imitation learning 1102, where the robot may infer the objective that the human wishes to achieve. Additional approaches may include vision-action models that map visual observations directly to actions, and vision-language-action models that combine visual input with natural language instructions to generalize skills across different situations. These approaches are described in additional detail with respect to the vision-action model training routine 1400 and vision-language-action model training routine 1500 described with respect to FIGS. 14-15 below.

To accelerate and safeguard learning, a number of skills may be trained first using a digital simulation environment with realistic rendering and physics. In simulation, a model intended for deployment in a robotic control system may practice tasks repeatedly and explore variations without risk of damage to a robot or entities and objects in the environment. Once a skill is performed reliably in simulation, it may be transferred to the real robot and refined further. In some cases, the robot may also learn directly in the real world through trial and error in environments designed with safety constraints, compliant control, and monitoring to protect, persons and pets, objects, and the robot itself.

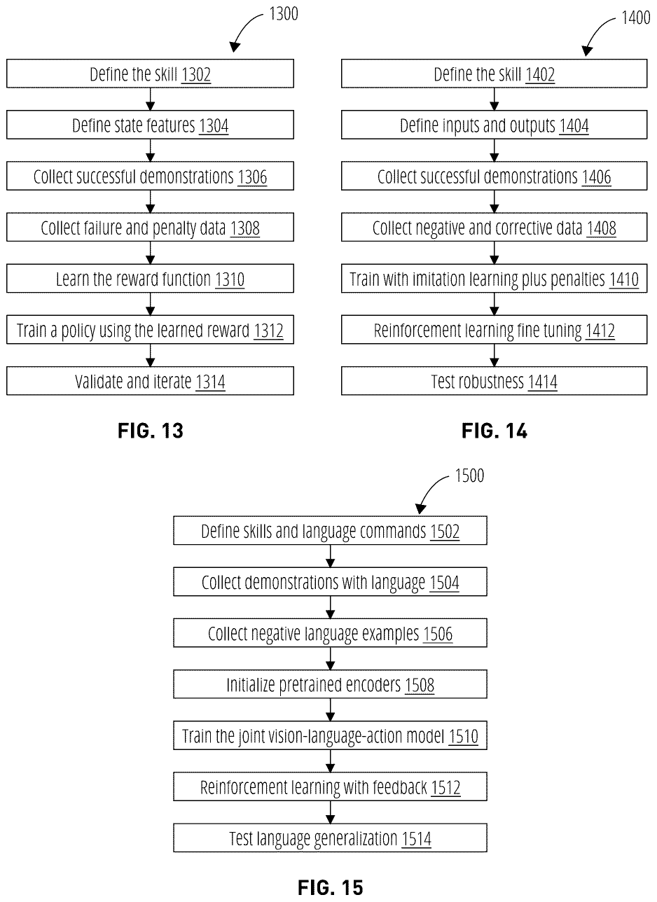

In each of these learning loop training approaches 1100, different types of models training may be employed. These types of model training may include inverse reinforcement learning routine 1300, vision-action model training routine 1400, and vision-language-action model training routine 1500, which are described in detail below with respect to FIGS. 13-15. For each of these training types, the robot may be assumed to have absolute joint encoders, force and torque feedback sensors, red-green-blue (RGB) and RGB depth (RGBD) cameras, sensor logging, action representation, safety constraint enforcement at run time, and safety constraint enforcement during data collection and learning.

Sensor logging may include RGB image capture, RGBD image or point cloud capture, joint position and velocity recording, end effect pose logging, gripper opening and force logging, force torque sensor readings, collision indicator readings, and controller state logging. Action representation may include using a consistent action space across skills, end effector delta pose (position plus orientation), and a gripper open or close command. Safety constraints may include joint motion, extension, and force limits, velocity and torque limits, maximum contact force limits, and collision avoidance/collision stop protection.

FIG. 12 illustrates an example routine 1200 for training an AI model to configure a tidying robot with learned skills and invoking the robot to perform the learned skills. Although the example routine 1200 depicts a particular sequence of operations, the sequence may be altered without departing from the scope of the present disclosure. For example, some of the operations depicted may be performed in parallel or in a different sequence that does not materially affect the function of the routine 1200. In other examples, different components of an example device or system that implements the routine 1200 may perform functions at substantially the same time or in a specific sequence. The logic modules described herein may be deployed as or may access AI models so trained to guide performance of the activities and operations attributed to them in this disclosure.

According to some examples, the method includes receiving, by an artificial intelligence (AI) model, skill definition data at block 1202. A skill is a stored series of robot actions and action parameters by which a tidying robot completes a task step. The skill definition data may include a skill name, a skill start condition, a skill success condition, and at least one skill failure condition. In one embodiment, skill definition data may include one or more natural language commands that the AI model may use to direct the tidying robot to perform the skill.

According to some examples, the method includes receiving, by the AI model, skill input data, including depth measurement data, representing a target environment in which the skill is to be performed at block 1204. In one embodiment, the skill input data may include image data, segmented image data, including semantic segmentation data, robot state data, and force feedback data. In one embodiment, the skill input data may include a natural language embedding.

According to some examples, the method includes configuring the AI model with a common feature set computed from the skill input data for use in performing a plurality of skills at block 1206. The common feature set may include a distance between a target object and a target region, a maximum alignment error, contact force magnitude, a distance to an obstacle, a joint limit margin, and motion smoothness. According to some examples, the method includes computing an end effector delta pose and/or a gripper command using the skill input data at block 1208.

According to some examples, the method includes collecting at least one successful demonstration of the skill, where the skill is executed and the skill success condition is detected at block 1210. According to some examples, the method includes saving the series of robot actions performed during the at least one successful demonstration as a learned skill at block 1212.

According to some examples, the method includes collecting at least one failed demonstration of the skill and use it to guide improvement of the AI model at block 1214. The at least one failed demonstration may be collected when the skill is executed and the at least one skill failure condition is detected. In one embodiment, the AI model may collect successful and failed demonstrations as the tidying robot receives a series of external control signals that direct the tidying robot through execution of the skill, recording real-time skill input data updates as the skill is executed, and providing these updates to the AI model as real-time feedback. In one embodiment, the successful and failed demonstrations may be collected as the tidying robot iterates upon performing the learned skill during autonomous operation or semi-autonomous operation in a controlled target environment. In one embodiment, the successful and failed demonstrations may be collected as the AI model invokes execution of the skill in a simulation environment. In one embodiment, learned skills may be performed in a modified target environment that includes a new environment layout and/or new target objects. Additional successful and failed demonstrations may be collected in this manner and used to guide improvement of the AI model. In one embodiment, the skill failure condition may include a negative natural language command experience. Negative natural language command experiences may comprise correct tidying robot motions paired with an incorrect natural language command, selection of a wrong target object in response to the natural language command, execution of the wrong skill in response to the natural language command, failure to execute the skill in response to an unfamiliar phrasing of the natural language command, detection of a collision, and application of excessive force by an actuator of the tidying robot. In one embodiment, the AI model may receive external approval and rejection signals, which may be used to refine the AI model.

According to some examples, the method includes configuring, with the AI model, a robotic control system of the tidying robot with the learned skill at block 1216. The tidying robot may comprise a chassis, a capture and containment system including a scoop, pusher pads including a first pusher pad and a second pusher pad, pusher pad arms including a first pusher pad arm and a second pusher pad arm, and a gripper arm, and a lifting column configured to raise and lower the capture and containment system through extension and retraction of a lifting column linear actuator. According to some examples, the method includes invoking, by the AI model, a performance of the learned skill by the tidying robot at block 1218.

FIG. 13 illustrates an inverse reinforcement learning routine 1300 in accordance with one embodiment. Although the example inverse reinforcement learning routine 1300 depicts a particular sequence of operations, the sequence may be altered without departing from the scope of the present disclosure. For example, some of the operations depicted may be performed in parallel or in a different sequence that does not materially affect the function of the inverse reinforcement learning routine 1300. In other examples, different components of an example device or system that implements the inverse reinforcement learning routine 1300 may perform functions at substantially the same time or in a specific sequence.

Reinforcement learning is a form of machine learning in which a model may be rewarded or penalized as it makes decisions in its environment based on evaluation of the efficacy of those decisions. This evaluation may be performed by a human agent able to provide input to the model. In inverse reinforcement learning, the rewards and penalties are inferred by the model based on how closely the actions and outcomes it directs match an operation it has learned through observation. The purpose of the inverse reinforcement learning routine 1300 may be for an AI model to learn what the robot may optimize for a given skill by inferring a reward function from demonstrations and failures.

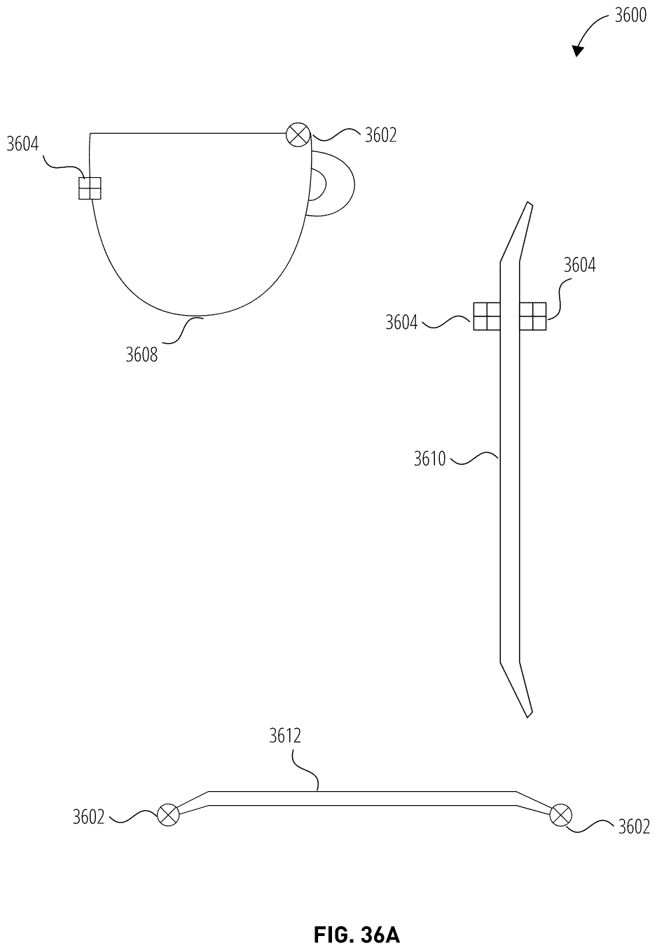

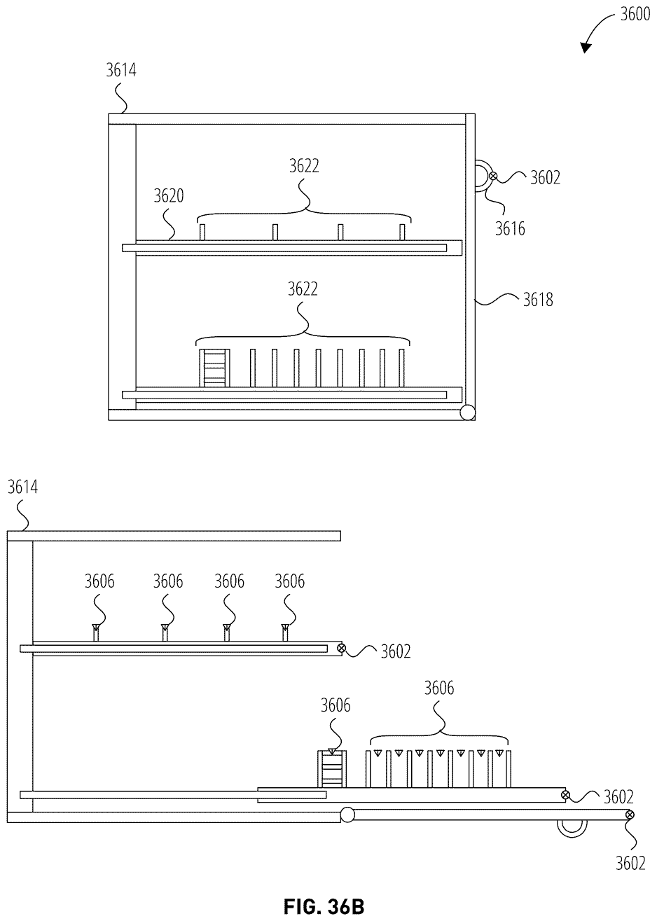

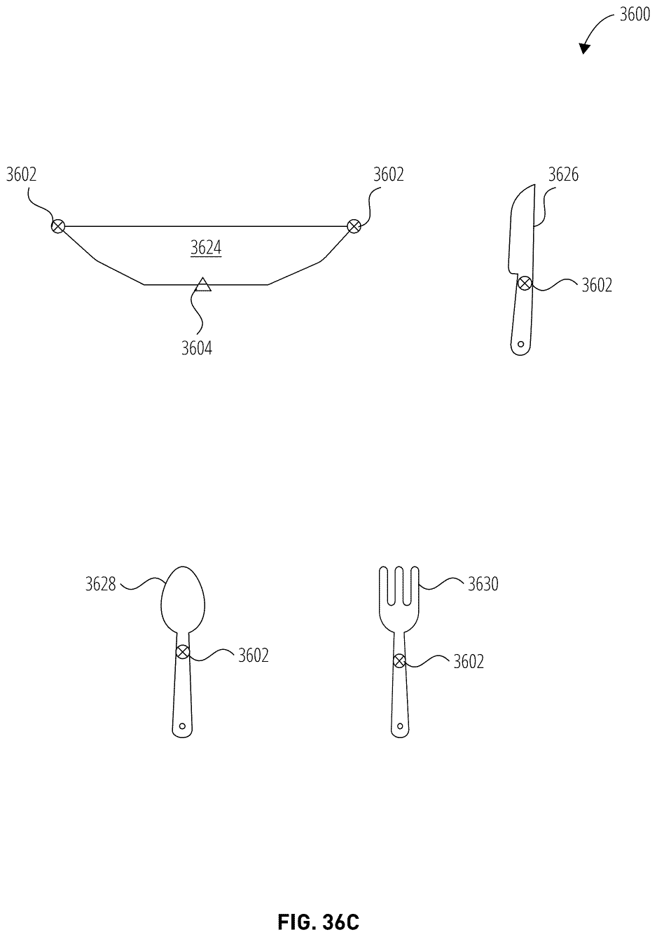

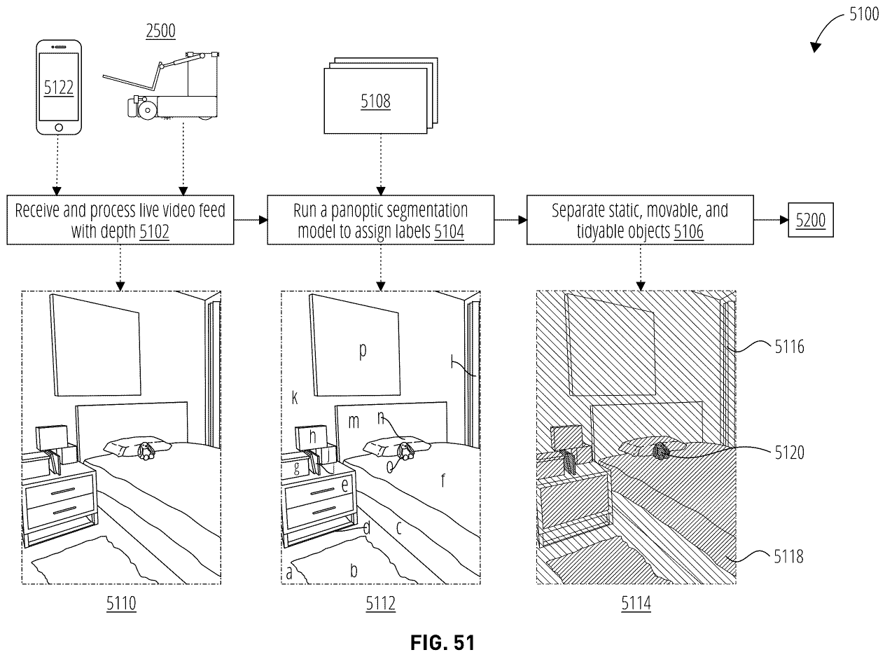

Perception capabilities needed may include semantic image segmentation, depth detection, and keypoint detection. In many cases, inverse reinforcement learning relies on structured state features, which may be most effectively computed using explicit perception modules. Semantic segmentation of image data is described in additional detail with respect to FIG. 51. Keypoints and their detection are described in greater detail with respect to FIGS. 36A-36C and 52-54. Depth measurement data for depth detection may be provided using a number of sensors in various configurations. Depth measurement data may be used by the robot to determine spatial distances between end effectors and target objects, between the robot and target regions, and other distances the robot or portions of the robot need to traverse to accomplish a task step.

The robot may be configured with one or more RGBD camera(s) that provide both visual information and depth. RGBD cameras may combine a camera sensor and LIDAR sensor for depth. In another embodiment, RGBD cameras may use stereo depth determination, where multiple RGB camera feeds with known spatial separation are analyzed jointly to determine depth. A machine learning model may estimates depth from image data provided by these or one or more RGB cameras. Depth measurement data may be determined through motion over time with a single RGB camera in one embodiment. These approaches may also be used together, feeding data into a depth estimation model/algorithm. Sometimes RGBD cameras combine a camera sensor and LIDAR sensor for depth, and sometimes RGBD cameras use stereo depth where multiple RGB camera feeds with known separation are combined to determine depth

According to some examples, the method includes defining the skill at block 1302. For each skill, a skill name, a start condition, a success condition, and failure conditions may be defined. For example, a skill may be named “Place plate in the top dishwasher tray.” Start conditions may include detecting a plate on the table, or detecting a plate in the environment with food particles on it. Success condition may be defined as, “Plate seated, upright, low contact force.” Failure conditions may include collision, dropped plate, or excessive force.

According to some examples, the method includes defining state features at block 1304. A standard feature set may be used across skills. These features may include the distance between object and target region, the alignment error between an end effector and the target object, the contact force magnitude that may be safely exerted by the robot, the distance to obstacles, the joint limit margin that determines how far an end effector or actuator is from reaching its maximum safe range of motion, and motion smoothness exhibited by an actuator over time. These features may be computed from segmentation, depth, force feedback, and robot state perceptions.

Alignment error may be determined visually where the position of both the end effector and target object are known from visual data. Contact force magnitude may be determined from pressure data provided by sensitive, skin-type sensors installed on an end effector to measure how much pressure is exerted when the end effector touches an object. Additionally, actuators such as brushless direct current (BLDC) motors may have current (and/or voltage) feedback where the difference in expected current draw for a motor's motion is compared with actual current draw. If additional current is needed for motion, then the actuator is encountering resistance and pushing against something. These and other force sensors may determine how much force/pressure an actuator is applying on an object.

Force sensor data may be particularly relevant for tasks involving handling delicate objects. For example, in trying to pick up a wine glass where applying too much force may break it, or picking up a heavy object where too little force may cause it to be dropped, the amount of force applied may be monitored and controlled to protect the object as well as the structural and operational integrity of the robot. Force data also allows measurement of the weight of objects when lifting, which may affect how much gripping force is applied to keep it from dropping. Different force magnitudes may also be applied based on different known object types (e.g., in recognizing that glass is breakable). Motion smoothness may be related to contact force magnitude. An abrupt drop in velocity or non-smooth velocity may indicate that an actuator is encountering resistance to motion.

According to some examples, the method includes collecting successful demonstrations at block 1306. This may be accomplished in some embodiments by teleoperating or guiding the robot, recording full state and action trajectory data, validating that success criteria are met, and collecting multiple runs (e.g., twenty runs) for a particular skill. Action trajectory data provides information on actuator position and motion over time while accomplishing a specific action under teleoperation.

According to some examples, the method includes collecting failure and penalty data at block 1308. This may include control failures as well. Failures may include light collisions, misalignment, excessive force, dropped objects, etc. Failure conditions may be labeled with the failure type and the penalty magnitude incurred when the failure is experienced. A control failure may be when the robot does not correctly follow or execute the commanded input, resulting in unintended or unstable behavior. For example, a robot may be commanded to move to a specified position, but it fails to move or moves to a different position instead.

According to some examples, the method includes learning the reward function at block 1310. The inverse reinforcement learning model may be trained to assign high rewards to successful states and low rewards to failure states. These reward rankings may be validated to confirm they align with human judgement in some embodiments. During teleoperation, successful states may include an aligned gripper, stable grasp force, no collision, and the object picked up securely. In contrast, failure states may include misalignment, excessive force, a dropped object, or contact collision. The inverse reinforcement learning algorithm may adjust the reward function so that trajectories containing successful states receive higher total reward than trajectories containing failure states. In one embodiment, a human may not rank each state individually, but success or failure labels may be provided during data collection, and the reward function may then be learned automatically from those labeled trajectories.

According to some examples, the method includes training a policy using the learned reward at block 1312. Reinforcement learning may be used in some embodiments. The policy may be optimized for learned rewards. The policy may be trained to enforce safety constraints. The policy may be a learned function, which may be implemented as a neural network or AI model, that maps the robot's current state to an action, such as joint movements or gripper commands. This policy may be trained using reinforcement learning to select actions that maximize the learned reward, meaning it develops behaviors that lead to successful states and avoids those that lead to failure states. After training is complete, such a policy may be used for inference, where it may take the current state as input and may output actions in real time without updating its parameters.

According to some examples, the method includes validating and iterating at block 1314. Policies and skills developed according to the inverse reinforcement learning routine 1300 may be tested on the robot. Failures may be reviewed and new data included to improve upon failure states encountered. The reward ranking and policies may be retrained as needed.

FIG. 14 illustrates a vision-action model training routine 1400 in accordance with one embodiment. Although the example vision-action model training routine 1400 depicts a particular sequence of operations, the sequence may be altered without departing from the scope of the present disclosure. For example, some of the operations depicted may be performed in parallel or in a different sequence that does not materially affect the function of the vision-action model training routine 1400. In other examples, different components of an example device or system that implements the vision-action model training routine 1400 may perform functions at substantially the same time or in a specific sequence. The vision-action model may be a multimodal foundation model that integrates data from visual input and actions that may be performed. Given an input image or video of a target environment, the vision action model may output low-level robot action that may be executed to accomplish a desired task based on target objects and target regions represented in the input image data.

The purpose of vision-action model training routine 1400 may be for the robot to learn how to execute a skill directly from perception. Perception capabilities needed may include semantic segmentation, depth, and keypoint detection. Vision-action models may be trained end-to-end, but explicit perception training may improve safety and sample efficiency.

According to some examples, the method includes defining the skill at block 1402. For example, an “Open Dishwasher” skill may be defined. The success criteria may include the door being fully open, and low force used to accomplish that. According to some examples, the method includes defining inputs and outputs at block 1404. Inputs may include RGB images, depth measurement data, joint state, and force feedback. Outputs may include end effector delta pose and gripper command. The end effector delta pose may include small, incremental changes in the position and orientation of the robot's end effector relative to its current pose. The inputs may be fed into the policy model as the robot's current state. The policy may process this information and may output low-level control actions, such as a three-dimensional (3D) end-effector translation and rotation command, joint velocity commands, a gripper open or close command, etc. During execution, this input-to-policy-to-action loop may run continuously in real time.

In one embodiment, the policy may output a command including an end effector delta pose such as moving an arm 1 cm forward and 0.5 cm upward, or rotating the arm 10 degrees upward. Output gripper commands may include an open command to move all gripper fingers outward to a preset open position, a close command to move all fingers inward until contact is made or they reach a target position, a hold command to maintain a current finger position and grip force, a set grip width command to specify an opening distance between the fingers, a set grip force command to apply a specified force level while closing, and other commands controlling gripper behavior, as will be readily understood by one of ordinary skill in the art.

According to some examples, the method includes collecting successful demonstrations at block 1406. Successful demonstrations may be collected through teleoperation of the robot. Variations in position, lighting, and viewpoint may be included across demonstrations. Synchronized observation action pairs may be recorded. According to some examples, the method includes collecting negative and corrective data at block 1408. Negative and corrective data may include missed grasps, incorrect motion direction, application of excessive force, collisions, etc. Penalty signals and human intervention events may be labeled as such.

According to some examples, the method includes training with imitation learning plus penalties at block 1410. The robot may be trained to match successful actions. Loss terms may be added to penalize force spikes, collisions, joint limit violations, etc. According to some examples, the method includes reinforcement learning fine tuning at block 1412. A force spike is a sudden, short-lived jump in measured force, such as when the gripper briefly impacts an object and the force rapidly increases for a single time step. Excessive force refers to applying a force that is too high in magnitude, even if it is smooth and steady. Force spikes thus relate to sudden changes, while excessive force relates to sustained high force levels.

Models being fine tuned may be run autonomously in simulation or in a controlled real-world environment. Task successes may be rewarded and unsafe behavior penalized. The safety controller may be kept active across all run cases. The safety controller may be a separate layer that monitors and constrains the actions proposed by the AI policy to support safe operation. If the policy outputs a command that exceeds force limits, joint limits, or collision boundaries, the safety controller may modify or override the command before sending the command to the robot. The safety controller may thus acs as a protective guardrail around the learned model.

According to some examples, the method includes testing robustness at block 1414. Learned skills may be performed in new environment layouts and/or with new object instances. Failures may be collected and retained to guide further improvement.

FIG. 15 illustrates a vision-language-action model training routine 1500 in accordance with one embodiment. Although the example vision-language-action model training routine 1500 depicts a particular sequence of operations, the sequence may be altered without departing from the scope of the present disclosure. For example, some of the operations depicted may be performed in parallel or in a different sequence that does not materially affect the function of the vision-language-action model training routine 1500. In other examples, different components of an example device or system that implements the vision-language-action model training routine 1500 may perform functions at substantially the same time or in a specific sequence.

Among machine learning models, a vision-language-action (VLA) model is a class of multimodal foundation models that integrates vision such as image processing and perception, language such as natural language recognition, and actions, such as robot actions that may be invoked by the model as part of a robotic control system. Given an input image or video of a robot's environment, along with a textual or audible natural language instruction, a VLA model may output low-level robot actions that may be executed to accomplish a learned skill, task step, or task associated with one or more natural language commands.

The purpose of vision-language-action model training routine 1500 may be to execute human-understandable skills based on natural language instructions, using visual perception of the environment. The vision-language-action (VLA) model may decide what the robot should do next, not how to directly drive motors or actuators. Perception capabilities needed for the vision-language-action model training routine 1500 may include semantic segmentation, depth, and keypoint detection. Semantic segmentation may improve language grounding and object disambiguation, such as distinguishing “blue cup” from “red cup”). In one embodiment, additional perception capabilities may be needed, such as language recognition. Language recognition may be employed separately from semantic segmentation. Semantic segmentation is a vision function that labels objects in an image, while language recognition processes and encodes the natural language command. In a VLA model, visual features and language embeddings may be combined to decide the robot's next action. An example of language use with a VLA model may include a language command such as, “pick up the blue cup.”

According to some examples, the method includes defining skills and language commands at block 1502. For each skill, a clear skill boundary and multiple natural language phrasings may be defined. A skill boundary may define the start and end conditions of a skill, meaning when the skill is considered to begin and when it is considered successfully completed or terminated. Commands may include “Open the dishwasher,” “Pick up the blue cup,” and “Place the cup on the top shelf.” Each language command may correspond to a single, human-understandable skill. An “Open Dishwasher” skill may be associated with language commands such as “Open the dishwasher,” “Open up the dishwasher,” “Go open the dishwasher up,” “Open the dishwasher door,” and similar formulations in this manner.

According to some examples, the method includes collecting demonstrations with language at block 1504. For each demonstration that is run, at least one language command may be provided. The robot may be guided or teleoperated to perform the skill. RGB images, depth data, robot state (joint positions, end effector pose, etc.), force and torque feedback data, and action outputs may be recorded. The full trajectory of the skill performance may be associated with the language command(s), the recorded actions being completed using the same action interface that will be in use at runtime.

According to some examples, the method includes collecting negative language examples at block 1506. This collection may cover demonstrations and autonomous attempts that contain otherwise correct motions pared with the wrong instruction, selection of the wrong object in response to a given command, execution of the wrong skill when presented with a command, and unsafe behavior, such as collisions or application of excessive force. Unsafe behavior may be treated as a negative language example when it occurs in response to a specific command. For example, if the instruction is “pick up the blue cup” and the robot collides with the table or applies excessive force, the action is incorrect for that command. The model may thus learn that such behaviors should not occur when executing that instruction. Each negative language example may be labeled with an instruction mismatch penalty and, if applicable, a safety penalty. In this manner, the model may be informed with what actions to avoid for a given command, in addition to what actions it needs to perform.

According to some examples, the method includes initializing pretrained encoders at block 1508. A pretrained vision encoder and a pretrained language encoder may be initialized. Where task data is limited, encoders may be initially frozen and find-tuned at a later time as needed. Freezing an encoder means keeping its pretrained base layers fixed so their weights are not updated during training, while a new, task-specific head is trained on top. For example, pretrained vision and language encoders may generate stable feature representations, and the new task-specific head may be trained to map those features to robot commands. In this manner, useful general knowledge may be preserved, and overfitting may be prevented when task data is limited.

According to some examples, the method includes training the joint vision-language-action model at block 1510. This is the core training step where the joint vision-language-action model may learn to map images, robot state, and language inputs to safe action commands. The overall vision-language-action model training routine 1500 may include data collection, encoder initialization, reinforcement learning fine tuning, and testing as described herein. At block 1510, the model may be trained, while the full vision-language-action model training routine 1500 builds, refines, and evaluates the complete system.

Inputs to block 1510 training may include RGB images, depth data, robot state (joint encoder data, gripper state, force feedback, etc.), and language embedding. Training outputs or action representations ma include intermediate, safe action commands rather than raw actuator control commands. These commands may include end effector target pose or delta pose, motion direction and distance, gripper commands (e.g., open, close, and hold), compliance or impedance modes, and skill or sub-skill identifiers.

Compliance or impedance modes may operate at the motor control level by using force or torque feedback to adjust actuator commands in real time, effectively controlling how stiffly or flexibly the robot behaves. For example, if the robot detects increasing contact force while pushing a drawer, it may reduce motor torque or stop once a maximum force threshold is reached. Similarly, if a human gently pushes on a compliant arm, the controller may allow it to yield slightly like a spring, whereas a rigidly position-controlled arm may resist the push and try to hold its exact position, potentially applying high counterforce instead of yielding.

These outputs may be executed by a lower-level motion and force controller that enforces safety constraints. Training may incorporate loss functions that reward matches to successful demonstration actions and penalize instruction mismatches and unsafe behaviors such as excess force application, collisions, exceeded joint limits, etc.

According to some examples, the method includes reinforcement learning with feedback at block 1512. Reinforcement learning may be used to fine-tune the vision-language-action policy itself. The robot may be allowed to attempt a previously demonstrated or guided skill autonomously. Automatic penalties from force and collisions sensors may be collected, as well as human approval and rejection signals. Collected data may be used to fine-tune the policy while keeping safety controllers active.

According to some examples, the method includes testing language generalization at block 1514. The trained model may be evaluated using unfamiliar phrasings of known language commands, new scenes and layouts, and multiple skills that share objects or regions. Failures may be logged and added back into training as negative or corrective examples.

A large vision-language-action model or vision-action model may be run in the cloud to decide on a next action the robot will perform at a task level. For tidying, this might mean producing a short plan such as “pick up cup #6,” “open the dishwasher,” and “place cup #6 in the top rack.” This model may run relatively slowly and may focus on reasoning over the whole scene, user preferences, and long-horizon strategy.

Individual manipulation skills may be trained separately upon models that may be run by robotic control system components located physically on the robot (i.e., on the edge). These skill models may operate at a much higher frame rate using real-time image, depth, joint encoder, and force feedback data. They may output safe, intermediate action commands and handle contact, force control, and collision avoidance with low latency.

This split may facilitate efficiency by allowing larger, slower cloud-based models to be used to handle heavy reasoning and planning, while the fast, safety-critical motion control is handled by more agile models at the edge. The cloud decides what to do, and the edge decides how to do it safely and quickly.

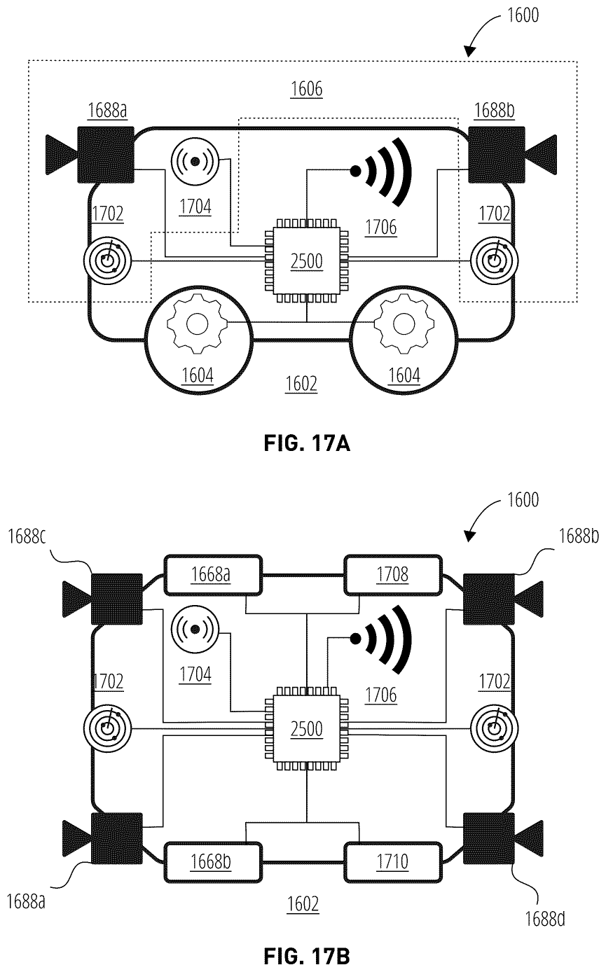

FIG. 16A-FIG. 17B illustrate a tidying robot 1600 in accordance with one embodiment. FIG. 16A shows a side view and FIG. 16B shows a top view. The tidying robot 1600 may comprise a chassis 1602, a mobility system 1604, a sensing system 1606, a capture and containment system 1608, and a robotic control system 2500. The capture and containment system 1608 may further comprise a scoop 1610, a scoop pivot point 1612, a scoop arm 1614, a scoop arm pivot point 1616, two pusher pads 1618 with pad pivot points 1622, two pusher pad arms 1620 with pad arm pivot points 1624, an actuated gripper 1626, a gripper arm 1628 with a gripper pivot point 1630, and a lifting column 1632 to raise and lower the capture and containment system 1608 to a desired height. In one embodiment, the gripper arm 1628 may include features for gripping and/or gripping surfaces in lieu of or in addition to an actuated gripper 1626.

The tidying robot 1600 may further include a mop pad 1634, and robot vacuum system 1636. The robot vacuum system 1636 may include a vacuum compartment 1638, a vacuum compartment intake port 1640, a cleaning airflow 1642, a rotating brush 1644, a dirt collector 1646, a dirt release latch 1648, a vacuum compartment filter 1650, and a vacuum generating assembly 1652 that includes a vacuum compartment fan 1654, a vacuum compartment motor 1666, and a vacuum compartment exhaust port 1656. The tidying robot 1600 may include a robot charge connector 1658, a battery 1660, and number of motors, actuators, sensors, and mobility components as described in greater detail below, and a robotic control system 2500 providing actuation signals based on sensor signals and user inputs.

The chassis 1602 may support and contain the other components of the tidying robot 1600. The mobility system 1604 may comprise wheels as indicated, as well as caterpillar tracks, conveyor belts, etc., as is well understood in the art. The mobility system 1604 may further comprise motors, servos, or other sources of rotational or kinetic energy to impel the tidying robot 1600 along its desired paths. Mobility system 1604 components may be mounted on the chassis 1602 for the purpose of moving the entire robot without impeding or inhibiting the range of motion needed by the capture and containment system 1608. Elements of a sensing system 1606, such as cameras, lidar sensors, or other components, may be mounted on the chassis 1602 in positions giving the tidying robot 1600 clear lines of sight around its environment in at least some configurations of the chassis 1602, scoop 1610, pusher pad 1618, and pusher pad arm 1620 with respect to each other.

The chassis 1602 may house and protect all or portions of the robotic control system 2500, (portions of which may also be accessed via connection to a cloud server) comprising in some embodiments a processor, memory, and connections to the mobility system 1604, sensing system 1606, and capture and containment system 1608. The chassis 1602 may contain other electronic components such as batteries 1660, wireless communications 1706 devices, etc., as is well understood in the art of robotics. The robotic control system 2500 may function as described in greater detail with respect to FIG. 25. The mobility system 1604 and or the robotic control system 2500 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 1608 may comprise a scoop 1610 with an associated scoop motor 1680 to rotate the scoop 1610 into different positions at the scoop pivot point 1612. The capture and containment system 1608 may also include a scoop arm 1614 with an associated scoop arm motor 1678 to rotate the scoop arm 1614 into different positions around the scoop arm pivot point 1616, and a scoop arm linear actuator 1670 to extend the scoop arm 1614. Pusher pads 1618 of the capture and containment system 1608 may have pusher pad motors 1682 to rotate them into different positions around the pad pivot points 1622. Pusher pad arms 1620 may be associated with pusher pad arm motors 1684 that rotate them around pad arm pivot points 1624, as well as pusher pad arm linear actuators 1672 to extend and retract the pusher pad arms 1620. The gripper arm 1628 may include a gripper arm motor 1686 to move the gripper arm 1628 around a gripper pivot point 1630, as well as a gripper arm linear actuator 1674 to extend and retract the gripper arm 1628. In this manner the gripper arm 1628 may be able to move and position itself and/or the actuated gripper 1626 to perform the tasks disclosed herein.

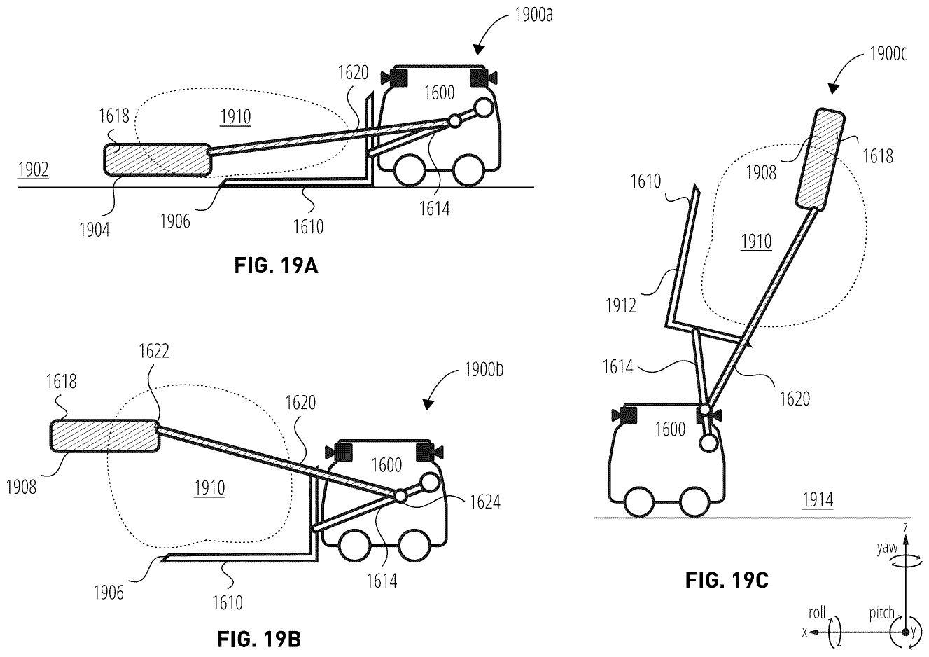

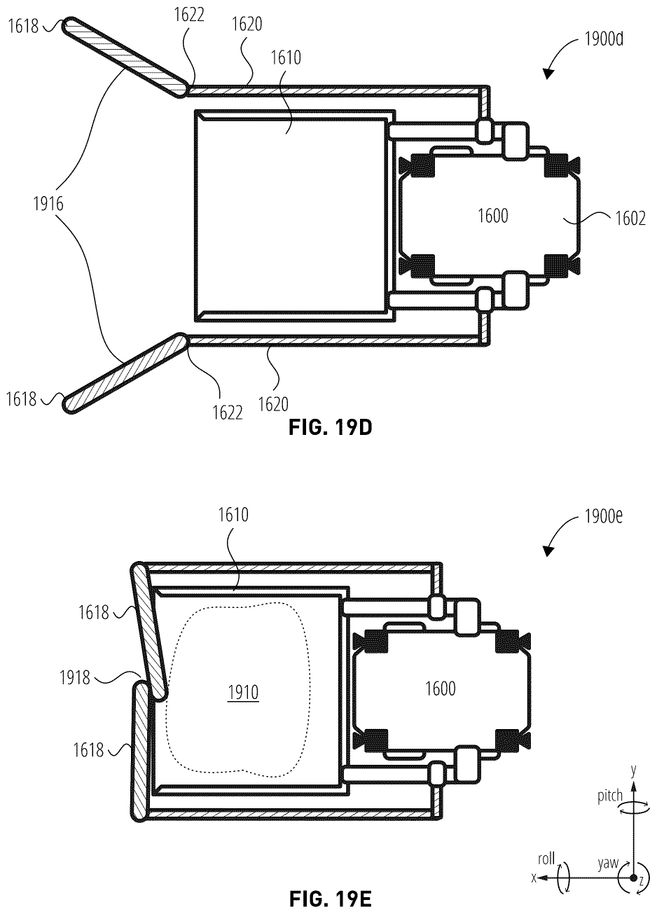

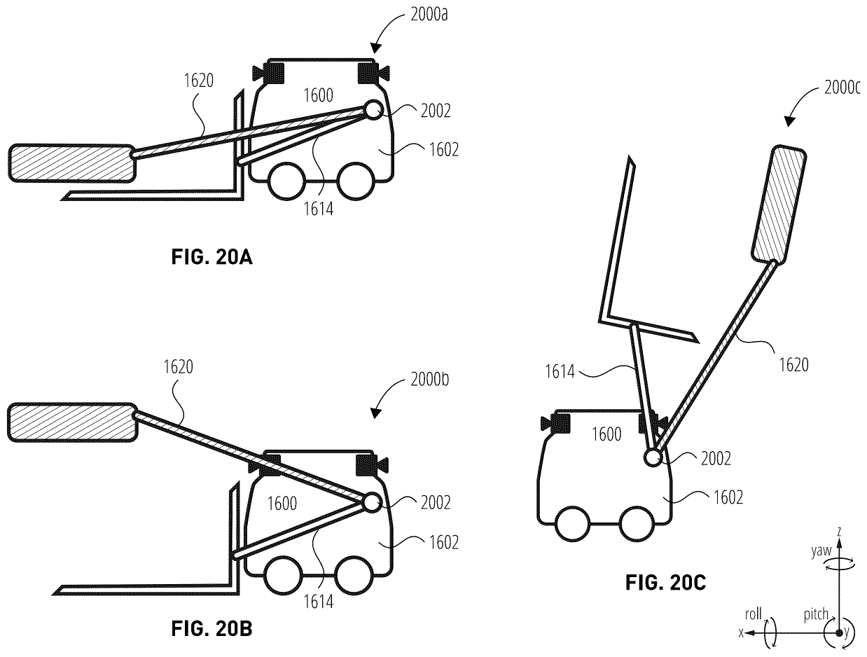

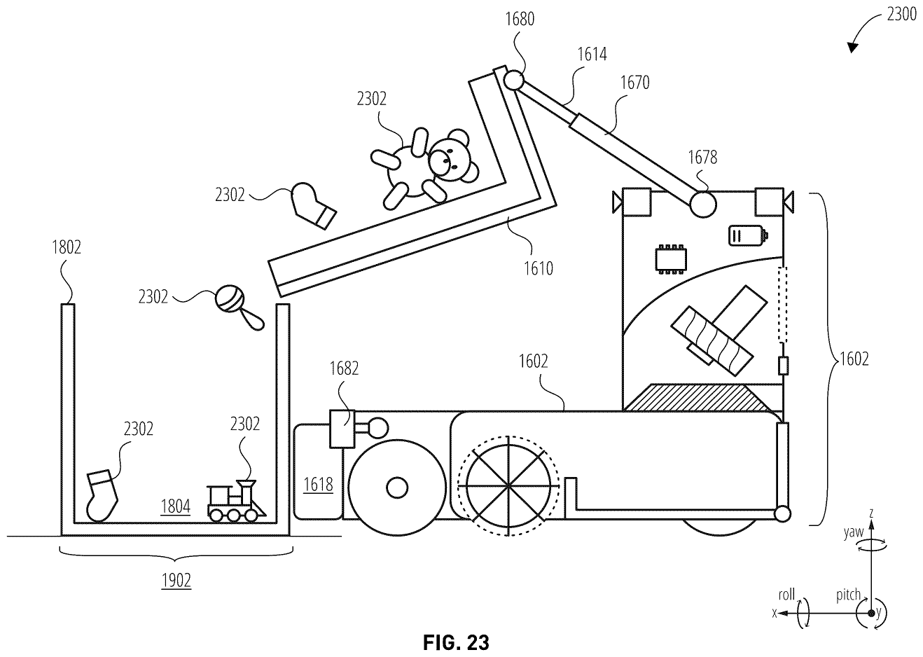

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 1620 may attach to the scoop 1610, as shown here. In other embodiments, the pusher pad arm 1620 may attach to the chassis 1602 as shown, for example, in FIG. 20A or FIG. 23. It will be well understood by one of ordinary skill in the art that the configurations illustrated may be designed to perform the basic motions described with respect to FIG. 19A-FIG. 24 and the processes illustrated elsewhere herein.

The geometry of the scoop 1610 and the disposition of the pusher pads 1618 and pusher pad arms 1620 with respect to the scoop 1610 may describe a containment area, illustrated more clearly in FIG. 19A-FIG. 19E, in which objects may be securely carried. Servos, direct current (DC) motors, or other actuators at the scoop arm pivot point 1616, pad pivot points 1622, and pad arm pivot points 1624 may be used to adjust the disposition of the scoop 1610, pusher pads 1618, and pusher pad arms 1620 between fully lowered scoop and grabber positions and raised scoop and grabber positions, as illustrated with respect to FIG. 19A-FIG. 19C.

In some embodiments, gripping surfaces may be configured on the sides of the pusher pads 1618 facing inward toward objects to be lifted. These gripping surfaces may provide cushion, grit, elasticity, or some other feature that increases friction between the pusher pads 1618 and objects to be captured and contained. In some embodiments, the pusher pad 1618 may include suction cups in order to better grasp objects having smooth, flat surfaces. In some embodiments, the pusher pads 1618 may be configured with sweeping bristles. These sweeping bristles may assist in moving small objects from the floor up onto the scoop 1610. In some embodiments, the sweeping bristles may angle down and inward from the pusher pads 1618, such that, when the pusher pads 1618 sweep objects toward the scoop 1610, the sweeping bristles form a ramp, allowing the foremost bristles to slide beneath the object, and direct the object upward toward the pusher pads 1618, facilitating capture of the object within the scoop and reducing a tendency of the object to be pressed against the floor, increasing its friction and making it more difficult to move.

The capture and containment system 1608, as well as some portions of the sensing system 1606, may be mounted atop a lifting column 1632, such that these components may be raised and lowered with respect to the ground to facilitate performance of complex tasks. A lifting column linear actuator 1662 may control the elevation of the capture and containment system 1608 by extending and retracting the lifting column 1632. A lifting column motor 1676 may allow the lifting column 1632 to rotate so that the capture and containment system 1608 may be moved with respect to the tidying robot 1600 base or chassis 1602 in all three dimensions.

The tidying robot 1600 may include floor cleaning components such as a mop pad 1634 and a vacuuming system. The mop pad 1634 may be able to raise and lower with respect to the bottom of the tidying robot 1600 chassis 1602, so that it may be placed in contact with the floor when desired. The mop pad 1634 may include a drying element to dry wet spots detected on the floor. In one embodiment, the tidying robot 1600 may include a fluid reservoir, which may be in contact with the mop pad 1634 and able to dampen the mop pad 1634 for cleaning. In one embodiment, the tidying robot 1600 may be able to spray cleaning fluid from a fluid reservoir onto the floor in front of or behind the tidying robot 1600, which may then be absorbed by the mop pad 1634.

The vacuuming system may include a vacuum compartment 1638, which may have a vacuum compartment intake port 1640 allowing cleaning airflow 1642 into the vacuum compartment 1638. The vacuum compartment intake port 1640 may be configured with a rotating brush 1644 to impel dirt and dust into the vacuum compartment 1638. Cleaning airflow 1642 may be induced to flow by a vacuum compartment fan 1654 powered by a vacuum compartment motor 1666. cleaning airflow 1642 may pass through the vacuum compartment 1638 from the vacuum compartment intake port 1640 to a vacuum compartment exhaust port 1656, exiting the vacuum compartment 1638 at the vacuum compartment exhaust port 1656. The vacuum compartment exhaust port 1656 may be covered by a grating or other element permeable to cleaning airflow 1642 but able to prevent the ingress of objects into the chassis 1602 of the tidying robot 1600.

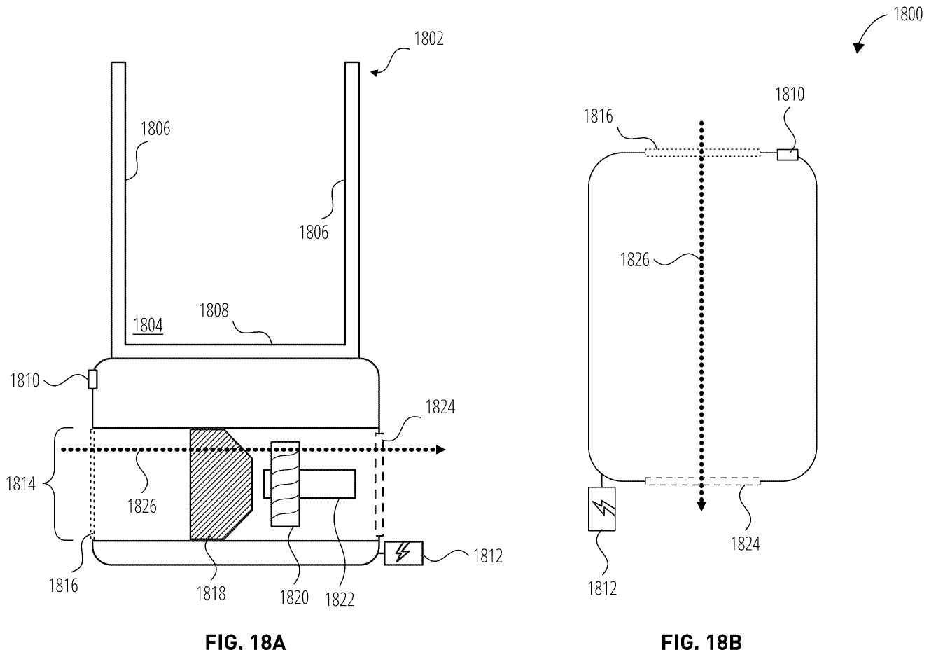

A vacuum compartment filter 1650 may be disposed between the vacuum compartment intake port 1640 and the vacuum compartment exhaust port 1656. The vacuum compartment filter 1650 may prevent dirt and dust from entering and clogging the vacuum compartment fan 1654. The vacuum compartment filter 1650 may be disposed such that blocked dirt and dust are deposited within a dirt collector 1646. The dirt collector 1646 may be closed off from the outside of the chassis 1602 by a dirt release latch 1648. The dirt release latch 1648 may be configured to open when the tidying robot 1600 is docked at a base station 1800 with a vacuum emptying system 1814, as is illustrated in FIG. 18A and FIG. 18B and described below. A robot charge connector 1658 may connect the tidying robot 1600 to a base station charge connector 1810, allowing power from the base station 1800 to charge the tidying robot 1600 battery 1660.

FIG. 17A and FIG. 17B illustrate a simplified side view and top view of a chassis 1602, respectively, in order to show in more detail aspects of the mobility system 1604, the sensing system 1606, and the communications 1706, in connection with the robotic control system 2500. In some embodiments, the communications 1706 may include the network interface 2512 described in greater detail with respect to robotic control system 2500.

In one embodiment, the mobility system 1604 may comprise a left front wheel 1668b and a right front wheel 1668a powered by mobility system motor 1664, and a single rear wheel 1668c, as illustrated in FIG. 16A and FIG. 16B. The single rear wheel 1668c may be actuated or may be a passive roller or caster providing support and reduced friction with no driving force.

In one embodiment, the mobility system 1604 may comprise a right front wheel 1668a, a left front wheel 1668b, a right rear wheel 1708, and a left rear wheel 1710. The tidying robot 1600 may have front-wheel drive, where right front wheel 1668a and left front wheel 1668b are actively driven by one or more actuators or motors, while the right rear wheel 1708 and left rear wheel 1710 spin on an axle passively while supporting the rear portion of the chassis 1602. In another embodiment, the tidying robot 1600 may have rear-wheel drive, where the right rear wheel 1708 and left rear wheel 1710 are actuated and the front wheels turn passively. In another embodiment, the tidying robot 1600 may have additional motors to provide all-wheel drive, may use a different number of wheels, or may use caterpillar tracks or other mobility devices in lieu of wheels.

The sensing system 1606 may further comprise cameras such as the front left camera 1688a, rear left camera 1688b, front right camera 1688c, rear right camera 1688d, and scoop camera 1688e, light detecting and ranging (LIDAR) sensors such as lidar sensors 1702, and inertial measurement unit (IMU) sensors, such as IMU sensors 1704. In some embodiments, there may be a single front camera and a single rear camera.

FIG. 18A and FIG. 18B illustrate a base station 1800 in accordance with one embodiment. FIG. 18A shows a left side view and FIG. 18B shows a top view. The base station 1800 may comprise an object collection bin 1802 with a storage compartment 1804 to hold tidyable objects, heavy dirt and debris, or other obstructions. The storage compartment 1804 may be formed by bin sides 1806 and a bin base 1808. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 1800 may further comprise a base station charge connector 1810, a power source connection 1812, and a vacuum emptying system 1814 including a vacuum emptying system intake port 1816, a vacuum emptying system filter bag 1818, a vacuum emptying system fan 1820, a vacuum emptying system motor 1822, and a vacuum emptying system exhaust port 1824.

The object collection bin 1802 may be configured on top of the base station 1800 so that a tidying robot 1600 may deposit objects from the scoop 1610 into the object collection bin 1802. The base station charge connector 1810 may be electrically coupled to the power source connection 1812. The power source connection 1812 may be a cable connector configured to couple through a cable to an alternating current (AC) or direct current (DC) source, a battery, or a wireless charging port, as will be readily apprehended by one of ordinary skill in the art. In one embodiment, the power source connection 1812 is a cable and male connector configured to couple with 120V AC power, such as may be provided by a conventional U. S. home power outlet.

The vacuum emptying system 1814 may include a vacuum emptying system intake port 1816 allowing vacuum emptying airflow 1826 into the vacuum emptying system 1814. The vacuum emptying system intake port 1816 may be configured with a flap or other component to protect the interior of the vacuum emptying system 1814 when a tidying robot 1600 is not docked. A vacuum emptying system filter bag 1818 may be disposed between the vacuum emptying system intake port 1816 and a vacuum emptying system fan 1820 to catch dust and dirt carried by the vacuum emptying airflow 1826 into the vacuum emptying system 1814. The vacuum emptying system fan 1820 may be powered by a vacuum emptying system motor 1822. The vacuum emptying system fan 1820 may pull the vacuum emptying airflow 1826 from the vacuum emptying system intake port 1816 to the vacuum emptying system exhaust port 1824, which may be configured to allow the vacuum emptying airflow 1826 to exit the vacuum emptying system 1814. The vacuum emptying system exhaust port 1824 may be covered with a grid to protect the interior of the vacuum emptying system 1814.

FIG. 19A illustrates a tidying robot 1600 such as that introduced with respect to FIG. 16A disposed in a lowered scoop position and lowered pusher position 1900a. In this configuration, the pusher pads 1618 and pusher pad arms 1620 rest in a lowered pusher position 1904, and the scoop 1610 and scoop arm 1614 rest in a lowered scoop position 1906 at the front 1902 of the tidying robot 1600. In this position, the scoop 1610 and pusher pads 1618 may roughly describe a containment area 1910 as shown.

FIG. 19B illustrates a tidying robot 1600 with a lowered scoop position and raised pusher position 1900b. Through the action of servos or other actuators at the pad pivot points 1622 and pad arm pivot points 1624, the pusher pads 1618 and pusher pad arms 1620 may be raised to a raised pusher position 1908 while the scoop 1610 and scoop arm 1614 maintain a lowered scoop position 1906. In this configuration, the pusher pads 1618 and scoop 1610 may roughly describe a containment area 1910 as shown, in which an object taller than the scoop 1610 height may rest within the scoop 1610 and be held in place through pressure exerted by the pusher pads 1618.

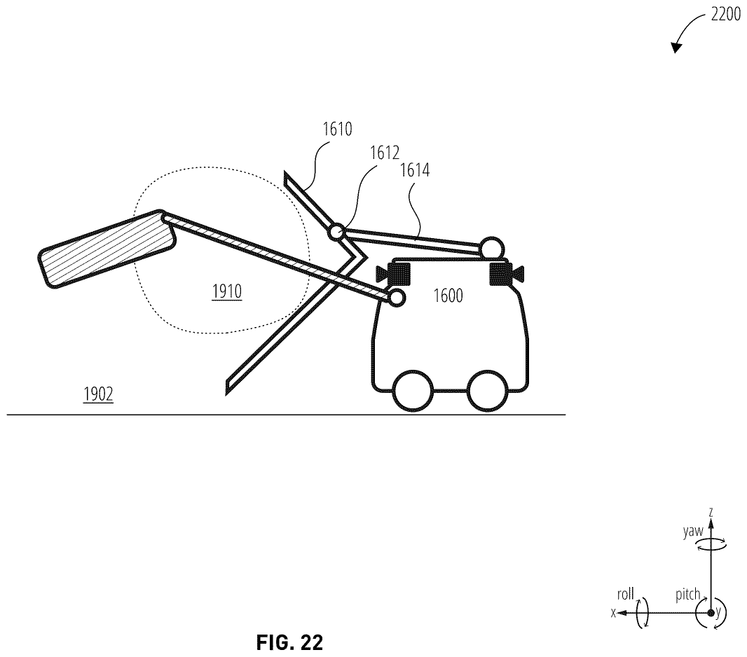

Pad arm pivot points 1624, pad pivot points 1622, scoop arm pivot points 1616 and scoop pivot points 1612 (as shown in FIG. 22) may provide the tidying robot 1600 a range of motion of these components beyond what is illustrated herein. The positions shown in the disclosed figures are illustrative and not meant to indicate the limits of the robot's component range of motion.

FIG. 19C illustrates a tidying robot 1600 with a raised scoop position and raised pusher position 1900c. The pusher pads 1618 and pusher pad arms 1620 may be in a raised pusher position 1908 while the scoop 1610 and scoop arm 1614 are in a raised scoop position 1912. In this position, the tidying robot 1600 may be able to allow objects drop from the scoop 1610 and pusher pad arms 1620 to an area at the rear 1914 of the tidying robot 1600.

The carrying position may involve the disposition of the pusher pads 1618, pusher pad arms 1620, scoop 1610, and scoop arm 1614, in relative configurations between the extremes of lowered scoop position and lowered pusher position 1900a and raised scoop position and raised pusher position 1900c.

FIG. 19D illustrates a tidying robot 1600 with pusher pads extended 1900d. By the action of servos or other actuators at the pad pivot points 1622, the pusher pads 1618 may be configured as extended pusher pads 1916 to allow the tidying robot 1600 to approach objects as wide or wider than the robot chassis 1602 and scoop 1610. In some embodiments, the pusher pads 1618 may be able to rotate through almost three hundred and sixty degrees, to rest parallel with and on the outside of their associated pusher pad arms 1620 when fully extended.

FIG. 19E illustrates a tidying robot 1600 with pusher pads retracted 1900e. The closed pusher pads 1918 may roughly define a containment area 1910 through their position with respect to the scoop 1610. In some embodiments, the pusher pads 1618 may be able to rotate farther than shown, through almost three hundred and sixty degrees, to rest parallel with and inside of the side walls of the scoop 1610.

FIG. 20A-FIG. 20C illustrate a tidying robot 1600 such as that introduced with respect to FIG. 16A. In such an embodiment, the pusher pad arms 1620 may be controlled by a servo or other actuator at the same point of connection 2002 with the chassis 1602 as the scoop arms 1614. The tidying robot 1600 may be seen disposed in a lowered scoop position and lowered pusher position 2000a, a lowered scoop position and raised pusher position 2000b, and a raised scoop position and raised pusher position 2000c. This tidying robot 1600 may be configured to perform the algorithms disclosed herein.

The point of connection shown between the scoop arms 1614/pusher pad arms 1620 and the chassis 1602 is an exemplary position and is not intended to limit the physical location of this point of connection. Such connection may be made in various locations as appropriate to the construction of the chassis 1602 and arms, and the applications of intended use.

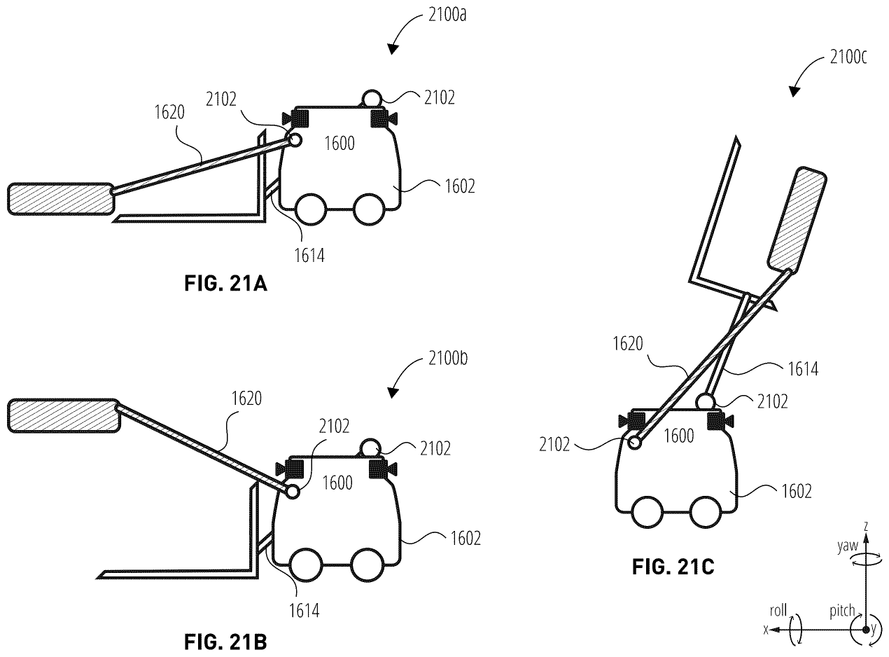

FIG. 21A-FIG. 21C illustrate a tidying robot 1600 such as that introduced with respect to FIG. 16A. In such an embodiment, the pusher pad arms 1620 may be controlled by a servo or servos (or other actuators) at different points of connection 2102 with the chassis 1602 from those controlling the scoop arm 1614. The tidying robot 1600 may be seen disposed in a lowered scoop position and lowered pusher position 2100a, a lowered scoop position and raised pusher position 2100b, and a raised scoop position and raised pusher position 2100c. This tidying robot 1600 may be configured to perform the algorithms disclosed herein.

The different points of connection 2102 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 22 illustrates a tidying robot 1600 such as was previously introduced in a front drop position 2200. The arms of the tidying robot 1600 may be positioned to form a containment area 1910 as previously described.

The tidying robot 1600 may be configured with a scoop pivot point 1612 where the scoop 1610 connects to the scoop arm 1614. The scoop pivot point 1612 may allow the scoop 1610 to be tilted forward and down while the scoop arm 1614 is raised, allowing objects in the containment area 1910 to slide out and be deposited in an area to the front 1902 of the tidying robot 1600.

FIG. 23 illustrates how the positions of the components of the tidying robot 1600 may be configured such that the tidying robot 1600 may approach an object collection bin 1802 and perform a front dump action 2300. The scoop 1610 may be raised by scoop arm motor 1678, extended by scoop arm linear actuator 1670, and tilted by scoop motor 1680 so that tidyable objects 2302 carried in the scoop 1610 may be deposited into the storage compartment 1804 of the object collection bin 1802 positioned to the front 1902 of the tidying robot 1600, as is also described with respect to the front drop position 2200 of FIG. 22.

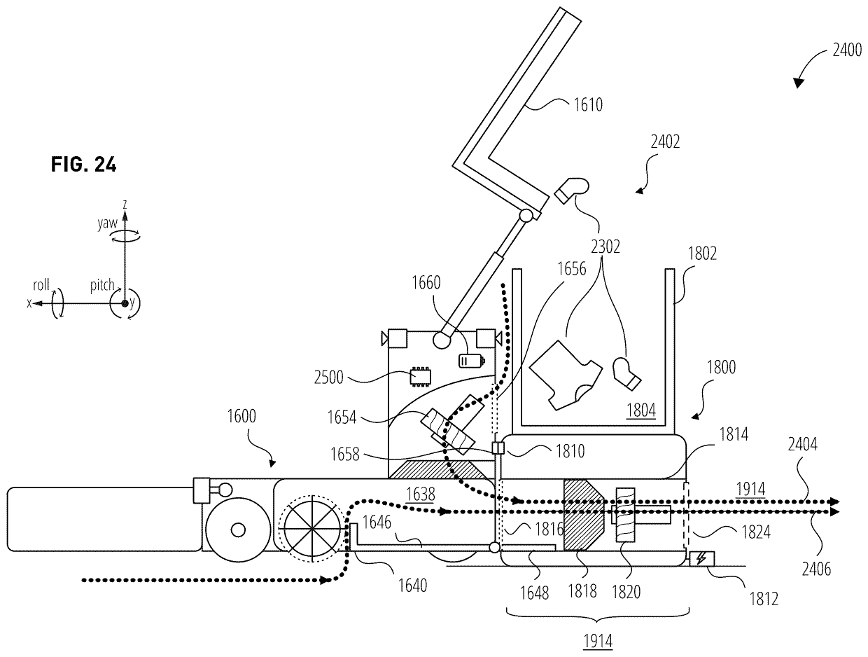

FIG. 24 illustrates a tidying robotic system interaction 2400 in accordance with one embodiment. The tidying robotic system may include the tidying robot 1600, the base station 1800, a robotic control system 2500, and logic 2514 that when executed directs the robot to perform the disclosed method. When the tidying robot 1600 is docked at a base station 1800 having an object collection bin 1802, the scoop 1610 may be raised and rotated up and over the tidying robot 1600 chassis 1602, allowing tidyable objects 2302 in the scoop 1610 to drop into the storage compartment 1804 of the object collection bin 1802 to the rear 1914 of the tidying robot 1600 in a rear dump action 2402, as is also described with respect to the raised scoop position and raised pusher position 1900c and raised scoop position and raised pusher position 2000c described with respect to FIG. 19C and FIG. 20C, respectively.

In a docked state, the robot charge connector 1658 may electrically couple with the base station charge connector 1810 such that electrical power from the power source connection 1812 may be carried to the battery 1660, and the battery 1660 may be recharged toward its maximum capacity for future use.

When the tidying robot 1600 docks at its base station 1800, the dirt release latch 1648 may lower, allowing the vacuum compartment 1638 to interface with the vacuum emptying system 1814. Where the vacuum emptying system intake port 1816 is covered by a protective element, the dirt release latch 1648 may interface with that element to open the vacuum emptying system intake port 1816 when the tidying robot 1600 is docked. The vacuum compartment fan 1654 may remain inactive or may reverse direction, permitting or compelling airflow 2404 through the vacuum compartment exhaust port 1656, into the vacuum compartment 1638, across the dirt collector 1646, over the dirt release latch 1648, into the vacuum emptying system intake port 1816, through the vacuum emptying system filter bag 1818, and out the vacuum emptying system exhaust port 1824, in conjunction with the operation of the vacuum emptying system fan 1820. The action of the vacuum emptying system fan 1820 may also pull airflow 2406 in from the vacuum compartment intake port 1640, across the dirt collector 1646, over the dirt release latch 1648, into the vacuum emptying system intake port 1816, through the vacuum emptying system filter bag 1818, and out the vacuum emptying system exhaust port 1824. In combination, airflow 2404 and airflow 2406 may pull dirt and dust from the dirt collector 1646 into the vacuum emptying system filter bag 1818, emptying the dirt collector 1646 for future vacuuming tasks. The vacuum emptying system filter bag 1818 may be manually discarded and replaced on a regular basis.

FIG. 25 depicts an embodiment of a robotic control system 2500 to implement components and process steps of the systems described herein. Some or all portions of the robotic control system 2500 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 2500 on a cloud server and/or user's mobile computing device may control more than one robot at a time, allowing multiple robots to work in concert within a working space.

Input devices 2504 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 2504 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 2504 are provided via various machine signal conductors (e.g., busses or network interfaces) and circuits to memory 2506.

The memory 2506 is typically what is known as a first- or second-level memory device, providing for storage (via configuration of matter or states of matter) of signals received from the input devices 2504, instructions and information for controlling operation of the central processing unit or processor 2502, and signals from storage devices 2510. The memory 2506 and/or the storage devices 2510 may store computer-executable instructions and thus forming logic 2514 that when applied to and executed by the processor 2502 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 2514 may include portions of a computer program, along with configuration data, that are run by the processor 2502 or another processor. Logic 2514 may include one or more machine learning models 2516 used to perform the disclosed actions. In one embodiment, portions of the logic 2514 may also reside on a mobile or desktop computing device accessible by a user to facilitate direct user control of the robot.

Information stored in the memory 2506 is typically directly accessible to the processor 2502 of the device. Signals input to the device cause the reconfiguration of the internal material/energy state of the memory 2506, creating in essence a new machine configuration, influencing the behavior of the robotic control system 2500 by configuring the processor 2502 with control signals (instructions) and data provided in conjunction with the control signals.

Second- or third-level storage devices 2510 may provide a slower but higher capacity machine memory capability. Examples of storage devices 2510 are hard disks, optical disks, large-capacity flash memories or other non-volatile memory technologies, and magnetic memories.

In one embodiment, memory 2506 may include virtual storage accessible through a connection with a cloud server using the network interface 2512, as described below. In such embodiments, some or all of the logic 2514 may be stored and processed remotely.

The processor 2502 may cause the configuration of the memory 2506 to be altered by signals in storage devices 2510. In other words, the processor 2502 may cause data and instructions to be read from storage devices 2510 in the memory 2506 which may then influence the operations of processor 2502 as instructions and data signals, and which may also be provided to the output devices 2508. The processor 2502 may alter the content of the memory 2506 by signaling to a machine interface of memory 2506 to alter the internal configuration and then converted signals to the storage devices 2510 alter its material internal configuration. In other words, data and instructions may be backed up from memory 2506, which is often volatile, to storage devices 2510, which are often non-volatile.

Output devices 2508 are transducers that convert signals received from the memory 2506 into physical phenomena such as vibrations in the air, patterns of light on a machine display, vibrations (i.e., haptic devices), or patterns of ink or other materials (i.e., printers and 3-D printers).

The network interface 2512 receives signals from the memory 2506 and converts them into electrical, optical, or wireless signals to other machines, typically via a machine network. The network interface 2512 also receives signals from the machine network and converts them into electrical, optical, or wireless signals to the memory 2506. The network interface 2512 may allow a robot to communicate with a cloud server 2522 containing logic 2514, a mobile device, other robots, and other network-enabled devices.

In one embodiment, a global database 2518 may provide data storage available across the devices that comprise or are supported by the robotic control system 2500. The global database 2518 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 2518 may be a single data structure or may be distributed across more than one data structure and storage platform, as may best suit an implementation of the disclosed solution. In one embodiment, the global database 2518 is coupled to other components of the robotic control system 2500 through a wired or wireless network, and in communication with the network interface 2512.

In one embodiment, a robot instruction database 2520 may provide data storage available across the devices that comprise or are supported by the robotic control system 2500. The robot instruction database 2520 may include the programmatic routines that direct specific actuators of the tidying robot, such as are described previously, to actuate and cease actuation in sequences that allow the tidying robot to perform individual and aggregate motions to complete tasks.

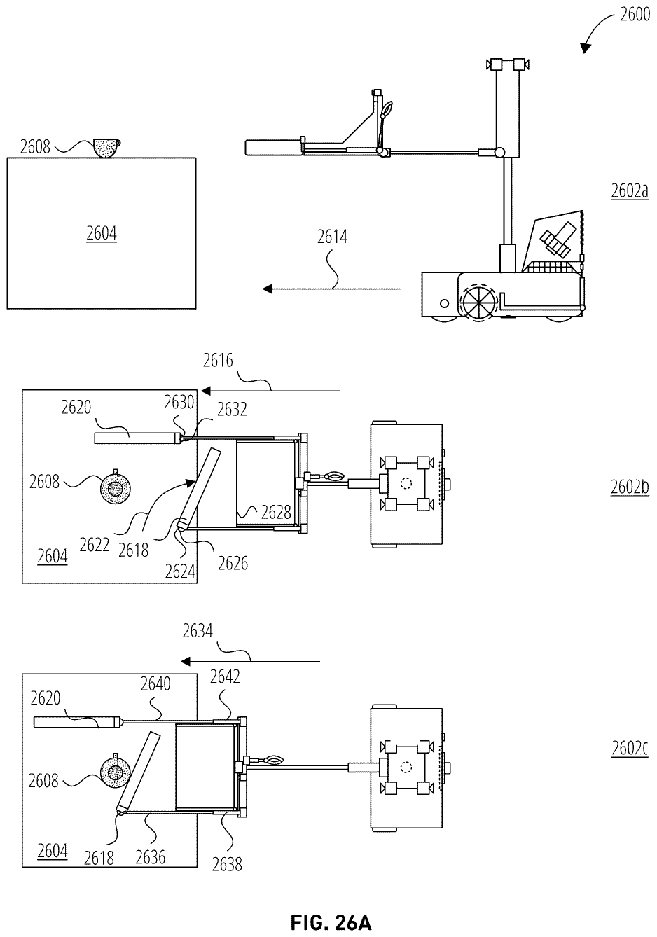

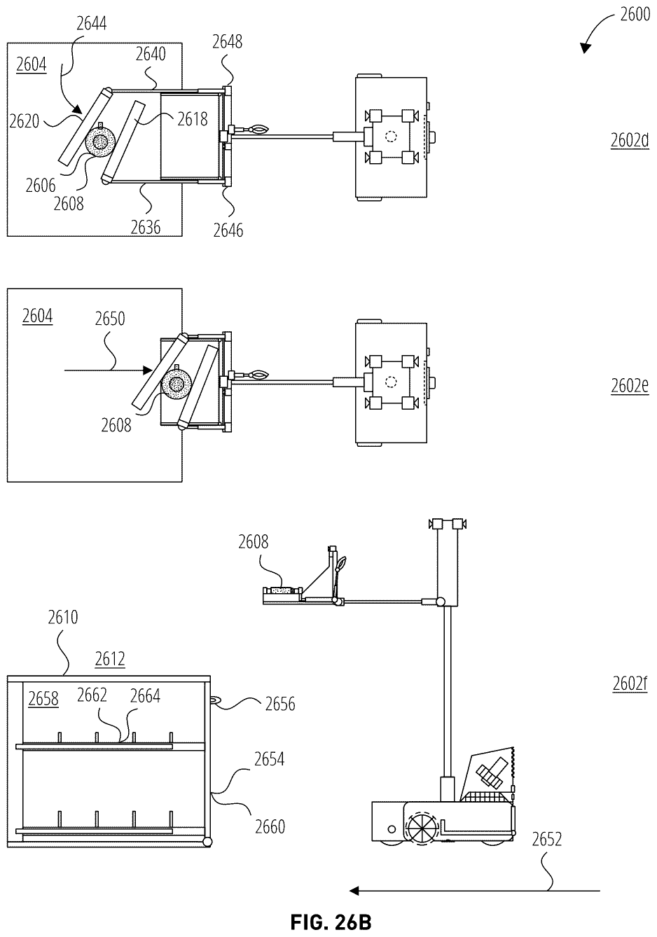

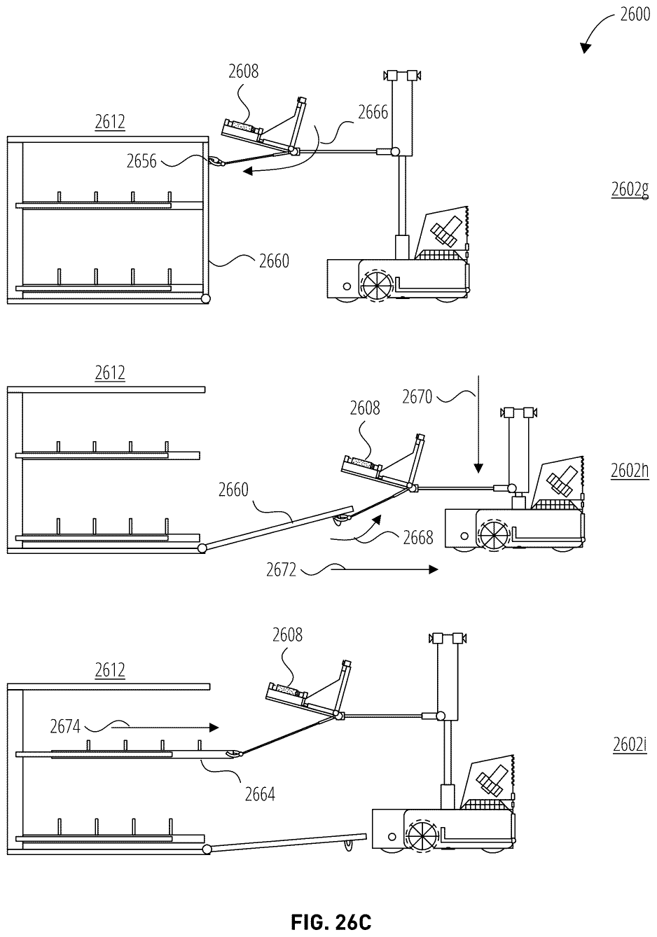

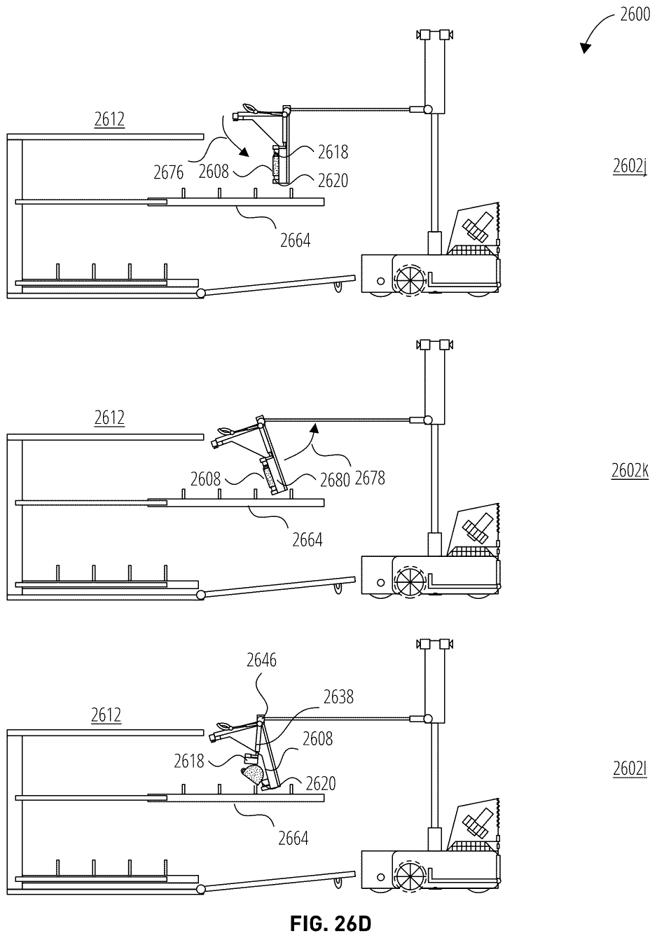

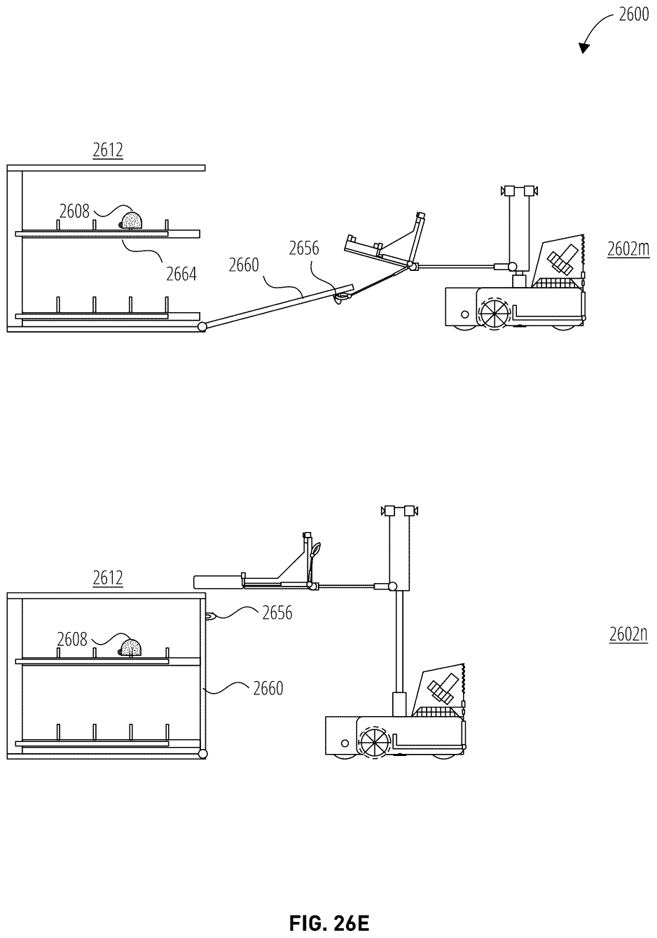

FIG. 26A-FIG. 26E illustrate an item placement procedure 2600 in accordance with one embodiment. Steps 2602a-2602n illustrate the actions a tidying robot 1600 may take to approach a tabletop or countertop 2604, remove an obstruction 2606 such as a dirty cup 2608, and place it at a destination 2610, such as a dishwasher 2612. In step 2602a, the tidying robot 1600 may approach 2614 the countertop 2604 through the action of the mobility system 1604. The tidying robot 1600 may have its pusher pads 1618 extended in front of the scoop 1610. The lifting column 1632 may be elevated such that the bottom of the scoop 1610 is level with and slightly above the top of the countertop 2604.

In step 2602b, the tidying robot 1600 may continue to approach 2616 the countertop 2604 and the cup 2608 with the first pusher pad 2618 rotated inward 2622 at a first pad pivot point 2624 by a first pusher pad motor 2626 toward the front edge 2628 of the scoop 1610, and parallel to or angled toward that front edge 2628. The second pusher pad 2620 may be open and pointing forward as shown or may be rotated outward at a second pad pivot point 2630 by a second pusher pad motor 2632 to be further away from the scoop 1610 front edge 2628. In step 2602c, the tidying robot 1600 may drive forward or may extend 2634 the scoop arm linear actuator 1670, and/or the first pusher pad arm 2636 using the first pusher pad arm linear actuator 2638 and the second pusher pad arm 2640 using the second pusher pad arm linear actuator 2642, horizontally forward until the cup 2608 is in contact with the first pusher pad 2618.

In step 2602d, the tidying robot 1600 may close 2644 the second pusher pad 2620 so that the cup 2608 is held firmly between the first pusher pad 2618 and the second pusher pad 2620. The first pusher pad arm motor 2646 at the base of the first pusher pad arm 2636 and the second pusher pad arm motor 2648 at the base of the second pusher pad arm 2640 may be rotated to lift the cup 2608 slightly up and off of the countertop 2604. The cup 2608 may be positioned slightly above the level of the front edge 2628 of the scoop 1610. In step 2602e, the pusher pad arm linear actuator 1672 may retract 2650 so that the cup 2608 passes above the front edge 2628 into an area fully above the scoop 1610. The first and second pusher pad arm motor 1684 may rotate to lower the cup 2608 onto the scoop 1610.

In step 2602f, the tidying robot 1600 may plan and execute an approach path 2652, using the mobility system 1604 to drive from the countertop 2604 to the destination 2610, such as the dishwasher 2612. The destination 2610 may have an access panel 2654 with a handle 2656 allowing access to an interior of the destination 2658, such as a dishwasher door 2660. The destination 2610 may include storage platforms 2662 such as dishwasher trays 2664. During path planning and navigation, the tidying robot 1600 may hold the cup 2608 securely in the scoop 1610 with the pusher pads 1618. In step 2602g, the tidying robot 1600 may rotate and extend 2666 the gripper arm 1628 underneath the scoop 1610 so that the gripper arm 1628 or actuated gripper 1626 may grab the handle 2656 of the dishwasher door 2660.

In step 2602h, the tidying robot 1600 may retract and potentially rotate 2668 the gripper arm 1628 to begin opening the dishwasher 2612. The tidying robot 1600 may then retract the lifting column linear actuator 1662 to lower 2670 the lifting column 1632 while backing up 2672 using its mobility system 1604 to fully open the dishwasher door 2660. In step 2602i, the tidying robot 1600 may use the gripper arm 1628 or actuated gripper 1626 to pull out 2674 one of the dishwasher trays 2664 while still holding the cup 2608 securely in the scoop 1610. This action may be performed through similar forward and backward motions of the tidying robot 1600 along with extension, retraction, and rotation of the gripper arm 1628, raising and lowering of the lifting column 1632, etc.

In step 2602j, the tidying robot 1600 may extend the scoop arm linear actuator 1670 of the scoop arm 1614 so that the scoop 1610 is over the dishwasher tray 2664. The scoop motor 1680 may rotate 2678 so that the scoop 1610 begins to invert 2676. At this time, the first pusher pad 2618 and second pusher pad 2620 may still apply firm pressure to the cup 2608. In step 2602k, the scoop motor 1680 may continue to rotate 2678 the scoop 1610 so that the cup 2608 is held in a partially inverted position 2680 slightly above the dishwasher tray 2664 while the cup is still held securely in the scoop 1610.

In step 26021, the first pusher pad 2618 may rotate slightly through the action of its first pusher pad arm motor 2646, and the first pusher pad arm linear actuator 2638 may extend slightly as shown, moving the cup 2608 slowly out of the scoop 1610 and onto the dishwasher tray 2664. The first pusher pad 2618 and second pusher pad 2620 may maintain firm pressure on the cup 2608 as it is being moved to keep its motion steady and controlled. In step 2602m, the cup 2608 may now rest safely on the dishwasher tray 2664. The tidying robot 1600 may push the dishwasher tray 2664 back into the dishwasher 2612 and close the dishwasher door 2660 through coordinated operation of the mobility system 1604, gripper arm 1628, lifting column 1632, etc., in a manner similar to the steps previously described.

In step 2602n, now that the cup 2608 is in the dishwasher 2612, the dishwasher door 2660 is closed, and the handle 2656 is released, the tidying robot 1600 may plan a path to return to the countertop to pick up another dish to put in the dishwasher 2612, to navigate to a base station, or to perform other tidying tasks. Once the dishwasher 2612 has completed washing the cup 2608, it may be removed from the dishwasher 2612 using steps similar to those implemented to remove the cup 2608 from the countertop 2604.

One of ordinary skill in the art will appreciate that, while the first pusher pad is shown here to be the left pusher pad and the second pusher pad is illustrated as the right pusher pad, the actions described here and elsewhere in this disclosure may be performed as readily with the right pusher pad being the first and the left the second. The designations “first,” “second,” “right,” and “left” used herein are not intended to limit the performance of these actions to a specifically sided sequence of motion for the tidying robot 1600.

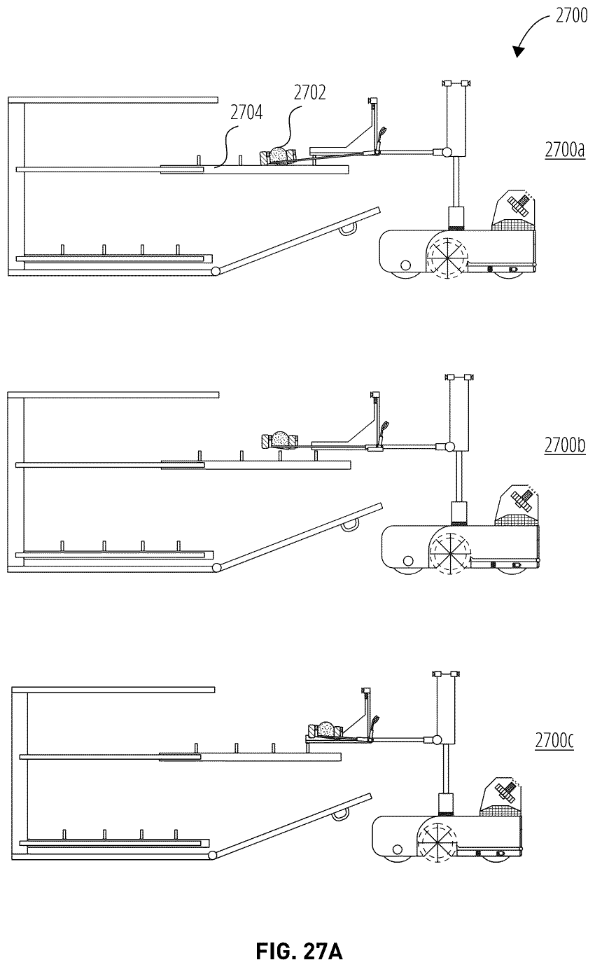

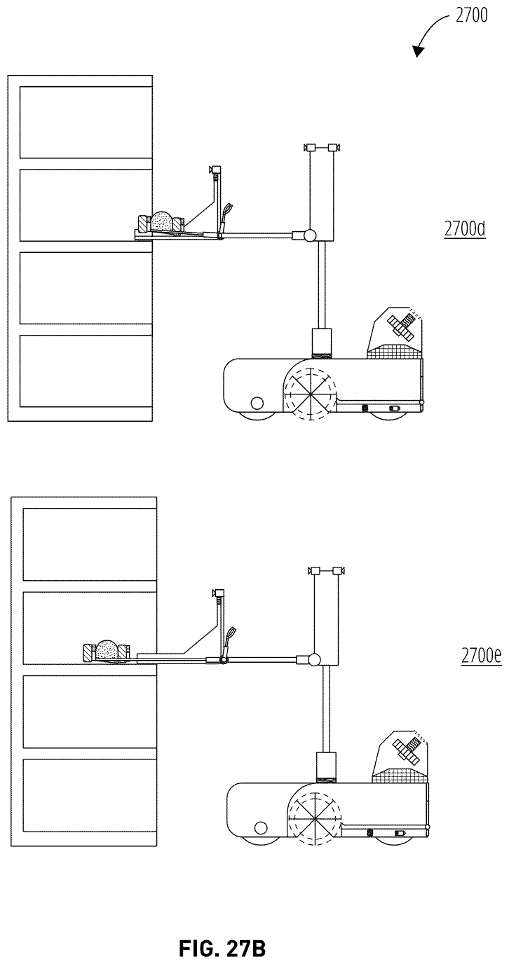

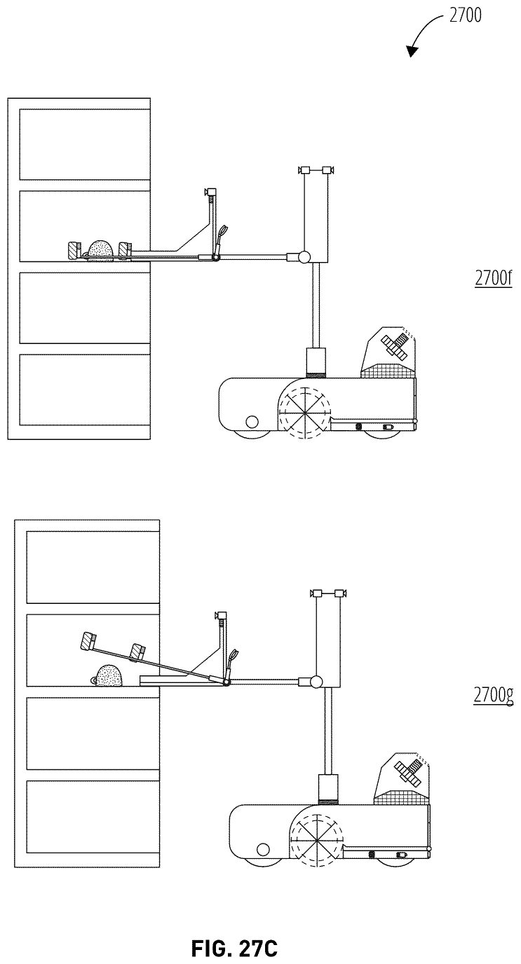

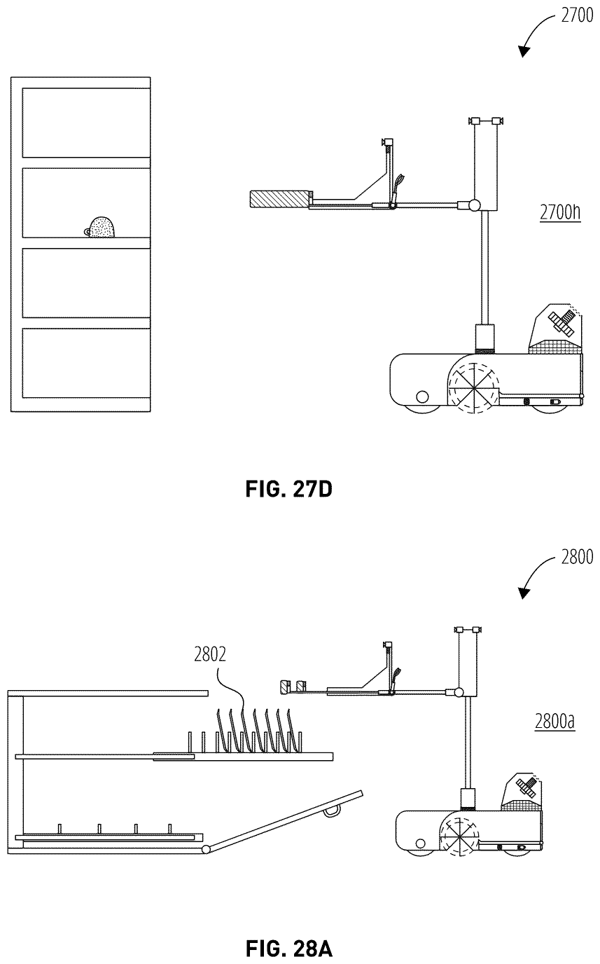

FIG. 27A-FIG. 27D illustrate an item removal procedure 2700 in accordance with some embodiments. The item removal procedure 2700 shows the general purpose tidying robot unloading the dishwasher, and putting the cup it picks up onto a shelf or into a cupboard. In step 2700a, the pusher pads of a tidying robot grip a cup 2702 that is on a storage tray 2704 in the dishwasher. In some embodiments, a first pusher pad is rotated inward toward a front edge of the scoop. The tidying robot approaches the cup 2702 and stops when the cup 2702 is positioned between the pusher pads and contacts the inward rotated first pusher pad. Next, the second pusher pad is rotated until the second pusher pad contacts the cup 2702. In step 2700b, the cup is lifted off of the storage tray 2704 using the pusher pads. In step 2700c, the cup is moved onto the scoop by retracting the pusher pad arms.

After the cup 2702 has been transport to a shelf or cupboard, in step 2700d, the scoop is placed near the edge of the shelf followed by step 2700e, where the cup pushed off of the scoop and onto the shelf by extending the pusher pad arms. In step 2700f, the pusher pads release the cup onto the shelf, followed by step 2700g, where the pusher pads are raised up above the cup. In step 2700h, the scoop is removed from the shelf by backing up the tidying robot.

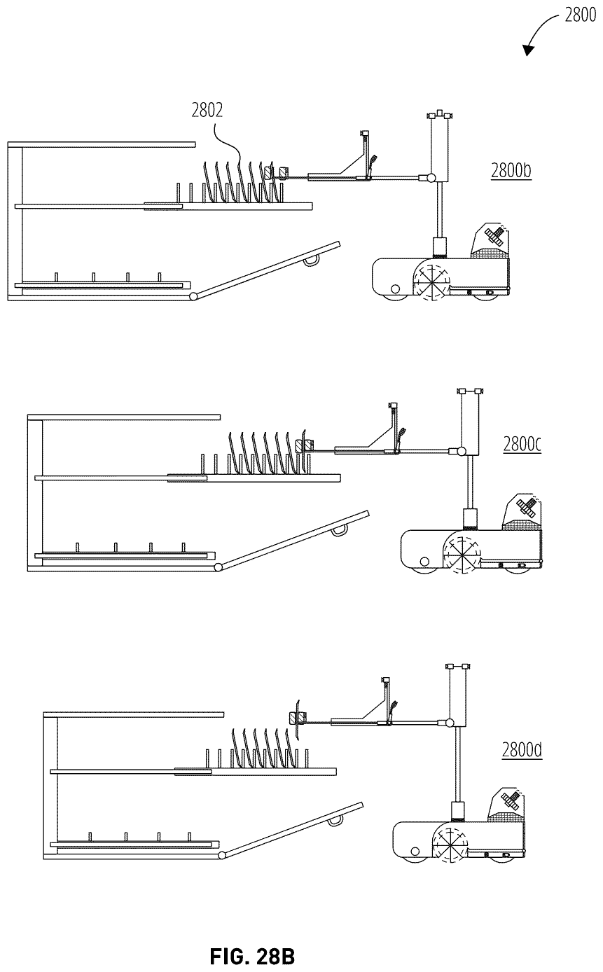

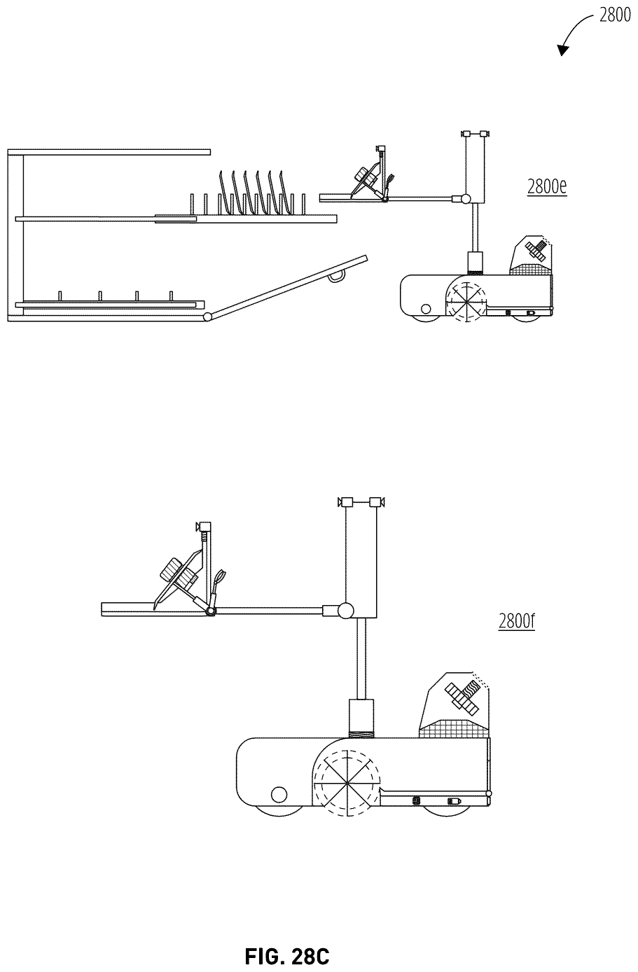

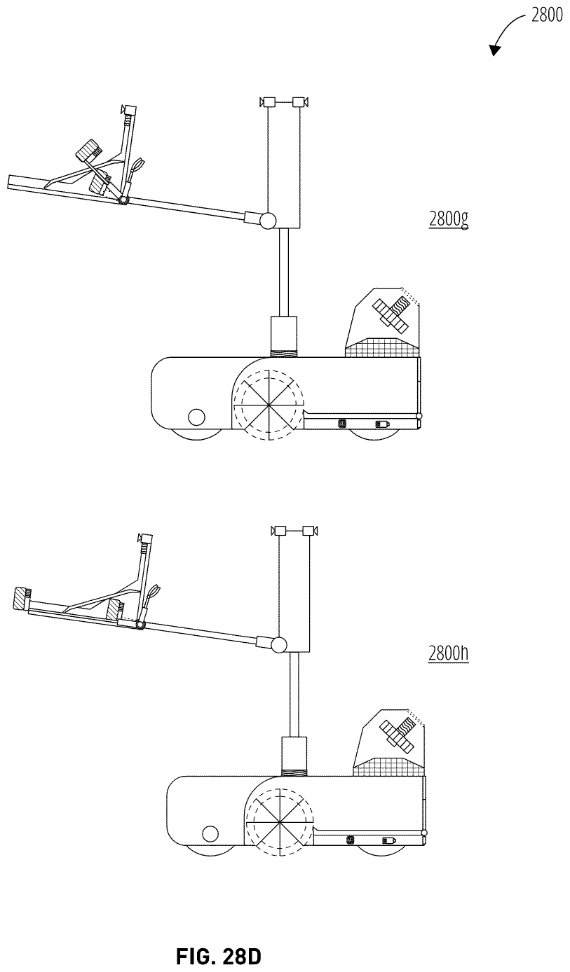

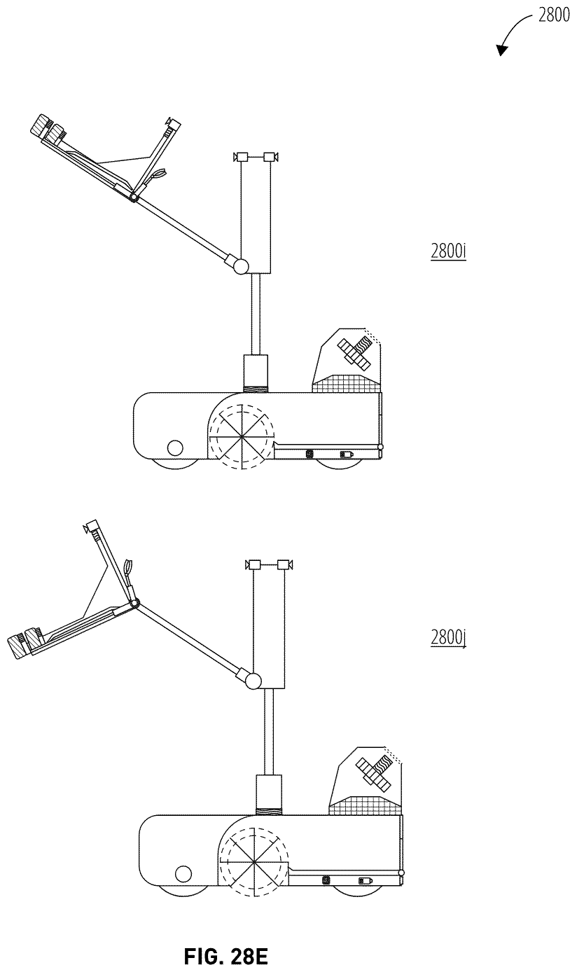

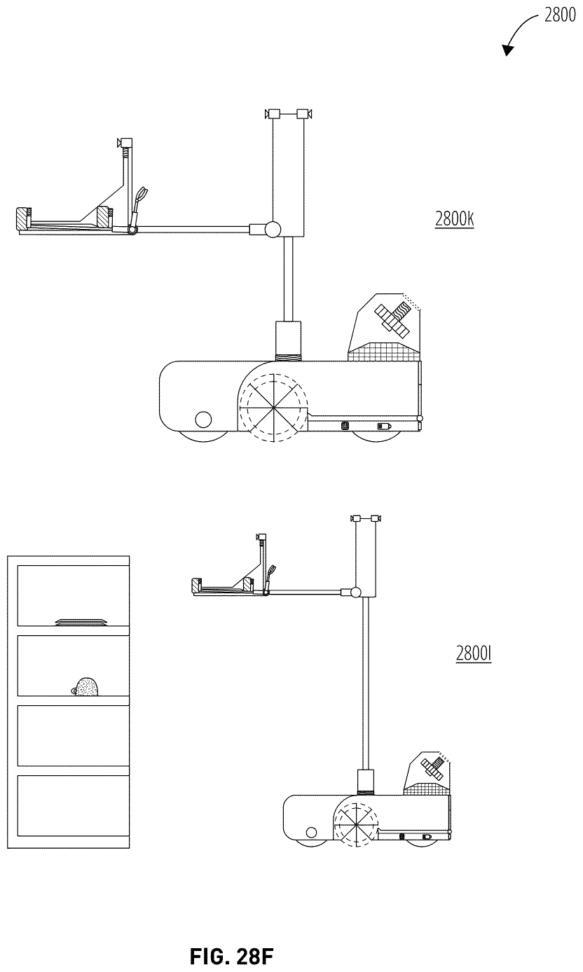

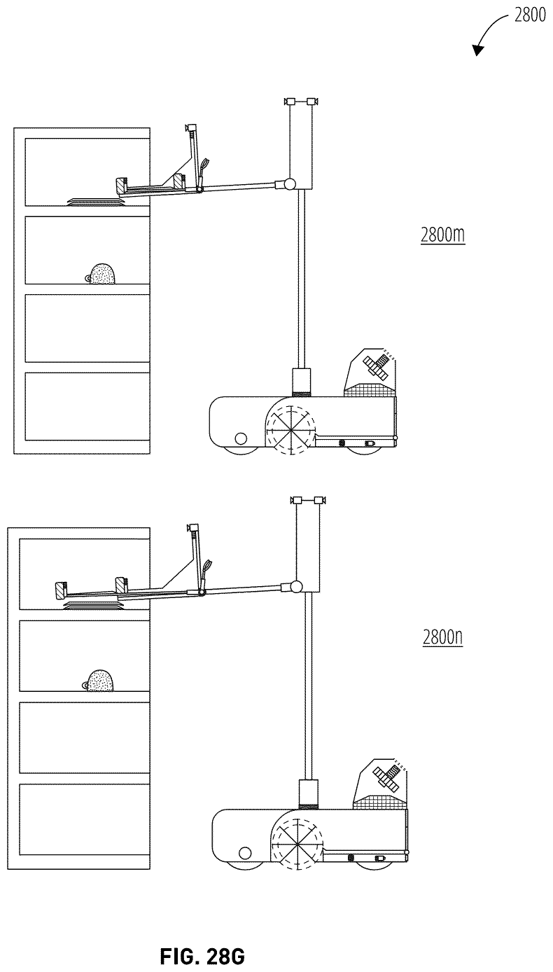

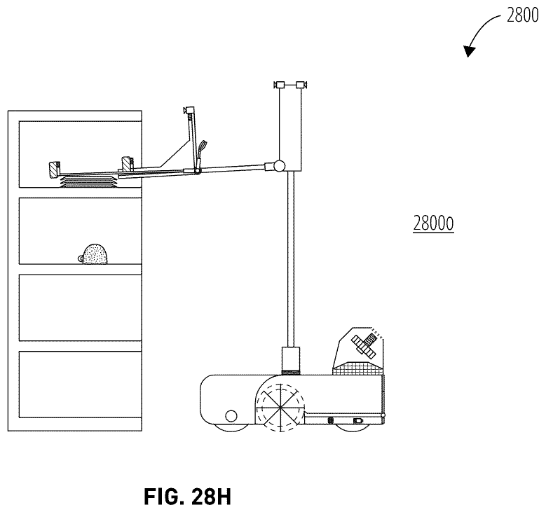

FIG. 28A-FIG. 28H illustrate an item removal procedure 2800 in accordance with some embodiments. The item removal procedure 2800 shows how to unload multiple plates 2802. In step 2800a, the pusher pad arms are positioned immediately above the plate 2802 followed by step 2800b, where the pusher pad arms are lowered so that the plate 2802 is encapsulated. The pusher pad arms close in step 2800c in order to grasp the plate 2802. Next, in step 2800d, the plate 2802 is lifted vertically using the lifting column linear actuator. In step 2800e, the pusher pad arms move the plate into the scoop while also, in some embodiments, lowering the scoop to minimize the distance above the dishwasher storage tray. In step 2800f, after the plate is removed from the dishwasher, it is initially held between the pusher pads. In order to start the movement of the plate to a flat position in the bottom of the scoop, in step 2800g, the scoop is tilted back slightly and the lower pusher arm is retraced and rotated down so that the plate moves towards the bottom of the scoop. Next, in step 2800h, the free pusher pad is used to block the front of the scoop so that the plate 2802 cannot slide off of the scoop. In step 2800i, the pusher pad arm under the plate is extended towards the front of the scoop so that it is no longer under the plate. In some embodiments, the scoop is further tilted back so that the plate falls towards the back of scoop and may minimize the impact force of plate falling off of pusher pad into the scoop. According to step 2800j, the scoop may be tilted forward, moving the plate towards the front of the scoop so that a pusher pad arm may be placed behind the plate. In step 2800k, the pusher arms are moved together to hold the plate with one pusher pad arm in front of the plate and the second pusher pad arm behind the plate. In step 28001, the plate is manipulated such that it is flat in the scoop and slightly forward so that a pusher pad arm can go behind it. In step 2800m, the scoop is positioned immediately next to a stack of plates followed by step 2800n, where the pusher pad arms are used to move the plate to a position immediately above the stack of plates. The pusher arms are opened to place the plate onto the stack of plates in step 28000.

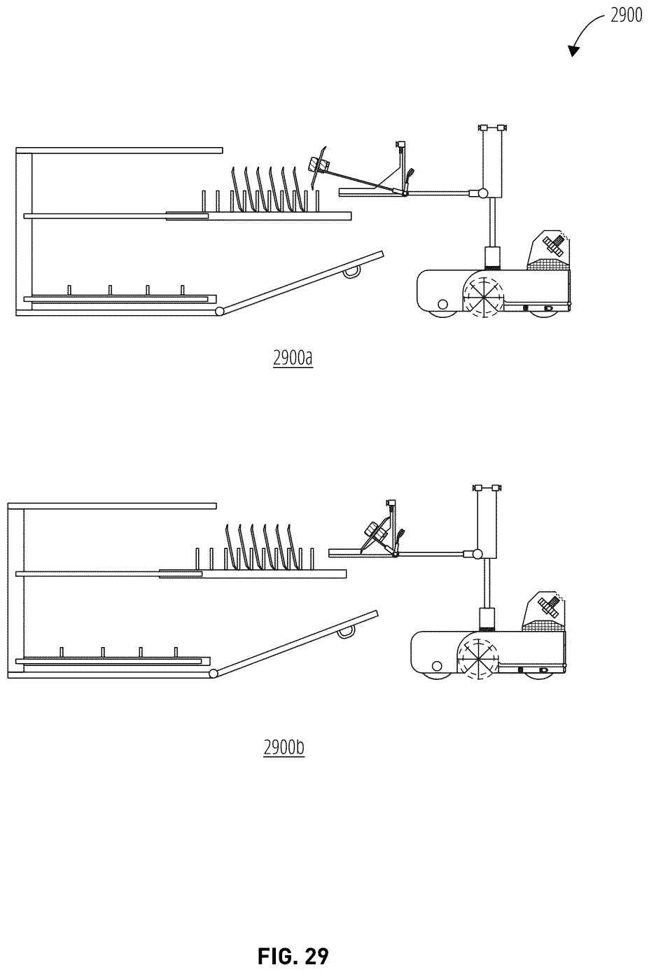

FIG. 29 illustrates an item removal procedure 2900 in accordance with some embodiments. FIG. 29 shows an alternative what of unloading plates from the dishwasher. In step 2900a of this embodiment, the pusher pad arms are rotated to lift the plate, which keeps the scoop closer to the dishwasher rack. This procedure may keep the plate just above the dishwasher rack and scoop so that it is unlikely to be damaged even if dropped. In step 2900b, the pusher pads are used to move the plate into the scoop while also lowering the scoop to minimize the distance above the dishwasher rack.

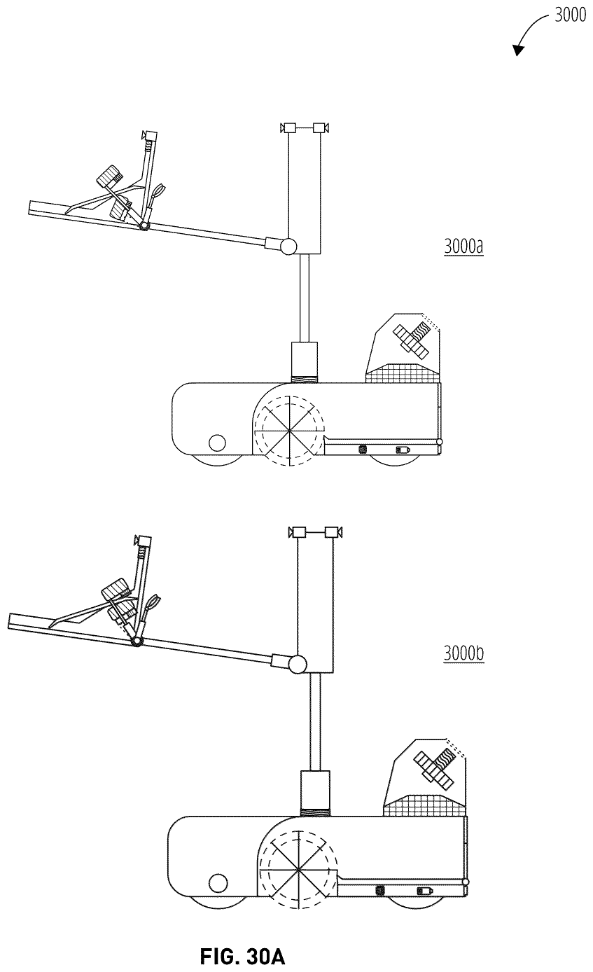

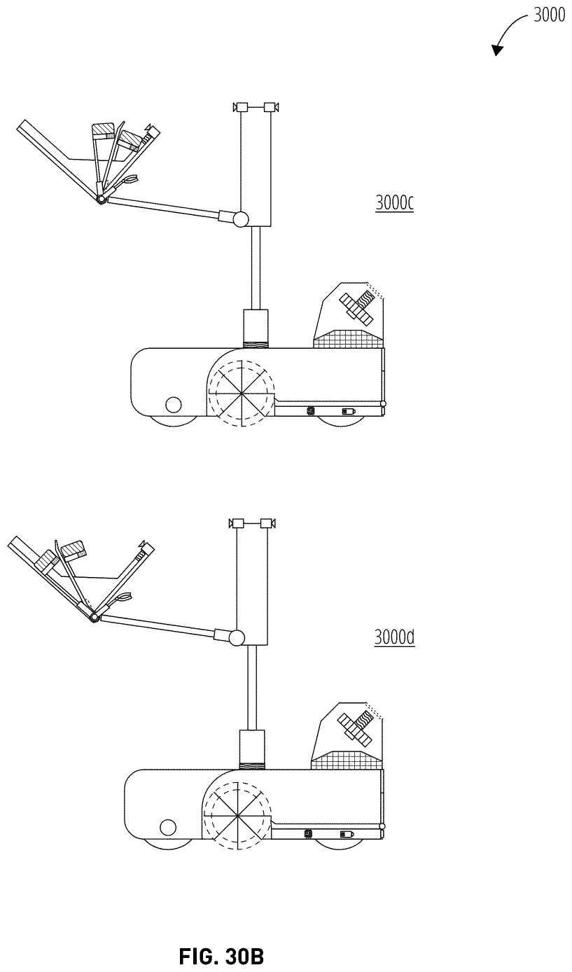

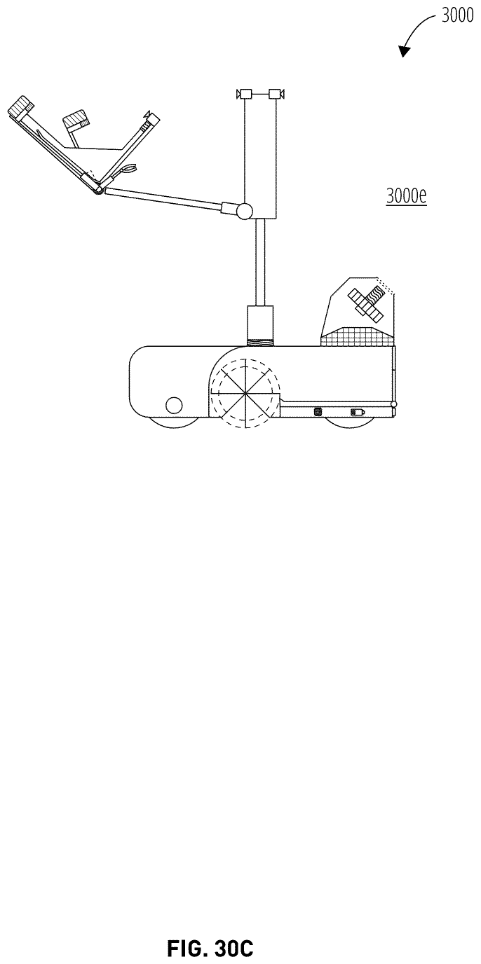

FIG. 30A illustrates an item flipping procedure 3000 in accordance with some embodiments. If a plate has the wrong side up in the scoop then it needs to be flipped before putting it away on a shelf or in a cupboard. In step 3000a, the lower pusher pad arm is retracted so that the plate is not tightly held. Next, in an embodiment shown in step 3000b, the upper and lower pusher pad arms are rotated up toward the top of the plate, where they grasp the edge of the top of the plate. In step 3000c, while keeping a grip on the plate, the pusher arms are extended so that the corner of the plate move to the corner of the scoop. In an embodiment, the plate stays close to the scoop during this maneuver with the pusher arms staying close to the back of the scoop. Next, in step 3000d, the pusher pad arms are rotated, along the plate, from the back of the scoop to the front of the scoop. In step 3000e, the pusher pad arm that is located under the plate is extended, allowing the plate to gently fall onto the scoop, completing the flip maneuver. In some embodiments, the scoop may be kept tilted back to minimize the impact force of the plate falling into the scoop.

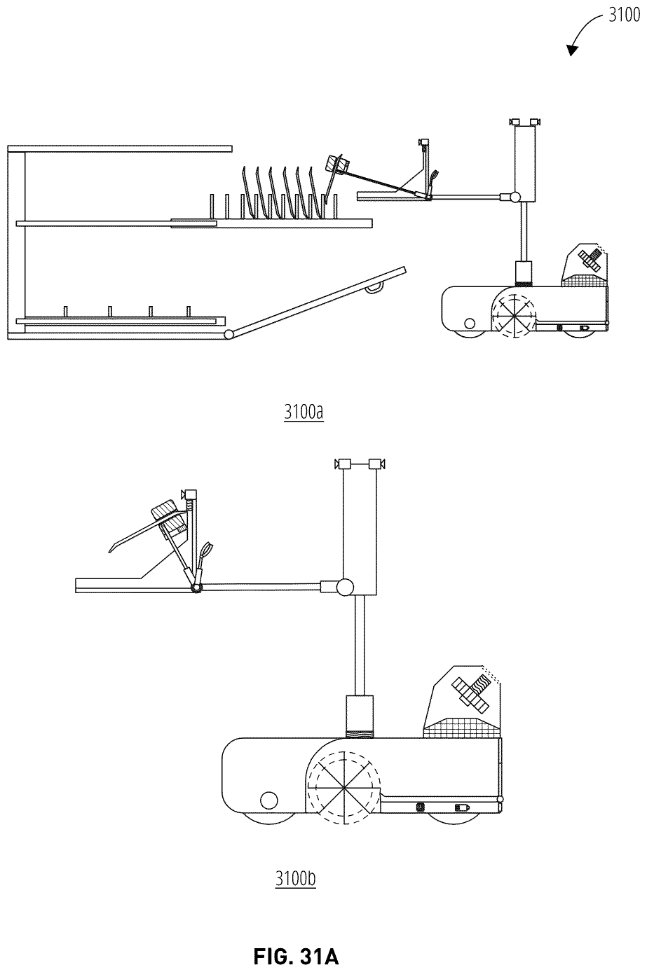

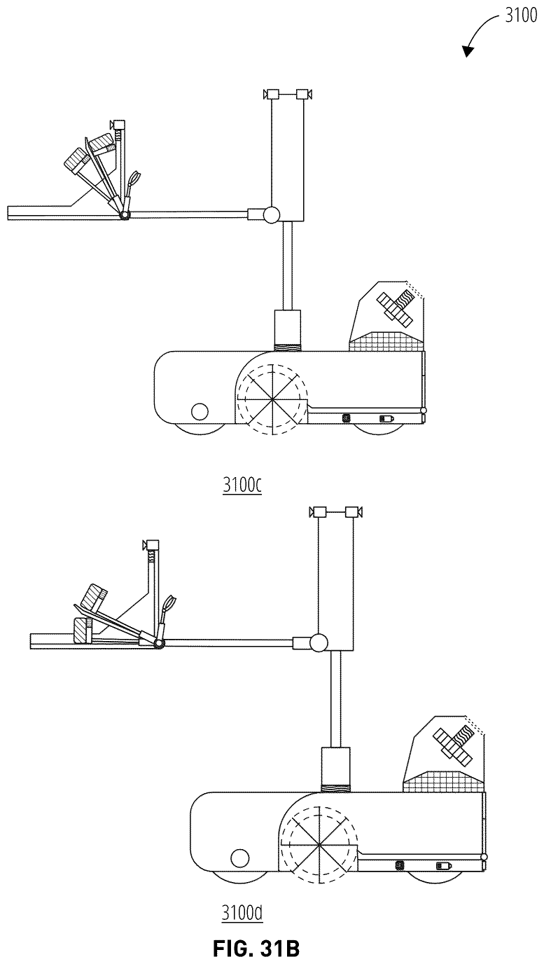

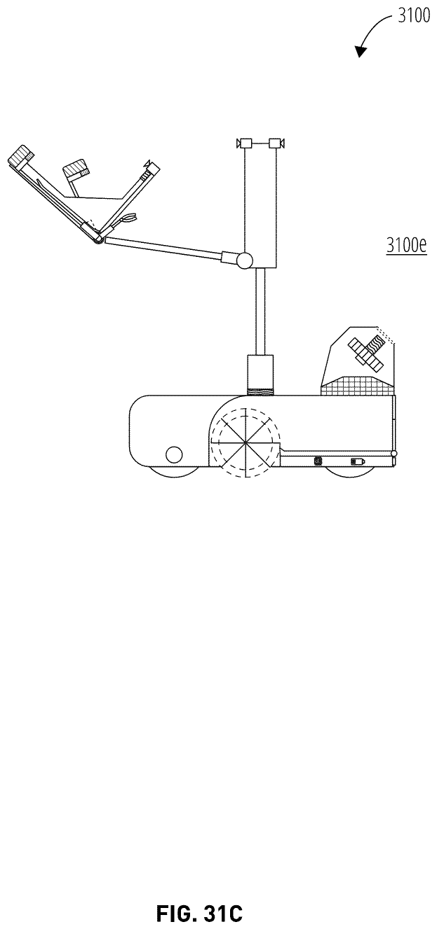

FIG. 31A illustrates an item flipping procedure 3100 in accordance with some embodiments. A second type of plate flipping procedure may begin in step 3100a with grabbing the top of the plate when unloading the plate from a dishwasher. In step 3100b, the pusher pad arms are retracted and rotated, moving the plate above the scoop. In some embodiments, the top of the plate is in contact with the back of the scoop and the bottom of the plate is not in contact with the scoop. In step 3100c, while maintaining pressure on the plate, one of the pusher arm is rotated slightly downwards, causing the corner of the plate to move into a corner of the scoop. This maneuver is similar to the process that occurs if a book is held between ones fingers, and ones fingertips are moved slightly up and slightly down, resulting in moving the bottom edge back and forth in a swinging motion. In step 3100d, the pusher pad arms are rotated from the back of the scoop to the front of the scoop. The flipping maneuver is completed in step 3100e where the pusher pad arm that is under the plate is extended towards the front of the scoop.

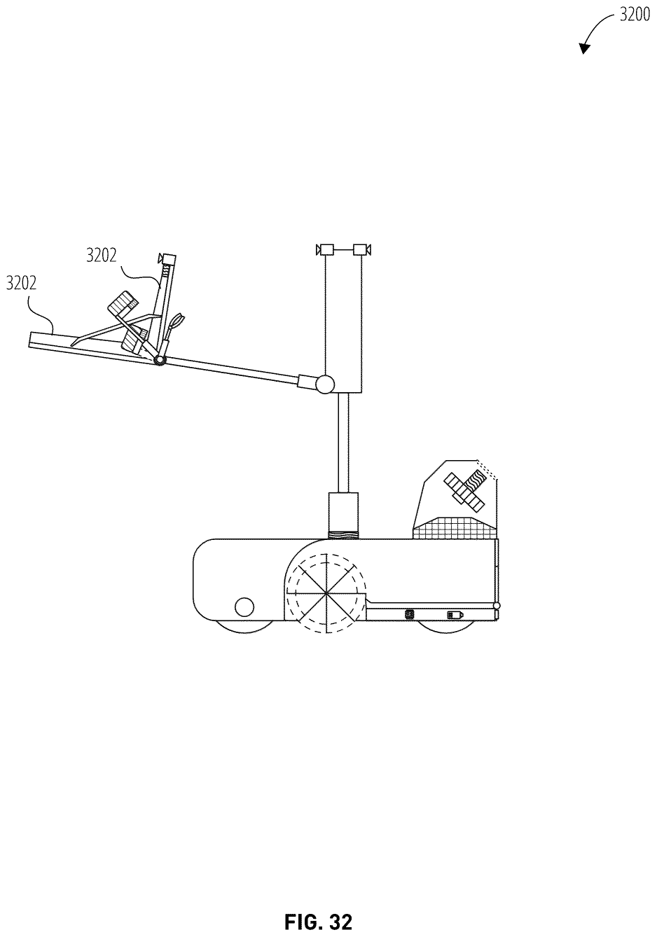

FIG. 32 illustrates scoop walls 3200 in accordance with some embodiments. The pusher pads may be designed so that they can go over the sides of the scoop and manipulate objects within the scoop. In some embodiments, drawings in this disclosure may show what appears to be interference between the scoop sides and where the pusher pads connect with the pusher pad arms. In exemplary embodiments, these may be addressed by one or move of:
Slightly lowering the scoop wall in the sketches so that there isn't any interference.
Raising the connection point between the pusher pads and the pusher pad arms so they can reach over a higher scoop wall.
Performing the same actions to manipulate the plates, but simply keeping the pusher pad connection point above the scoop wall to avoid interference.
Folding in the scoop walls before picking up the plates to avoid any interference.

FIG. 32 illustrates an embodiment with lower scoop walls 3202 so that the pusher pad connection points are able to go over the top in many pusher pad configurations without interfering.

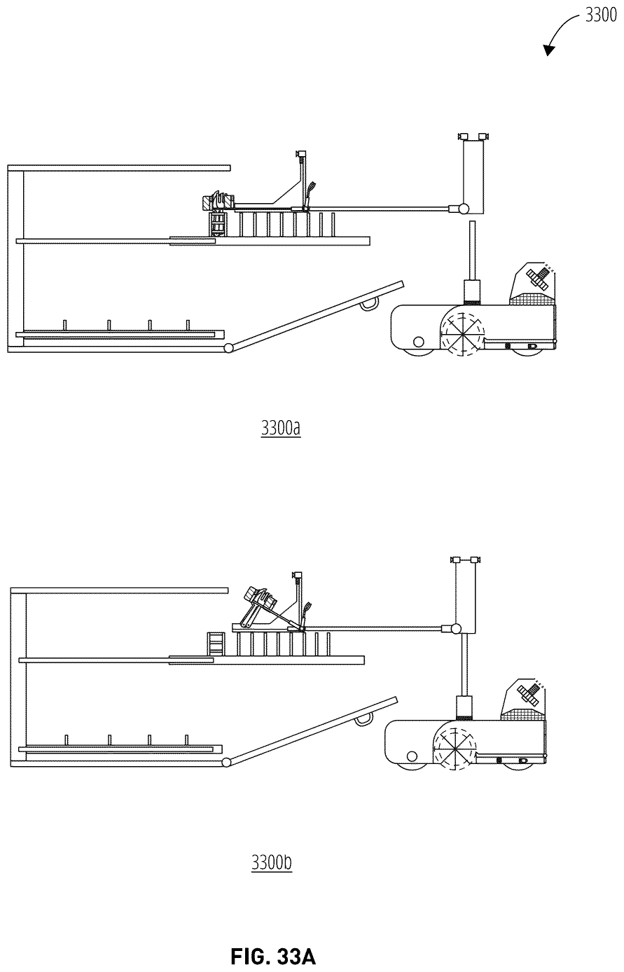

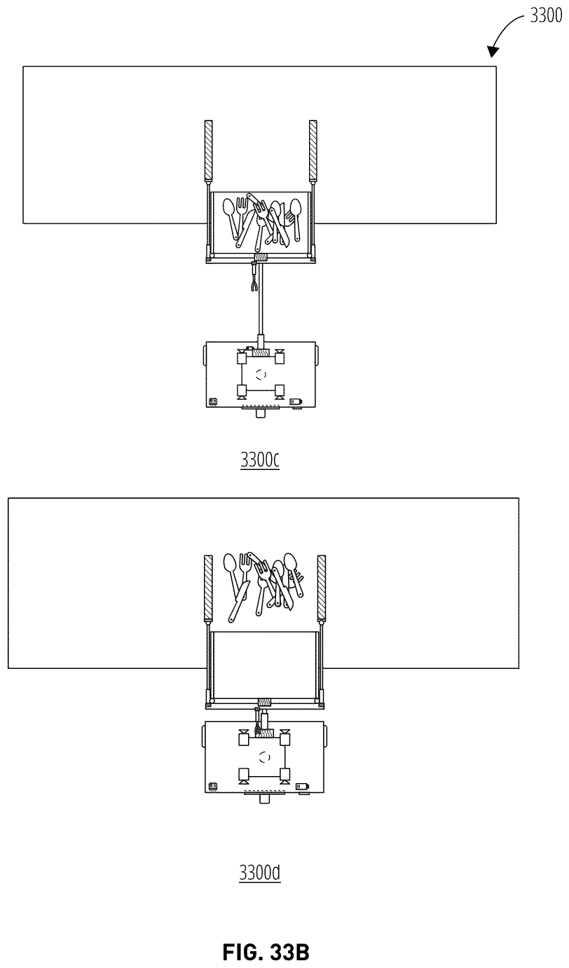

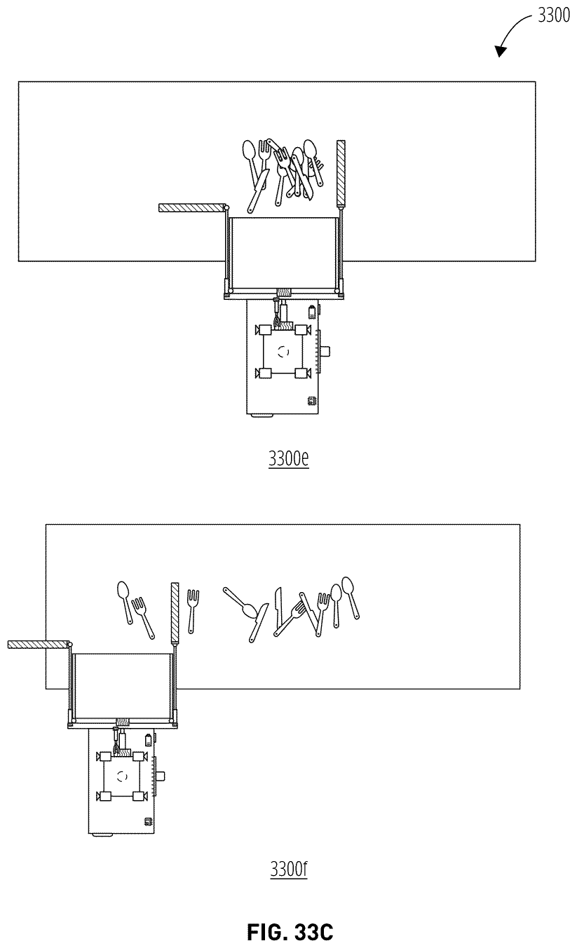

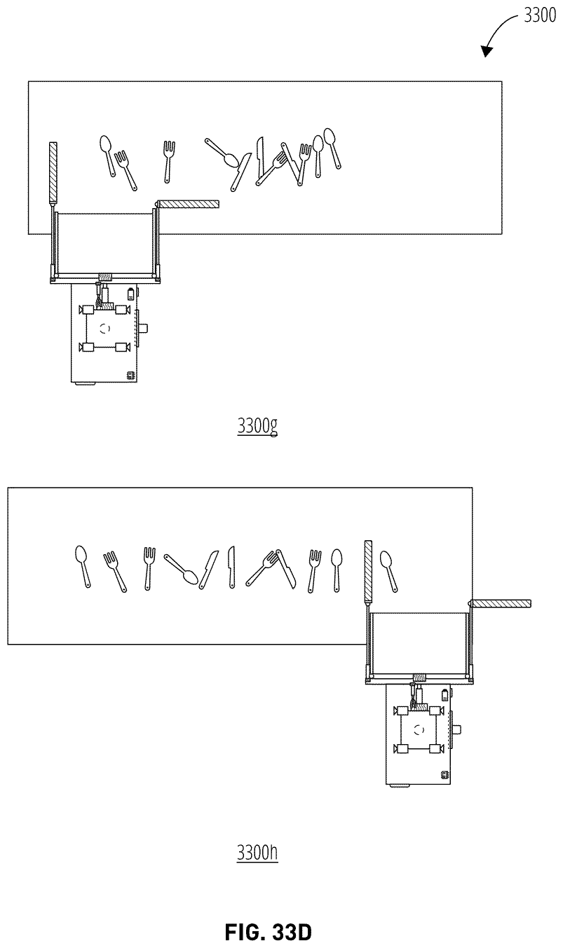

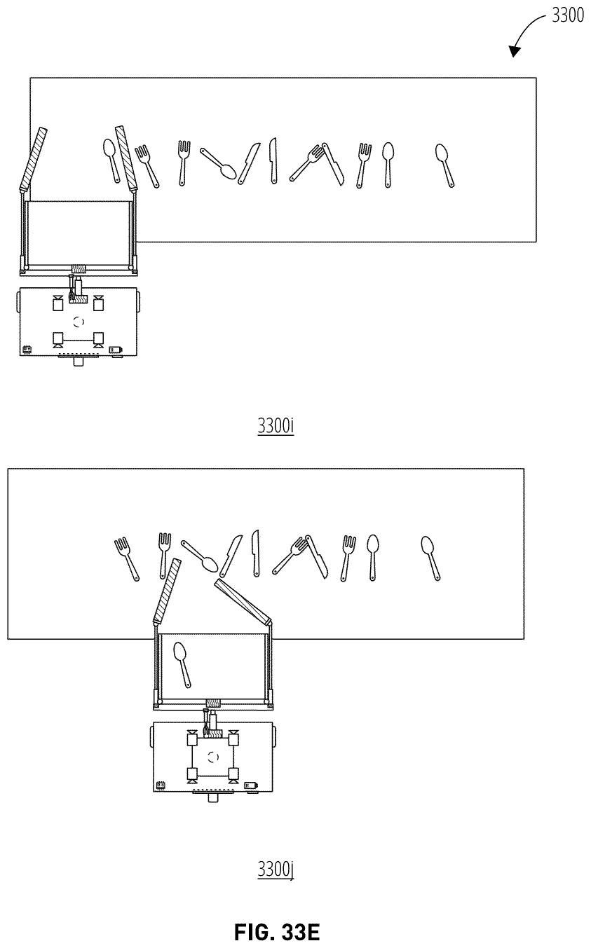

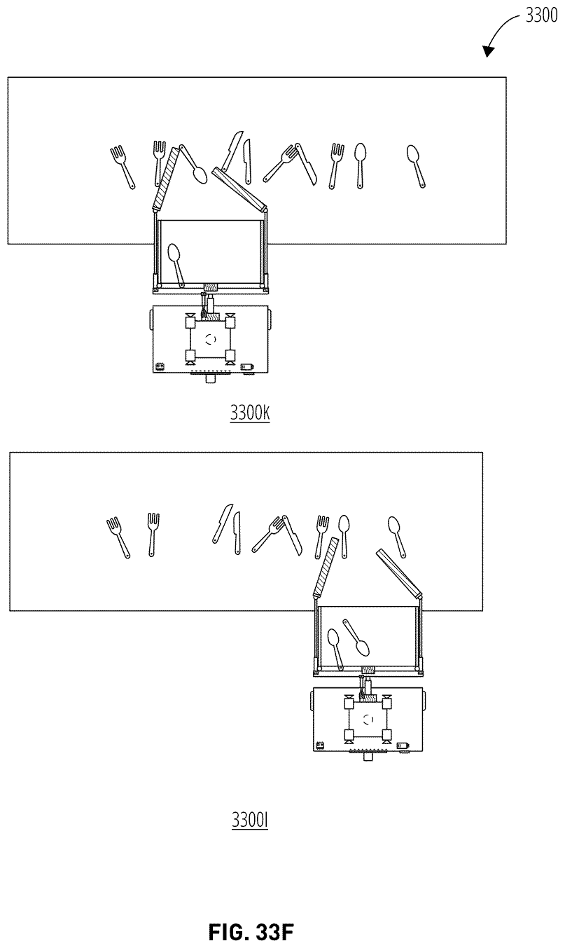

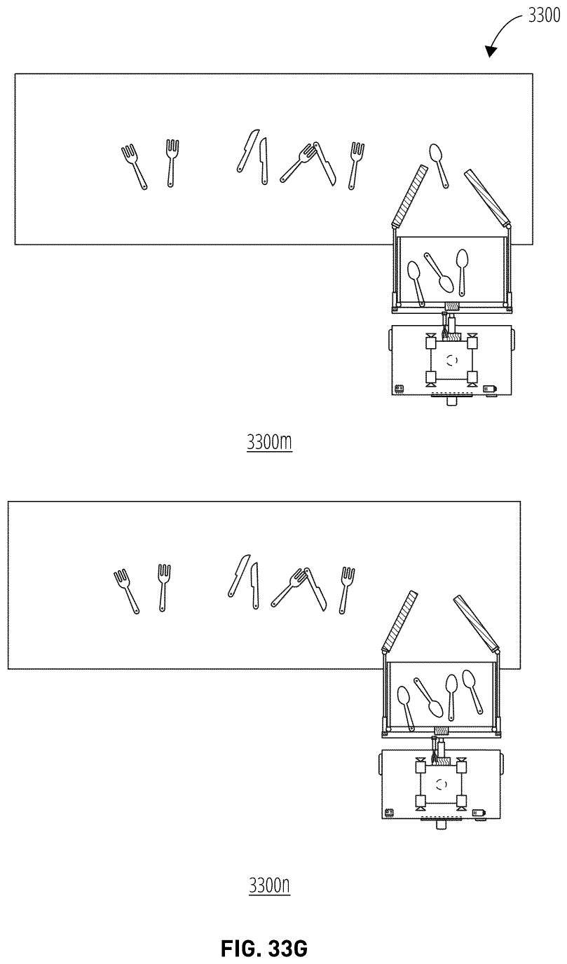

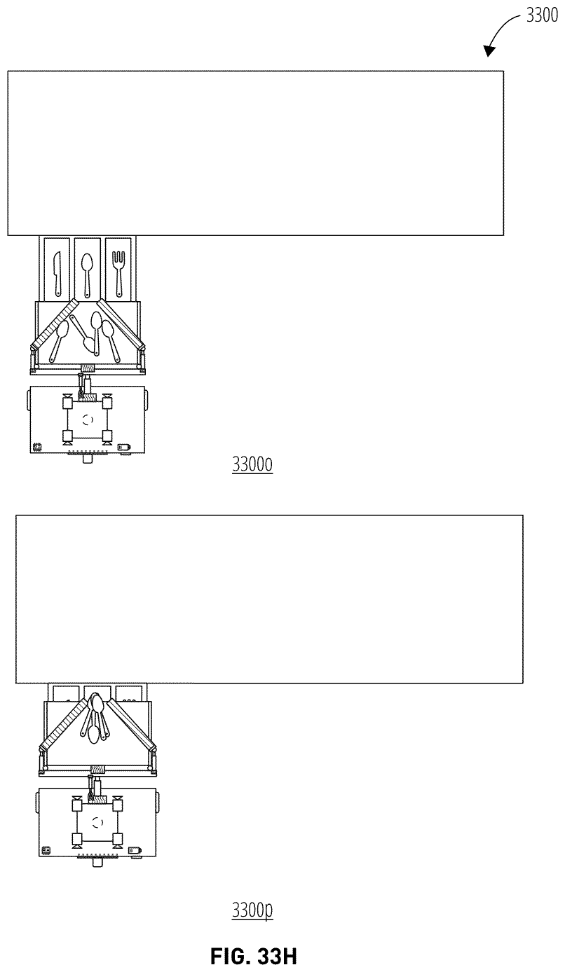

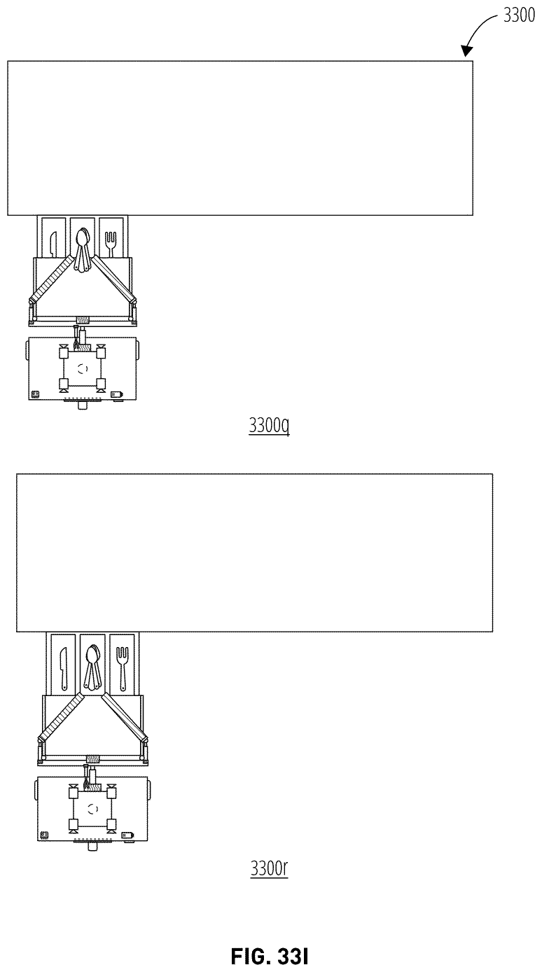

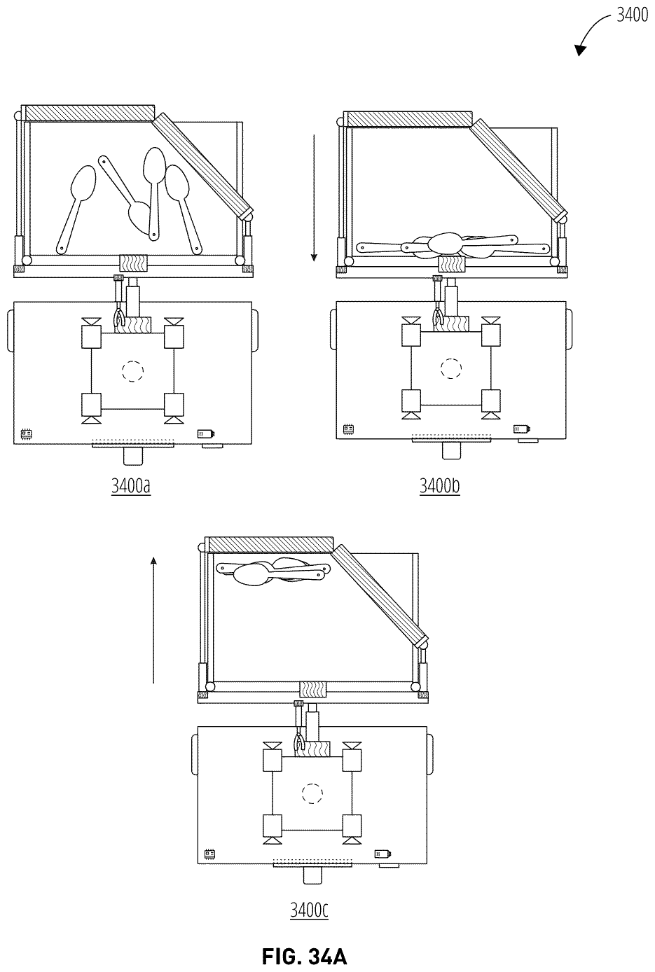

FIG. 33A illustrates a cutlery removal and sorting procedure 3300 in accordance with some embodiments. When unloading a dishwasher, the general purpose tidying robot may use a clean surface, such as a countertop, to sort the cutlery by category. In step 3300a, pusher pads are closed around cutlery, located in basket, to pick it up, followed by moving the cutlery into the scoop of the tidying robot in step 3300b. If the cutlery items are released into the scoop by the pusher pads, unsorted cutlery will result in the scoop as shown in step 3300c. In an embodiment, the cutlery is dumped onto a clean sorting surface in step 3300d by lifting the rear of the scoop and allowing the cutlery to slide out of the scoop. According to some embodiments, in step 3300e, the tidying robot is turned so that is is able to drive parallel to the sorting surface and the scoop of the robot is turned, with a rotational actuator at a base of the lifting column, such that the front edge of the scoop is parallel with the front edge of the surface. In step 3300f, the pusher pad is lifted slightly above the sorting surface, leaving a gap so that there is just enough space for the cutlery to fit through the gap. The tidying robot may drive along the edge of the sorting surface, spreading out cutlery. In step 3300g and step 3300h, the process of spreading out cutlery is repeated until the cutlery is sufficiently spaced for individual selection. In steps 3300i-3300n, the pusher pads may be used in a V-shape to pick up individual cutlery by category. In some embodiments, a typical pickup pattern may be used where an opening is made between the pusher pads and they are extended out to pick up individual pieces of cutlery and place them into the scoop. Optionally, the pusher pads may be used to rotate the cutlery so that they have the same orientation. After collecting a desired category of cutlery into the scoop, the collected cutlery may be placed into a cutlery tray slot in step 33000, by using the pusher arms in a V-shape configuration inside the scoop to direct cutlery into a cutlery tray slot by category. The gap in the V-shaped pusher pads is aligned with a desired cutlery tray slot. In step 3300p, the scoop is tilted forward so that tips of cutlery fall into the desired cutlery slot. Next, in step 3300q, the scoop is moved backwards while slightly increasing the tilt angle of the scoop, directing the cutlery between the pusher pads into the cutlery slot. This may be accomplished by retracting a scoop arm linear actuator or reversing the tidying robot. In some embodiments, because the tips of the cutlery are already in the cutlery slot, this provides some friction that helps the cutlery move out of the scoop. In step 3300r, the front edge of the scoop is moved to the back of the cutlery slot while tilting the scoop forward, resulting in all of the cutlery resting fully in the cutlery slot.

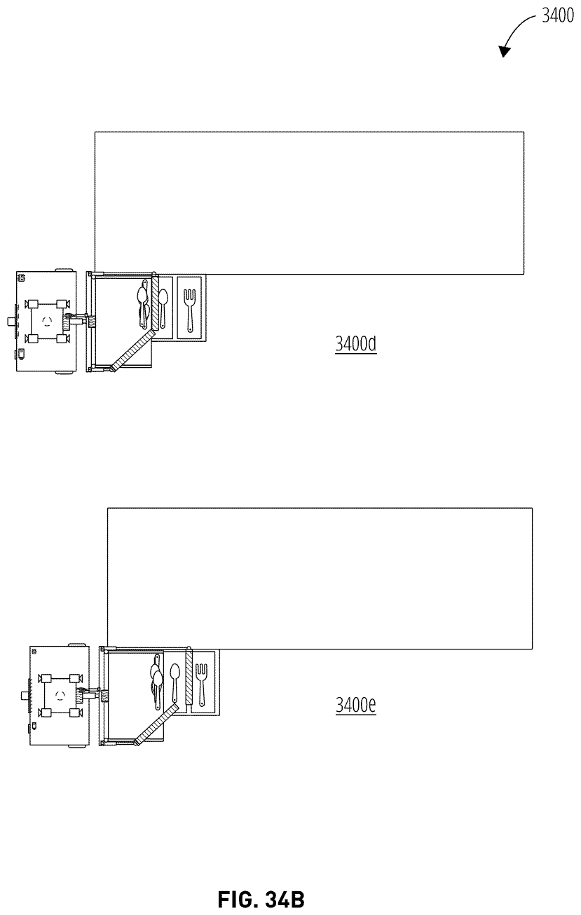

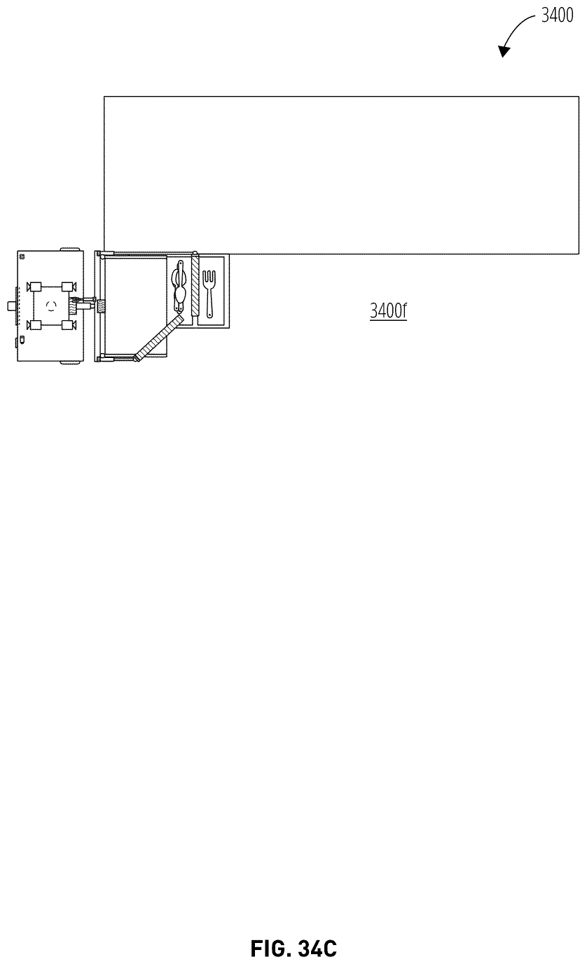

FIG. 34A illustrates a cutlery sorting procedure 3400 in accordance with some embodiments. In an alternative method of placing cutlery into a cutlery slot by category, step 3400a configures pusher pads in the scoop so that a first pusher pad is flat against the front edge and the second pusher pad is in a position to facilitate directing the cutlery towards one side at around a 45 degree angle. In step 3400b, the scoop is tilted back, moving the cutlery to the back of the scoop. In step 3400c, the scoop is tilted forward, allowing the cutlery to gather behind the first pusher pad, while the second pusher pad pusher pad directs the cutlery toward the first pusher pad. In step 3400d, the front edge of the scoop is positioned next to a long side of the cutlery tray slot while keeping the scoop tilted forward so that cutlery is flat against the first pusher pad. In step 3400e, the right pusher pad is rotated up slightly while extending the right pusher pad arm so that the pusher pad moves to the other side of the cutlery try slot. In some embodiments, the second pusher pad is rotated slightly out of the scoop. According to an embodiment, in step 3400f, the cutlery falls into the cutlery tray slot because the scoop is tilted forward.

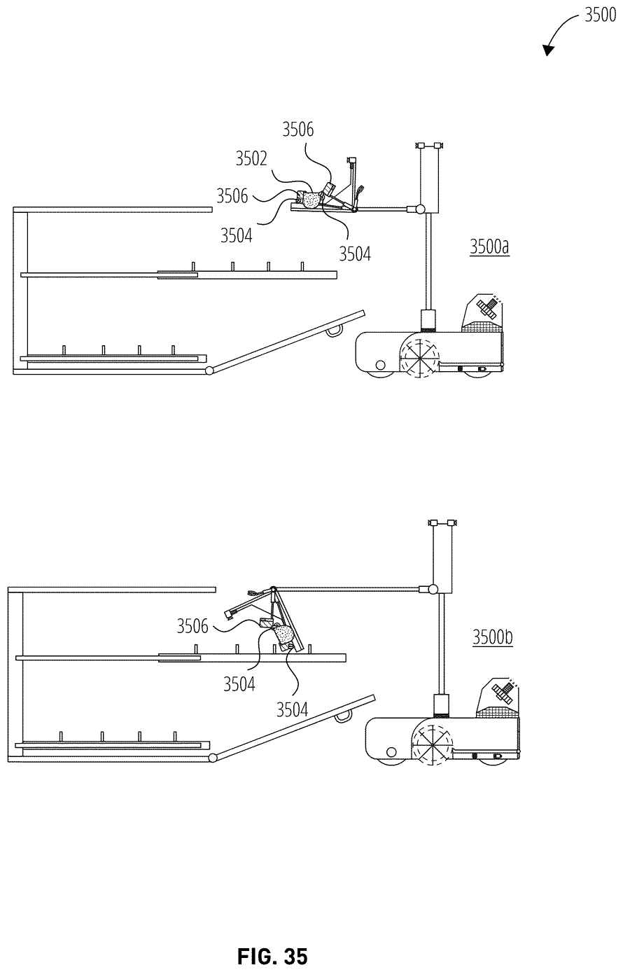

FIG. 35 illustrates an item loading procedure 3500 in accordance with some embodiments. Actuators at end of pusher arms may be switched out for different actuators. In some embodiments, a multi-purpose soft gripper (either 2 finger or 3 finger) is typically included at the end of the arms with the general purpose tidying robot that can be used for grasping fabric, or picking up small objects to help move them on/off the scoop in a controlled way.

Including grippers (or other end-effectors) at the end of the pusher arms may be very useful in accomplishing many tasks with the general purpose tidying robot. However, different types of grippers (or end effectors) may work better for accomplishing different tasks.

As such, it may be useful to have Swiss army knife type of functionality in gripper (or end effector) attachments that can be connected to the of the pusher arms either with some sort of release and attachment mechanism, or with a mechanism where different types of grippers (or end effectors) fold-out from a storage compartment for use when needed.

Some examples include the following:
Fabric gripper: uses clamping, friction, and/or air/suction to manipulate textiles or soft materials.
Suction cup or vacuum gripper: uses suction cups (potentially in a grid) for flat or smooth items.
Magnetic gripper: picks up metal objects using magnetism.
Soft gripper: flexible, for delicate or irregular objects.
Three-finger gripper: wraps around cylindrical or irregular shapes.
Parallel VS angular gripper: jaws move in parallel VS jaws pivot to open/close.

In situations especially where there's a release and attachment mechanism then specialized tooling may also be incorporated in some situations such as:
Vacuum hose end effector
Cleaning spray end effector
Squeegee tool end effector
Sponge or surface wiping end effector
Brush attachment
Duster attachment
Mop attachment
Spray nozzle end effector
Screwdriver or drill end effector
Special camera or sensor module attachment
Carabiner attachment
Welding torch end effector
3D printing extruder end effector

Such optional tooling may extend the general purpose tidying robot to be used in other settings and to perform other tasks such as in warehouses, manufacturing production lines, businesses and/or industrial.

In an embodiment, FIG. 35 illustrates an example where a multi-purpose soft gripper 3504 at the end of the pusher pad 3506 may assist with placing a cups 3502 into a dishwasher. In an embodiment, step 3500a illustrates a cup 3502 being held by soft grippers 3504 on a handle of the cup and the top lip of the cup, while in the scoop of a tidying robot. In some embodiments, one of the handle or the top lip may be held by the soft grippers 3504. In step 3500b, the scoop holding the cup 3502 is inverted while the cup is being held against the bottom of the scoop by the soft grippers 3504 and/or the pusher pads.

When manipulating objects with the general purpose tidying robot such as having it fold clothing, pick up dishes or cutlery items, or open appliance doors, the robot may often use a deep learning model to generate key points for specifically manipulating certain objects, often alongside panoptic segmentation, which labels both whole objects and their individual parts. In some embodiments, these tasks are commonly handled by a single model with a shared backbone and multiple output heads, such as one for segmentation and another for key point detection, enabling efficient joint inference.

In particular, these manipulation key points may often differ from visual key points in that for example the correct fold points on clothing may often simply be along an edge a certain distance from a corner where the corner is visually distinctive, but the fold point is not visually unique.

The following is a discussion of aspects of the key point identification system:

### Core Perception Modules

Segmentation: identify objects and their parts (e.g., shirt vs. sleeve).
Landmarks: detect distinctive points (e.g., corners, handles, rims).
Affordance heatmaps: highlight where actions are possible (grip, hold, push, align).
Keypoint solver: select specific contact points, respecting constraints (offset from corner, symmetry, opposing sides).

Task Configuration (Recipes) Each task is defined as a recipe made of steps. A step specifies:
Action type (grip, hold, lift, align).
Target object/part (shirt hem, pant leg, pot lid).
Constraints (e.g., “on edge,” “10 cm from corner,” “symmetric pair”).
End-effector type (gripper, scoop, pad).
Next step (what follows once this action is done).

This separates what to do (recipe) from how to see and act (perception+solver).

### Control & Planning

Step planner: reads the current step from the recipe.
Motion planner: turns chosen key points into robot motions.
State updater: records progress (which folds done, whether lid removed, etc.).

Learning Loops (Continuous Improvement) The robot improves over time using three complementary approaches:
1. Imitation Learning (IL)
   Learn initial behaviors from human demonstrations.
   Fast way to bootstrap skills.
2. Self-Supervised Learning
   Robot interacts with objects and learns from the outcomes (e.g., pulling on cloth to see how it moves).
   Improves perception and generalization without human labels.
3. Reinforcement & Human Corrections
   Rewards from task success (e.g., neat fold, stable pot lift).
   Human corrections can guide the robot without giving full new demos.
   Refines skills beyond what was demonstrated.

### Runtime Workflow

4. Perception: segmentation, landmarks, affordances.
5. Step selection: read the next step from the recipe.
6. Keypoint solver: pick exact manipulation points under step constraints.
7. Motion execution: plan and perform the action.
8. Feedback: log success/failure; use for imitation, self-supervised, or RL updates.
9. Advance to next step until task is complete.

### SUMMARY

Configurable: new tasks may use a new recipe file.
Reusable perception: segmentation, landmarks, affordances work across tasks.
Improves over time: imitation to start, self-supervision for generalization, reinforcement/corrections for refinement.
Step-wise execution: robot focuses on the next action, reducing complexity.

### Example Configuration

task: fold pants steps: —step: fold_leg_over action: grip target: pant_leg constraints: {fold_over: other_leg} end_effector: gripper next: fold_ankles_up-step: fold_ankles_up action: grip target: pant_ankles constraints: {fold_towards: waist} end_effector: gripper next: optional_stack-step: optional_stack action: grip target: folded_pants constraints: {fold_towards: half_height} end_effector: gripper next: done
task: fold_shirt steps: —step: fold_left_side action: grip target: shirt_hem constraints: {offset_from_corner: 10 cm, edge_aligned: true} end_effector: gripper next: fold_right_side-step: fold_right_side action: grip target: shirt_hem constraints: {symmetric_to: fold_left_side} end_effector: gripper next: fold bottom-step: fold_bottom action: grip target: shirt_hem constraints: {fold_towards: collar} end_effector: gripper next: done
task: fold_pants steps: —step: fold_leg_over action: grip target: pant_leg constraints: {fold_over: other_leg}

### Moving a Pot to the Scoop:

task: move_pot_to_scoop steps: —step: place_lift_pads action: hold target: pot_rim constraints: {two_points_opposite: true} end_effector: pads next: slide_pot —step: slide_pot action: translate target: scoop_surface constraints: {path: countertop_to_scoop, scoop_aligned: true} end_effector: pads next: release_pot-step: release_pot action: release target: pot constraints: {stable_on: scoop_surface} end_effector: pads next: done

### Segmentation

What: Split the image into objects and their parts, for example shirt body and sleeves, or pot and lid.
Why: Actions target specific parts, so the robot needs clear masks and edges.

### Landmarks

What: Distinctive points on the object such as corners, handles, or rim points.
Why: They provide anchors for actions like “grip 10 cm from this corner” even if the exact grip point is not visually unique.

### Affordance Heatmaps

What: A map showing which regions are suitable for an action like grip, hold, push, or align.
Why: They highlight feasible zones for the current step, helping the robot focus on where the action will succeed.

### Keypoint Solver

What: A module that converts landmarks and affordance maps into precise contact points and orientations.
Why: It enforces constraints such as “on an edge,” “a fixed offset from a landmark,” “symmetric pairs,” or “two opposing contact points,” ensuring the chosen key points are physically valid and task-appropriate.
   How they Work Together
Segmentation isolates the correct part of the object.
Landmarks identify reference anchors.
Affordance maps highlight suitable regions.
The Keypoint solver selects the exact contact points that satisfy the step's constraints.

The backbone (for example a CNN) processes the image once to extract general visual features. Multiple heads branch from it:
Segmentation head: Predicts object and part masks.
Landmark head: Predicts anchor points such as corners or handles.
Affordance head: predicts heatmaps showing where specific actions are possible.
Keypoint solver is either:
   A separate solver module that applies explicit rules and constraints (for example “choose a point on the hem edge offset from a corner” or “pick two symmetric points”)
   A neural head that directly predicts key points from shared features, possibly combined with a lightweight solver to enforce constraints.

This setup is efficient because the robot runs one forward pass through the backbone, and all perception tasks share the same features. It also helps the model learn better, since tasks like segmentation, landmarks, and affordances reinforce each other.

FIGS. 36A-36C illustrate keypoint identification 3600 in accordance with one embodiment. Keypoints may be used to identify both action related points (e.g., grip point, drop point, or pusher pad point), and semantic points of interest (e.g., cup handle, plate edge, door handle center, or utensil handle start/end).

In some embodiments as shown in FIG. 36A, the use of keypoint identification 3600 is used for holding a cup so that it can be inverted into a dishwasher. Keypoints may include grip points 3602, pusher pad points 3604, and drop points 3606. Key points are shown on a cup 3608 identifying the grip point 3602 where a soft gripper 3504 may be used and a pusher pad point 3604 where a pusher pad may be used to secure the cup 3608. In another example, pusher pads may be used to place or remove a plate vertically into or from the dishwasher, as seen in FIG. 28B. Pusher pad points 3604 are shown on the vertical plate 3610. In yet another scenario, keypoints may assist in grasping a plate to move and stack it on a shelf or in a cupboard as seen in FIG. 28G. Grip points 3602 are shown on the horizontal plate 3612.

FIG. 36B illustrates a dishwasher 3614 for which a grip point 3602 may be identified at the dishwasher handle 3616 on the dishwasher door 3618 when the dishwasher 3614 is closed, and additional grip points 3602 may be identified for the dishwasher trays 3620 and the outer edge of the dishwasher door 3618 when the dishwasher 3614 is open. The dishwasher trays 3620 may include dishwasher tray elements 3622, which may be associated with drop points 3606 when made accessible to the robot for loading tasks.

FIG. 36C illustrates keypoint identification 3600 performed for tableware such as a bowl 3624, knife 3626, spoon 3628, and fork 3630. Opposite points on the rim of the bowl 3624 may be identified as grip points 3602 while the underside of the bowl 3624 may be identified as a pusher pad point 3604 where the robot may support the bowl 3624 from beneath using a pusher pad. Points along the handles of the knife 3626, spoon 3628, and fork 3630 may be identified as grip points 3602, as illustrated.

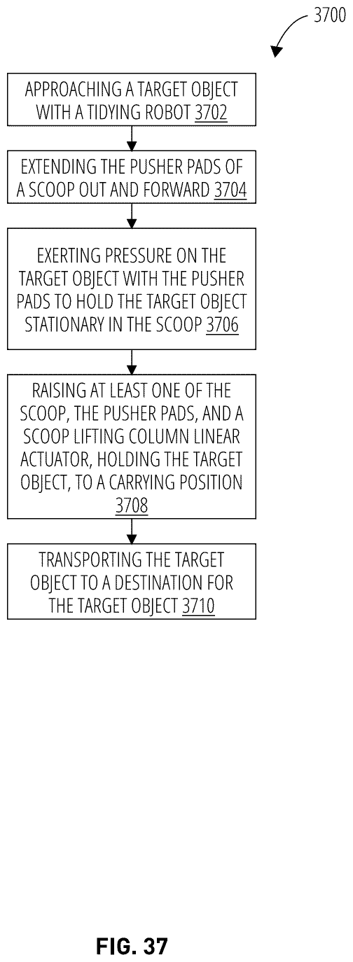

FIG. 37 illustrates an example method 3700 for picking up a target object and transporting it. Although the example method 3700, and all of the following examples in the figures below, depicts a particular sequence of operations, the sequence may be altered without departing from the scope of the present disclosure. For example, some of the operations depicted may be performed in parallel or in a different sequence that does not materially affect the function of the method 3700. In other examples, different components of an example device or system that implements the method 3700 may perform functions at substantially the same time or in a specific sequence.

According to some examples, the method includes approaching a target object with a tidying robot at block 3702.

According to some examples, the method includes extending the pusher pads of a scoop out and forward at block 3704.

According to some examples, the method includes exerting pressure on the target object with the pusher pads to hold the target object stationary in the scoop at block 3706.

According to some examples, the method includes raising at least one of the scoop, the pusher pads, and a scoop lifting column linear actuator, holding the target object, to a carrying position at block 3708.

According to some examples, the method includes transporting the target object to a destination for the target object at block 3710.

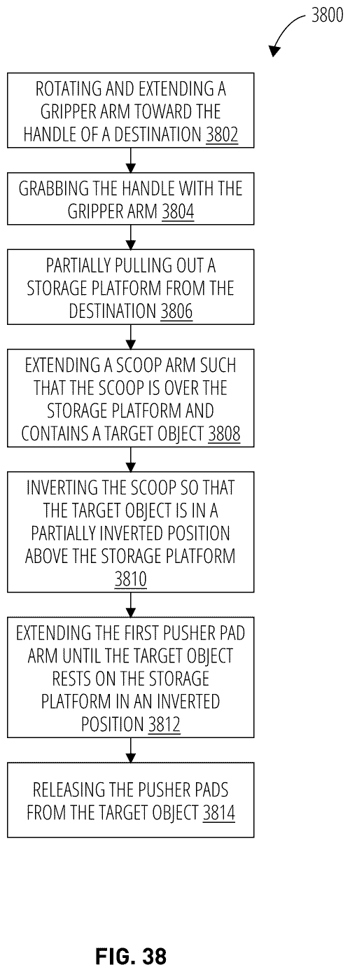

FIG. 38 illustrates an example method 3800 for loading the target object into a destination.

According to some examples, the method includes rotating and extending a gripper arm toward the handle of a destination at block 3802.

According to some examples, the method includes grabbing the handle with the gripper arm at block 3804.

According to some examples, the method includes partially pulling out a storage platform from the destination at block 3806.

According to some examples, the method includes extending a scoop arm such that the scoop is over the storage platform and contains a target object at block 3808.

According to some examples, the method includes inverting the scoop so that the target object is in a partially inverted position above the storage platform at block 3810.

According to some examples, the method includes extending the first pusher pad arm until the target object rests on the storage platform in an inverted position at block 3812.

According to some examples, the method includes releasing the pusher pads from the target object at block 3814.

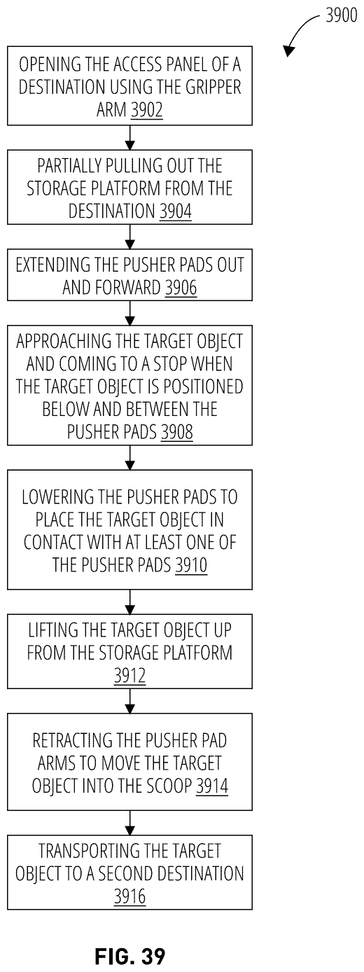

FIG. 39 illustrates an example method 3900 for removing a target object from a destination and transporting it.

According to some examples, the method includes opening the access panel of a destination using the gripper arm at block 3902.

According to some examples, the method includes partially pulling out the storage platform from the destination at block 3904.

According to some examples, the method includes extending the pusher pads out and forward at block 3906.

According to some examples, the method includes approaching the target object and coming to a stop when the target object is positioned below and between the pusher pads at block 3908.

According to some examples, the method includes lowering the pusher pads to place the target object in contact with at least one of the pusher pads at block 3910.

According to some examples, the method includes lifting the target object up from the storage platform at block 3912.

According to some examples, the method includes retracting the pusher pad arms to move the target object into the scoop at block 3914.

According to some examples, the method includes transporting the target object to a second destination at block 3916.

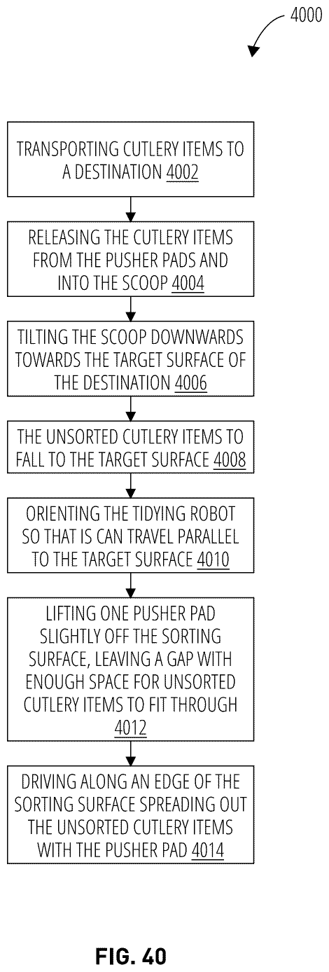

FIG. 40 illustrates an example method 4000 for transporting cutlery and sorting it.

According to some examples, the method includes transporting cutlery items to a destination at block 4002.

According to some examples, the method includes releasing the cutlery items from the pusher pads and into the scoop at block 4004.

According to some examples, the method includes tilting the scoop downwards towards the target surface of the destination at block 4006.

According to some examples, the method includes the unsorted cutlery items to fall to the target surface at block 4008.

According to some examples, the method includes orienting the tidying robot so that is can travel parallel to the target surface at block 4010.

According to some examples, the method includes lifting one pusher pad slightly off the sorting surface, leaving a gap with enough space for unsorted cutlery items to fit through at block 4012.

According to some examples, the method includes driving along an edge of the sorting surface spreading out the unsorted cutlery items with the pusher pad at block 4014.

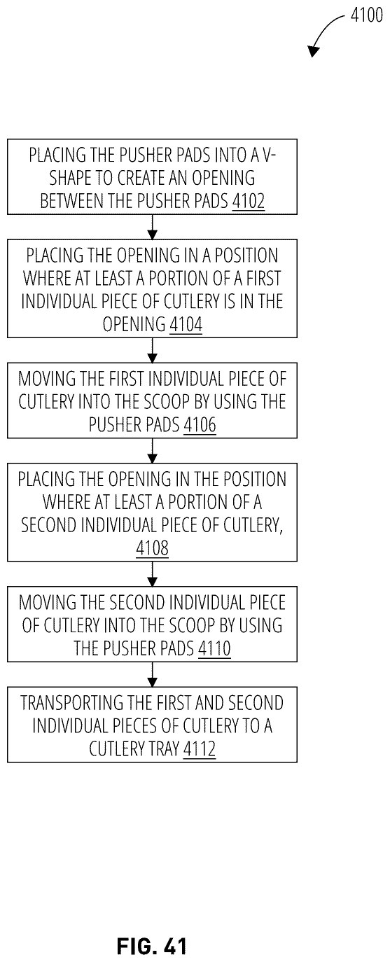

FIG. 41 illustrates an example method 4100 for sorting cutlery items.

According to some examples, the method includes placing the pusher pads into a V-shape to create an opening between the pusher pads at block 4102.

According to some examples, the method includes placing the opening in a position where at least a portion of a first individual piece of cutlery is in the opening at block 4104.

According to some examples, the method includes moving the first individual piece of cutlery into the scoop by using the pusher pads at block 4106.

According to some examples, the method includes placing the opening in the position where at least a portion of a second individual piece of cutlery, at block 4108.

According to some examples, the method includes moving the second individual piece of cutlery into the scoop by using the pusher pads at block 4110.

According to some examples, the method includes transporting the first and second individual pieces of cutlery to a cutlery tray at block 4112.

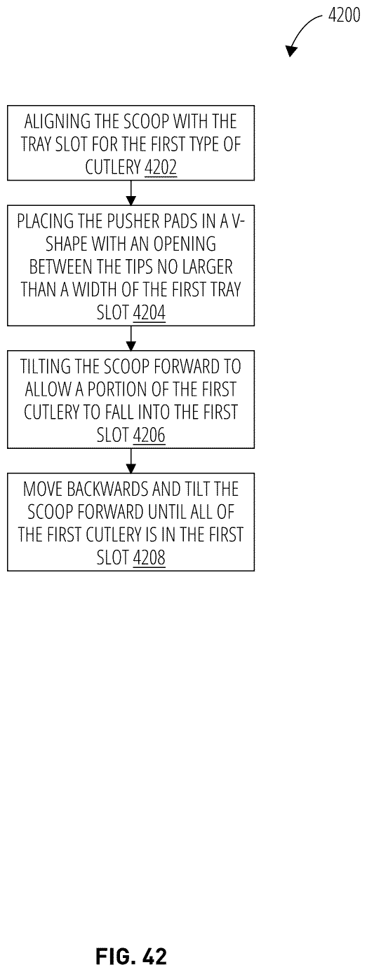

FIG. 42 illustrates an example method 4200 for placing sorted cutlery into a cutlery tray.

According to some examples, the method includes aligning the scoop with the tray slot for the first type of cutlery at block 4202.

According to some examples, the method includes placing the pusher pads in a V-shape with an opening between the tips no larger than a width of the first tray slot at block 4204.

According to some examples, the method includes tilting the scoop forward to allow a portion of the first cutlery to fall into the first slot at block 4206.

According to some examples, the method includes moving backwards and tilt the scoop forward until all of the first cutlery is in the first slot at block 4208.

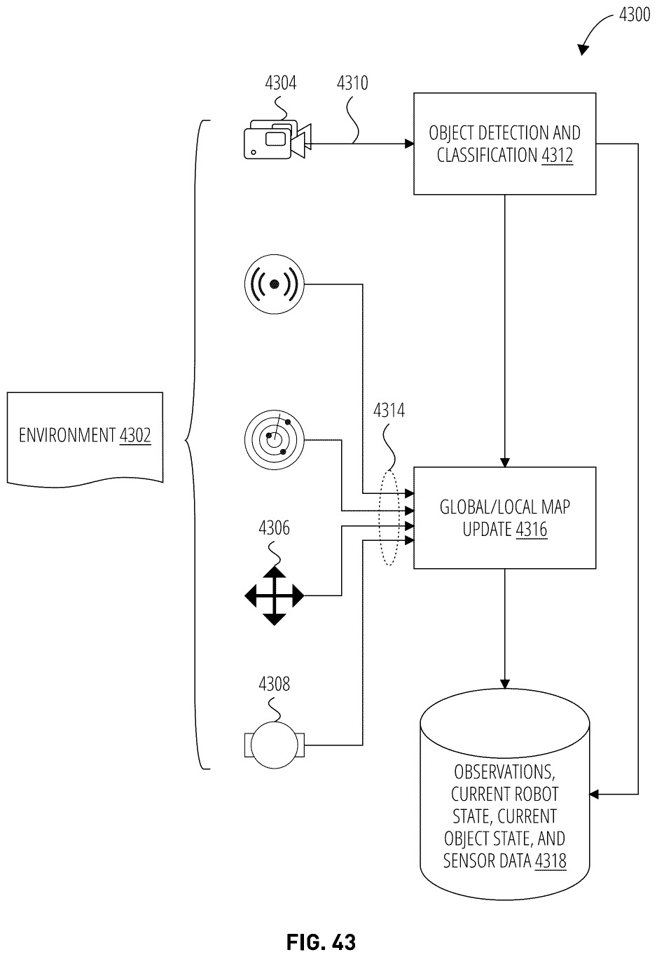

FIG. 43 illustrates sensor input analysis 4300 in accordance with one embodiment. Sensor input analysis 4300 may inform the tidying robot 1600 of the dimensions of its immediate environment 4302 and the location of itself and other objects within that environment 4302.

The tidying robot 1600 as previously described includes a sensing system 1606. This sensing system 1606 may include at least one of cameras 4304 (such as front left camera 1688a, rear left camera 1688b, front right camera 1688c, rear right camera 1688d, and scoop camera 1688e), IMU sensors 1704, lidar sensor 1702, odometry 4306, and actuator force feedback sensor 4308. These sensors may capture data describing the environment 4302 around the tidying robot 1600.

Image data 4310 from the cameras 4304 may be used for object detection and classification 4312. Object detection and classification 4312 may be performed by algorithms and models configured within the robotic control system 2500 of the tidying robot 1600. In this manner, the characteristics and types of objects in the environment 4302 may be determined.

Image data 4310, object detection and classification 4312 data, and other sensor data 4314 may be used for a global/local map update 4316. The global and/or local map may be stored by the tidying robot 1600 and may represent its knowledge of the dimensions and objects within its decluttering environment 4302. This map may be used in navigation and strategy determination associated with decluttering tasks.

The robot may use a combination of cameras 4304, lidar sensor 1702 and the other sensors to maintain a global or local area map of the environment and to localize itself within that. Additionally, the robot may perform object detection and object classification and may generate visual re-identification fingerprints for each object. The robot may utilize stereo cameras along with a machine learning/neural network software architecture (e.g., semi-supervised or supervised convolutional neural network) to efficiently classify the type, size and location of different objects on a map of the environment.

The robot may determine the relative distance and angle to each object. The distance and angle may then be used to localize objects on the global or local area map. The robot may utilize both forward and backward facing cameras to scan both to the front and to the rear of the robot.

image data 4310, object detection and classification 4312 data, other sensor data 4314, and global/local map update 4316 data may be stored as observations, current robot state, current object state, and sensor data 4318. The observations, current robot state, current object state, and sensor data 4318 may be used by the robotic control system 2500 of the tidying robot 1600 in determining navigation paths and task strategies.

FIG. 44 illustrates robotic control system interfaces 4400 in accordance with one embodiment. The robotic control system interfaces 4400 may comprise a sensing system 4402, including the robot's sensors, such as cameras 4404, lidar sensors 4406, IMU sensors 4408, wheel encoders 4410, and other sensors 4412. The robotic control system interfaces 4400 may further comprise robot user interfaces 4414 and robot actuators 4416. A tidying robot such as the tidying robot 1600 shown in FIGS. 16A-17B and 19A-24 having a robotic control system such as the robotic control system 2500 described with respect to FIG. 25 may include operational components that interface with the sensing system 4402, robot user interfaces 4414, robot actuators 4416, and each other. These components may include a perception module 4500, a navigation module 4600, a robot brain 4700, and an action module 4800, which are described in detail with respect to FIG. 45 through FIG. 48.

The perception module 4500 may receive image data 4418 from the cameras 4404. In one embodiment, the perception module 4500 may receive additional data from other elements of the sensing system 4402. For example, in one embodiment the perception module 4500 may also receive lidar data 4420 from the lidar sensors 4406. Based on the input image data 4418 received from the cameras 4404, the perception module 4500 may generate scene layout map data 4436 and local occupancy map data 4438 as described with respect to FIG. 45. The scene layout map data 4436 and local occupancy map data 4438 may be transmitted to the navigation module 4600. In some embodiments, the perception module 4500 may send the filtered 2D and 3D bounding boxes 4434 it may generate to the navigation module 4600 as well.

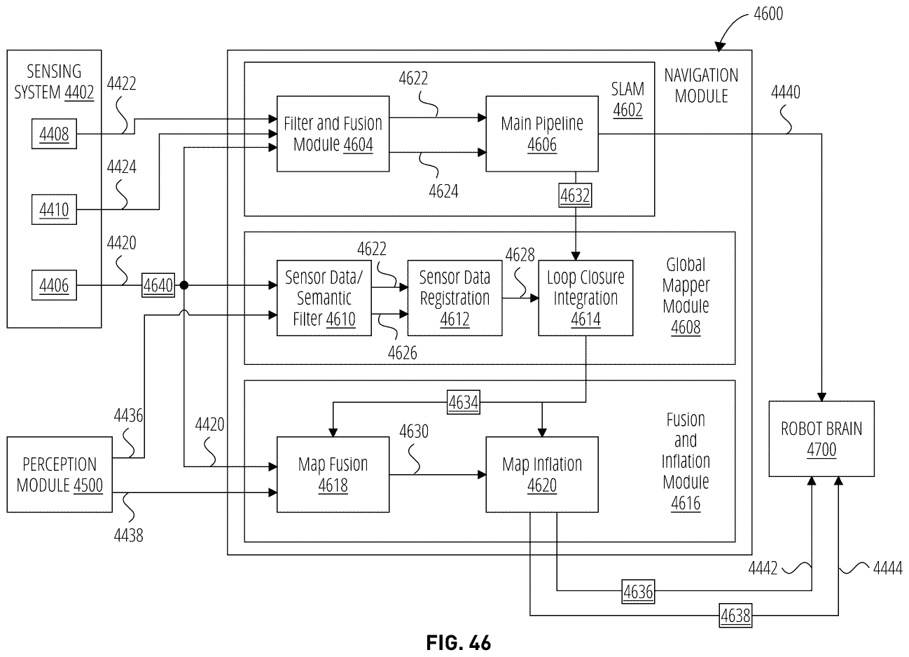

The navigation module 4600 may receive lidar data 4420 from the lidar sensors 4406, IMU data 4422 from the IMU sensors 4408, and wheel encoding data 4424 from the wheel encoders 4410 in addition to the scene layout map data 4436 and local occupancy map data 4438 from the perception module 4500. The lidar data 4420, IMU data 4422, and wheel encoding data 4424 may be used to determine a position or “pose” of the tidying robot 1600 within the environment it intends to navigate. In addition, this data may be used to transform the scene layout map data 4436 and local occupancy map data 4438 into an inflated local map data 4442 and inflated global map data 4444, as is described in greater detail with respect to FIG. 46. The robot pose 4440, inflated local map data 4442, and inflated global map data 4444 may be transmitted to the robot brain 4700.

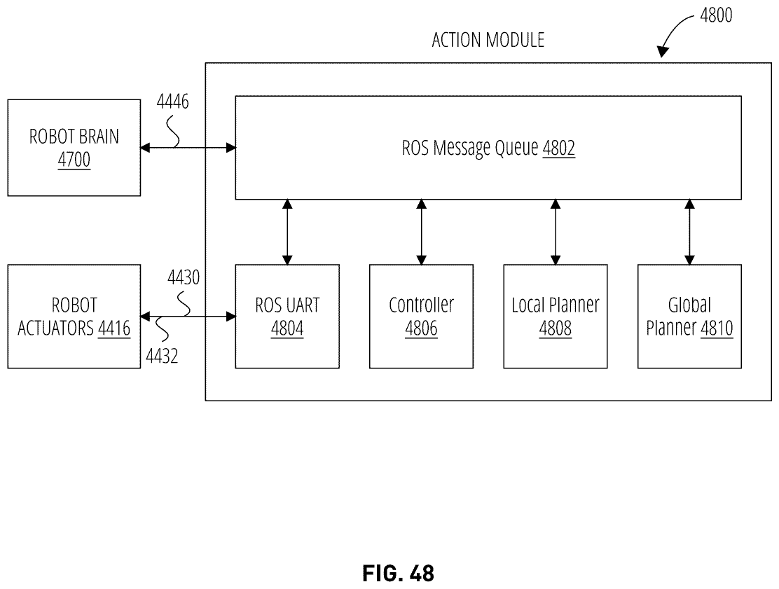

The robot brain 4700 may receive other sensor data 4426 from the other sensors 4412 of the sensing system 4402 in addition to the robot pose 4440, inflated local map data 4442, and inflated global map data 4444 from the navigation module 4600. The other sensor data 4426 may be used along with the data from the navigation module 4600 to generate robot operating system (ROS) messages, such as ROS messaging signals 4446, for transmission to the action module 4800. This is described in greater detail with respect to FIG. 47 and FIG. 48.

The action module 4800 may receive the ROS messaging signals 4446 from the robot brain 4700. The action module 4800 may generate robot action command signals 4430 based on the ROS messaging signals 4446 from the robot brain 4700, as is described in greater detail with respect to FIG. 48. The robot actuators 4416 may be actuated by these robot action command signals 4430 in a manner that commands the robot to perform actions as directed by the robot brain 4700. During such actuation, the forces applied by the robot actuators 4416 as they operate may be measured and transmitted back to the action module 4800 as actuator force feedback signals 4432. Such actuator force feedback signals 4432 may indicate the completion of actions, the encountering of obstructions, fault conditions, etc. The action module 4800 may use ROS messaging signals 4446 to communicate the actuator force feedback signals 4432 back to the robot brain 4700.

FIG. 45 illustrates a perception module 4500 in accordance with one embodiment. The perception module 4500 may include a detection module 4502, a scene segmentation module 4510, and a mapping module 4516. In one embodiment, the detection module 4502 may include a 2D object detection model 4504, 3D location prediction 4506, and detection filtering 4508. The scene segmentation module 4510 may include a segmentation model 4512 and edge detection algorithms 4514. In one embodiment, the mapping module 4516 may include a labeling module 4518, a top view transformation module 4520, a scene layout module 4522, and a local occupancy module 4526. The perception module 4500 may take in image data 4418 from the sensing system 4402 and may produce scene layout map data 4436 and local occupancy map data 4438, which it may transmit to the navigation module 4600.

The perception module 4500 may take in raw RGB image data 4418 and may create higher-level features such as 2D bounding boxes and class labels for objects detected in the image data, as well as scene layout and local occupancy maps for use in planning and navigation. The perception module 4500 may use object detection and segmentation models to identify different elements in the scene represented by the image data. These elements may be converted into 3D coordinates and/or maps using post-processing algorithms.

Detected objects may be classified and labeled in a number of ways. Some classes that may be useful for the purposes of a clutter tidying robot may be “obstacles,” “dynamic objects,” “static objects,” “movable objects,” “tidyable objects,” “toys,” “pets,” “humans,” “children,” “clothing,” “furniture,” “miscellaneous household object,” etc. Detected objects may be identified using one or more class labels, as is most useful for robot planning and operation. “Obstacles” refers to objects that may impede the passage of a robot as it navigates its environment to complete desired tasks. “Dynamic objects” refers to objects that may be expected to move independently of the robot during the time the robot is exploring, and navigating its environment, such as people, pets, other robots, etc. The term “Static object” in this disclosure refers to elements of a scene that are not expected to change over time, typically because they are rigid and immovable. Some composite objects may be split into a movable part and a static part. Examples include door frames, bookshelves, walls, countertops, floors, couches, dining tables, etc. The term “Movable object” in this disclosure refers to elements of the scene that are not desired to be moved by the robot (e.g., because they are decorative, too large, or attached to something), but that may be moved or deformed in the scene due to human influence. Some composite objects may be split into a movable part and a static part. Examples include doors, windows, blankets, rugs, chairs, laundry baskets, storage bins, etc. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc.

Given image data 4418, such as a raw RGB camera frame representing a detected image of a scene 4534, the detection module 4502 may estimate the shape and positions of objects of interest in the frame with respect to the tidying robot 1600, such as are shown in FIG. 51, captured in the detected image of a scene 4534. The detection module 4502 may use a 2D object detection model 4504 to detect objects in the frame. This may include object classifications and the extents of 2D bounding boxes indicating the locations of the objects. Object detection models such as those in the You Only Look Once (YOLO) series or DEtection TRansformer (DETR) series may be used to perform object detection through neural network architectures or using classical methods. These models may produce 2D bounding boxes with pixel coordinates for box center and size, as well as class labels, such as toy, bin, bin-label, book, clothes, home-misc., human, pet, furniture, etc., as exemplified by classified 2D bounding boxes 4546.

The detection module 4502 may then use 3D location prediction 4506 and a detected ground plane to generate 3D bounding boxes for the objects in the classified 2D bounding boxes 4546. The detections may be lifted from 2D to 3D, assuming the objects are on the ground (in contact with the ground plane). This allows the detection module 4502 to project the detected objects as 3D bounding boxes with respect to the frame of reference of the tidying robot 1600. Assuming all detections to be on the ground, the bottom corners of the bounding boxes may be used as contact points with the floor. Where the height of the camera from the floor is known, as may be the case for the 160, the 3D location of each floor pixel in the image plane may be calculated. This may be used to convert the contact points for each 2D bounding box to 3D coordinates with respect to the camera. The height of each bounding box may be assumed to be the same as the width.

Where the assumption of every object being on the floor is violated, much larger distances may be calculated as a result. These issues may be corrected by post-processing detection filtering 4508, where the 3D outputs may be filtered to remove irrelevant objects such as humans, furniture, and other objects that violate assumptions of being on the ground or are projected inside the scoop 1610 of the tidying robot 1600. The detection filtering 4508 may take in the 2D and 3D bounding boxes and the class labels and may compute a distance from the 3D bounding boxes to a known center point of the tidying robot 1600. This distance may be used to determine whether or not the object is too far from the robot, or whether it lies within the extent of the tidying robot 1600 scoop 1610. Objects too far from the tidying robot 16000 and objects in the scoop 1610 may have their classification and bounding box data removed to form a set of filtered 2D-3D bounding boxes and class labels 4530.

The scene segmentation module 4510 may take in raw RGB image data 4418, such as the detected image of a scene 4534, and may use a segmentation model 4512 to identify the floor and any rugs, playmats, and other relevant boundaries as an edge map. The segmentation model 4512 may be a model such as BiSeNet, Seaformer, or a similar model. The segmentation model 4512 may produce a multi-class segmentation map 4548 for the floor or drivable area.

The multi-class segmentation map may be sent to edge detection algorithms 4514. The edge detection algorithm 4514 may be a 3×3 kernel convolution with thresholding deployed on a graphics processing unit (GPU) or central processing unit (CPU). Canny or a similar edge detector may be used. Techniques such as mask-shifting followed by mask subtraction, performed by the GPU or CPU may be used. In this manner, the edge detection algorithms 4514 may identify the relevant boundaries in the segmentation map with their semantic information. The scene segmentation module 4510 may in this manner output drivable area boundary masks with semantic information 4536, identifying a floor boundary for the detected floor region and other relevant boundaries for other relevant regions, such as the rug, or playmats, drop cloths, etc., as drivable area boundary masks with semantic information 4536. The drivable area boundary masks with semantic information 4536 from the scene segmentation module 4510, and the filtered 2D-3D bounding box and class label 4530 from the detection module 4502, may both be passed to the mapping module 4516 for further processing.

The mapping module 4516 may take the filtered 2D-3D bounding box and class label 4530 and drivable area boundary masks with semantic information 4536 as input and may add additional semantic context. In this manner, the mapping module 4516 may generate semantically rich pseudo-laserscans that may be used for planning and navigation tasks by the tidying robot 1600. A labeling module 4518 of the mapping module 4516 may take in the filtered 2D-3D bounding box and class label 4530 and drivable area boundary masks with semantic information 4536 and may provide additional semantic labels 4532 to the boundary map to improve task-specific filtering of generated pseudo-laserscan points. The locations of 2D bounding boxes or the 3D locations of 3D bounding boxes with respect to the tidying robot 1600 may be used to determine points in the edge mask that are inside the corresponding bounding boxes. All of these points may be assigned the same label as the bounding box to provide a semantically rich boundary map 4538.

A top view transformation module 4520 may receive the semantically rich boundary map 4538 and use it to create a pseudo-laserscan/point cloud with semantic label classes 4540. The top view transformation module 4520 may wrap the image of the semantically rich boundary map 4538 to real-world location coordinates. In one embodiment, this may be performed using a lookup table that stores the pixel mappings from image space to the real world. In one embodiment, this may be performed using a homography matrix that maps the pixels to real-world coordinates in real time. The pseudo-laserscan/point cloud with semantic label classes 4540 may be sent to a scene layout module 4522 and a local occupancy module 4526.

The scene layout module 4522 may accept the pseudo-laserscan/point cloud with semantic label classes 4540 and may pass it through a filter 4524, keeping the semantically relevant points needed for global mapping and discarding points not needed. The filter 4524 may iterate over all of the points in the pseudo-laserscan/point cloud with semantic label classes 4540 and may remove points whose class does not match classes identified in the filter 4524 configuration parameters. The result may be scene layout map data 4436 such as the scene layout map 4542, which may include the elements relevant for global mapping and may be transmitted to the navigation module 4600.

The local occupancy module 4526 may take in the pseudo-laserscan/point cloud with semantic label classes 4540 and may pass it through a filter 4528, keeping the semantically relevant points needed for local path planning and obstacle avoidance. The filter 4528 may iterate over all of the points in the pseudo-laserscan/point cloud with semantic label classes 4540 and may remove those whose class does not match classes identified in the configuration for the filter 4528. The filtered laserscan/point cloud may form local occupancy map data 4438 such as the local occupancy map 4544, which may include elements useful for local path planning and local obstacle avoidance and may be transmitted to the navigation module 4600. In some embodiments, the filtered 2D-3D bounding box and class label 4530 may be passed to the navigation module 4600 or other navigation module embodiment as shown for the filtered 2D and 3D bounding boxes 4434 introduced in FIG. 44.

FIG. 46 illustrates a navigation module 4600 in accordance with one embodiment. The navigation module 4600 may include a simultaneous localization and mapping module 4602, a global mapper module 4608, and a fusion and inflation module 4616. In one embodiment, the simultaneous localization and mapping module 4602 may include a sensor data filter and fusion module 4604 and a main pipeline 4606. The global mapper module 4608 may include a sensor data filter and semantic filter 4610, multi-sensor data registration 4612, and loop closure integration 4614. The fusion and inflation module 4616 may include map fusion 4618 and map inflation 4620. The navigation module 4600 may take in lidar data 4420, IMU data 4422, and wheel encoding data 4424 from the sensing system 4402, as well as scene layout map data 4436 and local occupancy map data 4438 from the perception module 4500. The navigation module 4600 may use this data to generate a robot pose 4440, an inflated local map data 4442, and an inflated global map data 4444, which it may transmit to the robot brain 4700.

The simultaneous localization and mapping module 4602 may process the lidar data 4420, IMU data 4422, and wheel encoding data 4424 as described below to determine a tidying robot 1600 pose and location within a SLAM global map. The tidying robot 1600 may be capable of taking on a number of poses for the purposes of performing its tasks, these poses comprising the conditions and actions of its moveable parts, such as the scoop 1610, scoop arm 1614, scoop arm pivot point 1616, pusher pads 1618, Pusher pad arms 1620, pad pivot points 1622, and pad arm pivot points 1624, described in detail with respect to FIGS. 16A-16B. The main pipeline 4606 of the simultaneous localization and mapping module 4602 may provide the robot pose 4440 to the robot brain 4700.

The sensor data filter and fusion module 4604 of the simultaneous localization and mapping module 4602 may take in lidar data 4420, which is a form of laser or visual data representing detected objects in a scene 4640, as well as IMU data 4422 and wheel encoding data 4424 as a source of odometry. Additional visual and odometry data may be received as input from other sources depending on the application or on the hardware available. This data may be passed through relevant filters to eliminate noise and data that is potentially unreliable. Lidar data 4420 may be passed through a box filter that may remove data that lies within a predefined footprint around the lidar, in order to cater to objects around the lidar that may move along with it. This may be achieved by checking each point in the lidar data 4420 to determine if the point lies within a provided polygon based on the number of intersections of a line passing through the point and infinity with all sides of the polygon. Other filters may be used at this stage as well, based on the quality of lidar data 4420 input. In this manner, the sensor data filter and fusion module 4604 may generate filtered lidar data 4622.

In order to cater to the bias offset created due to the misalignment of the IMU sensor 4408 z-axis with a gravity vector, a correction filter may be used by the sensor data filter and fusion module 4604 to rectify this offset in the angular velocity output of the sensor, represented in the IMU data 4422. This offset may be configured at a calibration step. The filter stage may subtract the same offset from every data instance. Additional components of the IMU data 4422 may be used and filtered appropriately in the sensor data filter and fusion module 4604 depending on the input data quality.

Owing to the noise in the angular velocity output of wheel encoding data 4424, the same may be filtered by the sensor data filter and fusion module 4604. The remaining wheel encoding data 4424 may be fused with the filtered IMU data 4422 to generate an encoder-IMU filtered and fused odometry data 4624 source for the simultaneous localization and mapping module 4602. An extended Kalman filter (EKF) may be used for this fusion. The filtered lidar data 4622 and filtered and fused odometry data 4624 created by the sensor data filter and fusion module 4604 may be passed to the simultaneous localization and mapping module 4602 main pipeline 4606.

The main pipeline 4606 may receive the filtered lidar data 4622 and filtered and fused odometry data 4624, as well as other relevant visual and odometry information depending on the application or available hardware. The sensing system 4402 may provide a new laser measurement, in the form of lidar data 4420 at particular intervals governed by robot motion. The lidar data 4420 may correspond to a given odometry reading at these intervals, which may also be determined using data from the sensing system 4402, as described above. For each new laser measurement provided in the filtered lidar data 4622, a new 2D point registration may be created by the main pipeline 4606. The filtered lidar data 4622 for a single time instance may be provided in the form of consecutive angular range measurements that give a Euclidean distance between an obstacle detected at a point located at a particular angle from the lidar center. This angular range may be provided in polar coordinate form. This polar data may be converted to 2D cartesian coordinates using standard formulas for 2D geometry, and then transformed from the lidar frame of reference (center of lidar) to the frame of reference for the odometry reading at that point in time, provided in the filtered and fused odometry data 4624. The 2D point registrations may be added to a pose-graph, which may be a graphical representation of the odometry poses at each lidar measurement and their relationships, where nodes represent the poses and edges represent the spatial constraints (i.e., 2D transformations between the poses of corresponding nodes). The pose-graph may be initiated by the main pipeline 4606 when it is provided the filtered lidar data 4622 from the robot's initial lidar scan.

The main pipeline 4606 may use consecutive such filtered lidar data 4622 scans and filtered and fused odometry data 4624 readings for scan-to-scan matching to estimate and correct any odometry slippages that may have occurred between lidar scans. An odometry slippage may be detected when the filtered and fused odometry data 4624 is inconsistent with the location of the tidying robot 1600 indicated by the filtered lidar data 4622. As subsequent scans and readings arrive at the main pipeline 4606, a number “N” of the poses (nodes) in the pose-graph may be used together in a chain to look for loop closure. The number N may be tuned based on factors such as expected odometry and lidar noise and compute availability. Loop closure may be detected by determining if the current location being observed through the sensors has been previously visited by the robot or not. This is achieved by comparing current sensor data instances with previously stored instances corresponding to the area near the current estimated location of the robot. If a loop closure is detected, a correction constraint may be added to the pose-graph. The odometry poses for the N poses in the chain may be corrected based on the results from a pose-graph optimization. The optimization may be an error minimization technique incorporating the correction of the newly observed loop closure constraint into the N previous poses. As a result, the main pipeline 4606 may effectively achieve better global consistency in the SLAM global map it generates as output by reducing distortions and noise in mapped regions that arise from odometry slippages.

The main pipeline 4606 may perform a final spatial registration that may include probabilistically updating the 2D point registrations using methods such as Bayesian belief update and log odds update, which are based on counters of hits and misses of lidar beams. The final spatial registration may use all of the 2D point registrations it has collected from all data instances in a common grid for each particular location in the occupancy grid (cell location) defined by its spatial location in the real world, the starting location of the pipeline, and the map resolution. This grid is initialized at an origin point of the occupancy grid map based on the location where the pipeline is started. The local occupancy grid may drift due to odometry slippage but may be corrected in this manner. Grid sizing depends on the resolution of the map to be created and updated in the main pipeline 4606, as well as the extents of the coordinates in the 2D point registrations generated above, which may increase as the robot explores more areas. This workflow encompasses the approach based on the sensor suite used by us. However, for a different set of sensors, providing similar types of sources may involve additional or alternative steps, but overall may eventually lead to a similar occupancy grid-based representation of the environment.

Through these steps, the main pipeline 4606 may produce a SLAM global map 4632, which may be a 2D occupancy grid representation of the environment with obstacle information at lidar height and real-time location information for the robot. The main pipeline 4606 may provide the SLAM global map 4632 to the loop closure integration 4614 module of the global mapper module 4608, which is described in greater detail below.

The global mapper module 4608 may include a sensor data filter and semantic filter 4610. The sensor data filter and semantic filter 4610 may receive as input the lidar data 4420 from the sensing system 4402, as well as other sources of relevant visual information, and the scene layout map data 4436 from the perception module 4500. Similar to the sensor data filter and fusion module 4604 of the simultaneous localization and mapping module 4602, this filter may eliminate noise and potentially unreliable data in the context of mapping without regard to localization (the global mapper module 4608 may rely on the simultaneous localization and mapping module 4602 for accurate localization). The lidar data 4420 and other visual data may be processed as described for the sensor data filter and fusion module 4604. The scene layout map data 4436 may be passed through a semantic filter that caters to the filtering of points from the scene layout map data 4436 based on semantic information provided. This may act as an additional step of filtering control to eliminate unreliable/irrelevant semantic labels during mapping. The filtered lidar data 4622 and filtered scene layout map 4626 provided by the sensor data filter and semantic filter 4610 may be input to the multi-sensor data registration 4612.

Similar to the SLAM main pipeline 4606, the multi-sensor data registration 4612 may create 2D point registrations, but in this case, it may be for the visual sensors of the sensing system 4402. These registrations may created using the localization information from the simultaneous localization and mapping module 4602 module rather than odometry data. The multi-sensor data registration 4612 may transform the visual sensor data from the sensor frame of reference to the frame of reference in which the SLAM module main pipeline 4606 provides real-time localization information, i.e., the location where the main pipeline 4606 begins mapping. All of the 2D point registrations for the visual sensor data may then be probabilistically updated together in a common 2D occupancy grid based on predetermined sensor confidence values using similar approaches to those described for the main pipeline 4606 above. Additional optimization techniques such as those used for the pose-graph optimization as well as particle filter-based updates may be introduced to provide additional accuracy improvements based on the use case. The multi-sensor data registration 4612 may thus create 2D point registrations 4628 forming a 2D occupancy grid representation of the environment with obstacle information at lidar height and information from the scene layout map data 4436.

The 2D point registrations 4628 may be provided to the loop closure integration 4614 of the global mapper module 4608, along with the SLAM global map 4632 from the simultaneous localization and mapping module 4602, including odometry pose corrections for the N data points at their N timestamps. The loop closure integration 4614 may use these inputs to create a navigation global map 4634 that is an improved 2D occupancy grid representation, as compared with the 2D occupancy grid representation of the SLAM global map 4632. The loop closure integration 4614 may leverage the loop closure performed in the simultaneous localization and mapping module 4602 to improve already-registered points that may be affected due to slippage in odometry that has been fixed by the simultaneous localization and mapping module 4602 but may need to be updated in the global mapper module 4608. The loop closure integration 4614 may reiterate over the 2D point registrations 4628 that are temporally near the loop closure pose corrections previously generated. In this manner, slippage may not need to be recomputed and recorrected during global mapper registration at the multi-sensor data registration 4612.

Using these map pose corrections, the loop closure integration 4614 may update each data instance, and may then update the corresponding 2D point registrations 4628 using the corrected poses. These updated registrations may then be used to re-update the probabilities of respective cells in the grid of the navigation global map 4634 in a manner similar to that used by the main pipeline 4606 to update the SLAM global map 4632. The navigation global map 4634 may thus be an improved 2D occupancy grid representation of the environment (as compared to the SLAM global map 4632).

The navigation global map 4634 may be sent to the fusion and inflation module 4616. The fusion and inflation module 4616 may also receive lidar data 4420 from the sensing system 4402 and local occupancy map data 4438 from the perception module 4500. The map fusion 4618 of the fusion and inflation module 4616 may fuse the multiple input maps and/or sensor data into a fused local occupancy map 4630. The local occupancy map data 4438 and the lidar data 4420 may be used to register the data points in a single-shot manner onto the navigation global map 4634 from the global mapper module 4608. Any new point in the local occupancy map data 4438 or lidar data 4420 may be updated immediately in the output fused local occupancy map 4630, not probabilistically. The fused local occupancy map 4630 may then be cropped into a smaller square map around the tidying robot 1600 (acting as its center). This may provide a local map that is useful for obstacle avoidance in the environment. The immediate updates of laser data may aid with the inclusion of objects at lidar height, such as humans walking, furniture, etc., within the lidar field of vision, as well as those from the local occupancy map data 4438 that may be below the lidar field of vision, such as pets, babies, toys, etc. The fused local occupancy map 4630 may be passed to map inflation 4620.

The map inflation 4620 may take in the navigation global map 4634 from the global mapper module 4608 and the fused local occupancy map 4630 from map fusion 4618. In applications where other map information is available, the map inflation 4620 may also take in this data. Map inflation 4620 may perform the inflation of input occupancy grid maps to include a factor of safety around obstacles, in essence creating a buffer for the tidying robot 1600. The size of this buffer region may be governed by the robot's size in order to enable it to avoid obstacles. In one embodiment map inflation 4620 may be used to make inflated versions of global and local maps that may be used for navigation. An expanded occupied cost region may be created around every occupied cell in the input occupancy grid, based on the radius of inflation. This may aid the tidying robot 1600 in planning its movements to avoid these regions of buffer around obstacles. This inflation may also help mask narrow spaces in the environment that may appear to be free space but may not have dimensions that would allow the tidying robot 1600 to pass through. In this manner, the map inflation 4620 may produce an inflated local map 4636 that is a 2D occupancy grid representation of the robot's environment with a buffer region. The inflated local map 4636 may be provided as inflated local map data 4442 to the robot brain 4700.

Similarly, the map inflation 4620 may produce an inflated global map 4638 that may be provided as inflated global map data 4444 to the robot brain 4700. The inflated global map 4638 may be a 2D occupancy grid representation including a buffer region. The inflated global map 4638 may be provided as inflated global map data 4444 to the robot brain 4700.

FIG. 47 illustrates a robot brain 4700 in accordance with one embodiment. The robot brain 4700 may include a state module 4702 and a decision module 4708. The state module 4702 may include a robot state 4704 and an environment state 4706. The decision module 4708 may include service endpoints 4710, an event queue 4712, status check 4714 algorithms, event check 4716 algorithms, and behaviors 4718.

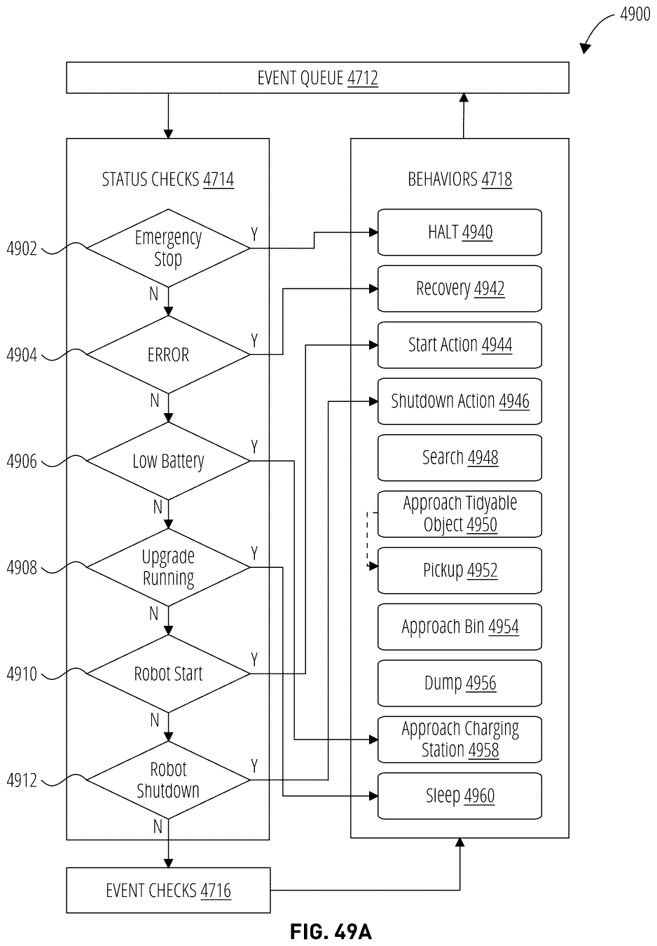

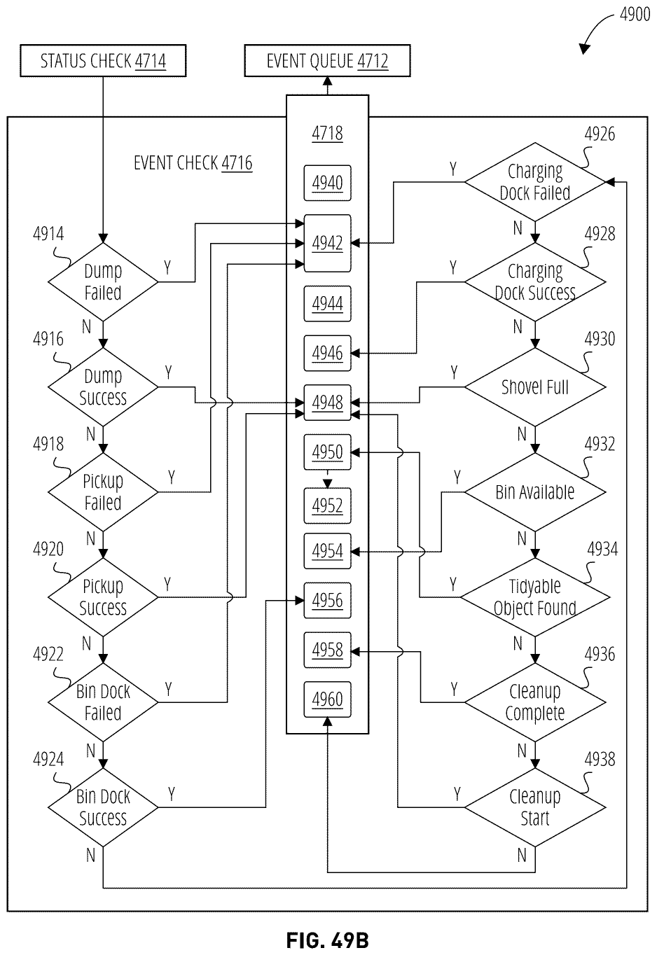

The robot brain 4700 may take the robot pose 4440, inflated local map data 4442, and inflated global map data 4444 data from the navigation module 4600, as well as data from other sensors 4412 among the sensing system 4402 in addition to those previously mentioned. A state module 4702 in the robot brain 4700 may use this information to determine a robot state 4704 and an environment state 4706, which the robot brain 4700 may communicate, via a ROS message queue 4802, to an action module 4800. The robot state 4704 may include conditions and parameters such as the robot pose 4440, as determined by the navigation module 4600 in one embodiment, a power charging status, the robot's location within its environment, a current task, a previous task, and/or next task the robot has to perform, a task status such as success or failure, and other state conditions, as are described in more detail with respect to FIG. 49A and FIG. 49B. The environment state may reflect conditions of an environment as detected by sensors and preserved as observations and maps. The environment state 4706 may include locations of objects as detected and located by the perception module 4500, the boundaries of a navigable area, a progress state toward a goal such as all detected objects handled as determined by their categories, etc. A decision module 4708 may interact with a robot user interface 4414, such as a mobile computing device application, web page, and/or hardware buttons, which provides a user the ability to communicate with and control the robot. The decision module 4708 may take interface signals 4428 from the robot user interfaces 4414 and determine service endpoints 4710, inform an event handler or event queue 4712, and control robot behaviors 4718. The data from the decision module 4708 likewise may be communicated to the action module 4800 via the ROS message queue 4802.

FIG. 48 illustrates an action module 4800 in accordance with one embodiment. The action module 4800 may include a ROS message queue 4802, an ROS universal asynchronous receiver/transmitter (UART) shown as ROS UART 4804, a controller 4806, a local planner 4808, and a global planner 4810.

The action module 4800 may take information from and send information to the robot brain 4700 using the ROS message queue 4802. The action module 4800 may also take information from and send information to robot actuators 4416, so as to effect action by the tidying robot 1600 within its environment, as will be well understood by one of skill in the art. In one embodiment, the action module 4800 may be the portion of the robotic control system 2500, such as a motion controller and motor and servo controller that controls actuators such as motors and servos which may impel the tidying robot 1600 to move throughout its environment and adjust its pose, as discussed above, in order to perform the tasks it is instructed to perform.

FIG. 49A and FIG. 49B illustrate a robot brain flow diagram 4900 in accordance with one embodiment. The actions of the flow diagram may be performed by a robot brain 4700 in conjunction with the perception module 4500, the navigation module 4600, and the action module 4800, as introduced in FIG. 48.

The state module 4702 of the robot brain 4700 may store data on a robot state, such as the robot's position, orientation, velocity, acceleration, joint states, and battery status. The state module 4702 may also store data on an environment state, such as the global map, the local map, detected objects, and destination bins for different classes of objects. This state data may be communicated via the ROS message queue 4802 to the action module 4800.

The robot brain 4700 may also include a decision module 4708 that takes in data from interfaces (which may include a mobile app, a web application programming interface, hardware buttons, the robot charging port, etc.). The interfaces may communicate with service endpoints, which may inform an event queue 4712 or priority message queue. The event queue 4712 may send poll messages to a status check 4714 algorithm, which may determine an appropriate behavior 4718 from among the behaviors 4718 available. The selection of a behavior 4718 results in a push message back to the event queue 4712, as well as communication to the ROS message queue 4802 in order to effect an action by the robot using the action module 4800.

Beginning with the status check 4714, if a need for an emergency stop is detected at check 4902, the HALT 4940 behavior 4718 may be selected. Otherwise, if an ERROR is detected at check 4904, a recovery 4942 behavior 4718 may be selected. Otherwise, if a low battery status is detected at check 4906, an approach charging station 4958 behavior 4718 may be selected. Otherwise, if an upgrade running state is detected at check 4908, a sleep 4960 behavior 4718 may be selected. Otherwise, if a robot start status is detected at check 4910, a start action 4944 behavior 4718 may be selected. Otherwise, if a robot shutdown status is detected at check 4912, a shutdown action 4946 behavior 4718 may be selected. After the status checks 4714 have been performed, they may be followed by event checks 4716.

The event check 4716 algorithm may begin by determining if a dump failed event is detected at check 4914, and if so, a recovery 4942 behavior 4718 may be selected. Otherwise, if a dump success event is detected at check 4916, a search 4948 behavior 4718 may be selected. Otherwise, if a pickup failed event is detected at check 4918, a recovery 4942 behavior 4718 may be selected. Otherwise, if a pickup success event is detected at check 4920, a search 4948 behavior 4718 may be selected. Otherwise, if a bin dock failed event is detected at check 4922, a recovery 4942 behavior 4718 may be selected. Otherwise, if a bin dock success event is detected check 4924, a dump 4956 behavior 4718 may be selected. Otherwise, if a charging dock failed event is detected at check 4926, a recovery 4942 behavior 4718 may be selected. Otherwise, if a charging doc success event is detected at check 4928, a shutdown action 4946 behavior 4718 may be selected. Otherwise, if a shovel full event is detected at check 4930, a search 4948 behavior 4718 may be selected. Otherwise, if a bin available event is detected at check 4932, an approach bin 4954 behavior 4718 may be selected. Otherwise, if a tidyable object available event is detected at check 4934, an approach tidyable object 4950 behavior 4718 may be selected. In one embodiment, the approach tidyable object 4950 behavior 4718 may be immediately followed by a pickup 4952 behavior 4718. Otherwise, if a cleanup complete event is detected at check 4936, an approach charging station 4958 behavior 4718 may be selected. Otherwise, if a cleanup start event is detected at check 4938, a search 4948 behavior 4718 may be selected. Otherwise, a sleep 4960 behavior 4718 may be selected.

This description is intended to illustrate and not limit the operation of the robot brain 4700 within a robot as disclosed herein. One of skill in the art will readily apprehend that the checks listed may be performed in some other order and that more or fewer checks than are illustrated here may be performed, resulting in the selection of more, fewer, or other behaviors than are included in behaviors 4718.

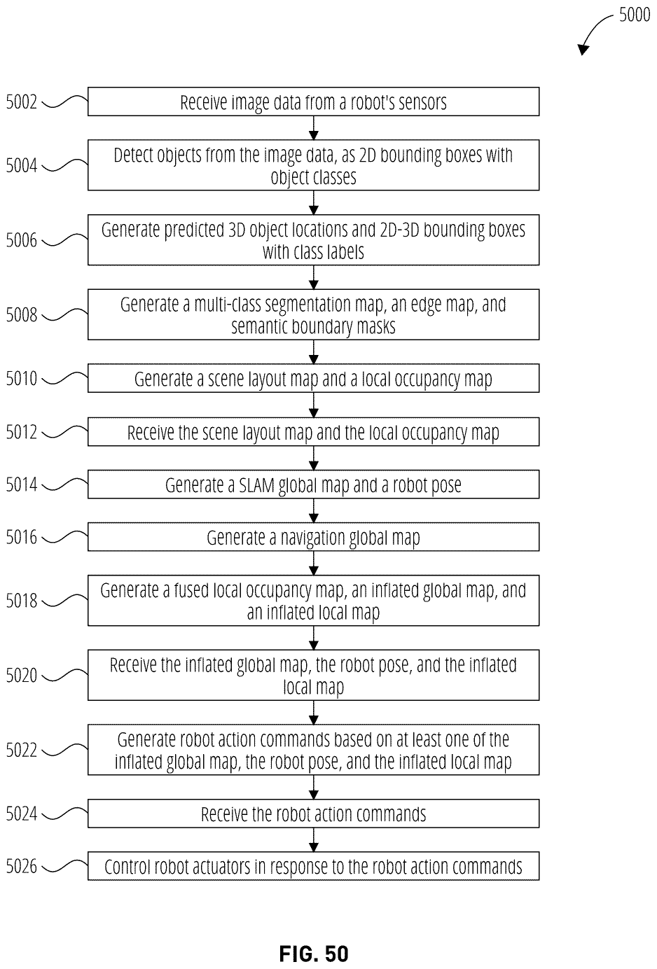

FIG. 50 illustrates an example routine 5000 in accordance with one embodiment. The routine 5000 may be performed by the elements of the robotic control system interfaces 4400 as described herein for the purpose of controlling a clutter tidying robot utilizing floor segmentation for the robot's mapping and navigation system. Although the example routine 5000 depicts a particular sequence of operations, the sequence may be altered without departing from the scope of the present disclosure. For example, some of the operations depicted may be performed in parallel or in a different sequence that does not materially affect the function of the routine 5000. In other examples, different components of an example device or system that implements the routine 5000 may perform functions at substantially the same time or in a specific sequence.

According to some examples, the method includes receiving image data from a robot's sensors at block 5002. For example, the perception module 4500 illustrated in FIG. 45 may receive image data from a robot's sensors. The perception module may comprise a detection module a scene segmentation module, and a mapping module. The robot's sensors may include at least one of cameras, lidar sensors, IMU sensors, wheel encoders, and other sensors.

According to some examples, the method includes detecting objects from the image data, as 2D bounding boxes with object classes at block 5004. For example, the detection module 4502 illustrated in FIG. 45 may detect objects from the image data, as 2D bounding boxes with object classes.

According to some examples, the method includes generating predicted 3D object locations and 2D-3D bounding boxes with class labels at block 5006. For example, the detection module 4502 illustrated in FIG. 45 may generate predicted 3D object locations and 2D-3D bounding boxes with class labels. The 3D object locations may be predicted using the 2D bounding boxes and a ground plane. The 2D-3D bounding boxes may be based on the predicted 3D object locations. In one embodiment, detection filtering by the detection module may remove the 2D-3D bounding boxes that are not on the ground or are inside of a shovel on the robot.

According to some examples, the method includes generating a multi-class segmentation map, an edge map, and semantic boundary masks at block 5008. For example, the scene segmentation module 4510 illustrated in FIG. 45 may generate a multi-class segmentation map, an edge map, and semantic boundary masks. The multi-class segmentation map may be generated using a segmentation model to segregate a floor boundary and other relevant regions in the image data. The edge map may include the floor boundary and other relevant boundaries, with semantic information. The semantic boundary masks may be created from the multi-class segmentation map. The semantic boundary masks may identify relevant boundaries and their semantic information. In one embodiment, the scene segmentation module may run an edge detection algorithm on the multi-class segmentation map, resulting in the semantic boundary masks with semantic information.

According to some examples, the method includes generating a scene layout map and a local occupancy map at block 5010. For example, the mapping module 4516 illustrated in FIG. 45 may generate a scene layout map and a local occupancy map. The scene layout map and the local occupancy map may be created using the 2D-3D bounding boxes and the semantic boundary masks. The scene layout map may include elements relevant for global mapping. The local occupancy map may include elements useful for local path planning and local obstacle avoidance. In one embodiment, the mapping module may use a labeling module to add additional semantic labels to the segmentation boundary masks by determining the points in the edge map that are inside a corresponding 2D bounding box or a corresponding 2D-3D bounding box. The labeling module may then assign all of the points inside of the corresponding 2D bounding box or corresponding 2D-3D bounding box the same label as that of the corresponding 2D bounding box or corresponding 2D-3D bounding box, thereby resulting in a semantically rich boundary map. The semantically rich boundary map may be warped into a point cloud with real-world coordinates and semantic label classes by a top view transformation module. The top view transformation module may use at least one of a lookup table that stores pixel mappings from an image space to real-world coordinates and a homography matrix that maps pixels from the image space to the real-world coordinates in real time. A scene layout module may filter the point cloud with real-world coordinates and semantic label classes, keeping the semantically relevant points needed for global mapping and discarding points not needed for global mapping. Similarly, the local occupancy module may filter the point cloud with real-world coordinates and semantic label classes, keeping the semantically relevant points needed for local path planning and obstacle avoidance.

According to some examples, the method includes receiving the scene layout map and the local occupancy map at block 5012. For example, the navigation module 4600 illustrated in FIG. 46 may receive the scene layout map and the local occupancy map. The navigation module may include a simultaneous localization and mapping module (SLAM) a global mapper module, and a fusion and inflation module.

According to some examples, the method includes generating a SLAM global map and a robot pose at block 5014. For example, the simultaneous localization and mapping module 4602 illustrated in FIG. 46 may generate a SLAM global map and a robot pose. The SLAM global map and robot pose may be generated using lidar data, IMU data, and wheel encoding data. The SLAM global map may include a 2D occupancy grid representation of the environment with obstacle information at lidar height and real-time location information of the robot. In one embodiment, a filter and fusion module in the simultaneous localization and mapping module may process the lidar data, the IMU data, and the wheel encoding data by removing noise and potentially unreliable data from the lidar data and the IMU data resulting in filtered lidar data and filtered IMU data, the filter and fusion module may also remove noise and potentially unreliable data from the angular velocity output of the wheel encoding data and fuse the non-angular velocity output data of the wheel encoding data with the filtered IMU data to generate filtered and fused odometry data. In one embodiment, the simultaneous localization and mapping module may use a main pipeline to generate the 2D occupancy grid representation of the environment with obstacle information at lidar height and real-time location information of the robot. The main pipeline may do this by receiving filtered lidar data and filtered and fused odometry data, creating a new 2D point registration for each new laser measurement at a given odometry reading, estimating and correcting odometry slippages between each odometry reading by scan-to-scan matching the new 2D point registrations, thereby resulting in odometry slippage data points, adding the odometry slippage data points to a pose-graph, resulting in an optimized pose-graph, and looking for loop closure in a chain of ‘N’ odometry slippage data points. Loop closure represents a process of determining if a current location observed by the robot's sensor has been previously visited by the robot. On condition loop closure is detected, the main pipeline may correct the odometry poses for each new 2D point registration based on the optimized pose-graph, resulting in loop closure pose corrections. The main pipeline may then form a common 2D occupancy grid using the 2D point registrations and probabilistically updated 2D point registrations, wherein the common 2D occupancy grid is the 2D occupancy grid representation of the environment with the obstacle information at lidar height and the real-time location information of the robot.

According to some examples, the method includes generating a navigation global map at block 5016. For example, the global mapper module 4608 illustrated in FIG. 46 may generate a navigation global map. The navigation global map may be created using the SLAM global map, lidar data, and the scene layout map. The navigation global map may represent an improved 2D occupancy grid representation of the environment when compared with the SLAM global map. In one embodiment, the global mapper module may use a sensor data filter to filter the lidar data and the scene layout map. The sensor data filter may remove noise and potentially unreliable data from the lidar data. The scene layout map may be passed through a semantic filter that caters to the filtering of points from the scene layout map based on the semantic information provided. The sensor data filter may output filtered lidar data and a filtered scene layout map where unreliable and irrelevant semantic labels have been removed during mapping. In one embodiment, the global mapper module may use a multi-sensor data registration to generate an enhanced 2D occupancy grid representation of the environment with obstacle information at lidar height, from the filtered lidar data and the filtered scene layout map received from the sensor data filter and semantic filter, by creating a new enhanced 2D point registration for each new laser measurement and the scene layout map using the real-time location information from the SLAM and updating all registrations from all of the robot's sensors, probabilistically, together in an enhanced common 2D occupancy grid based on predetermined confidence values of the robot's sensors. In one embodiment, the global mapper module may receive, by loop closure integration, the new enhanced 2D point registrations and the SLAM global map including the loop closure pose corrections. The loop closure integration may reiterate, temporally, over the new 2D point registrations that are near the loop closure pose corrections for all of the updated registrations of the robot's sensors from the multi-sensor data registration to provide reiterated loop closure pose corrections. The loop closure integration may update map pose data of each of the robot's sensors using the reiterated loop closure pose corrections, re-update the updated registrations of each of the robot's sensors with the updated map pose data, thereby resulting in enhanced registrations, and re-update, probabilistically with the enhanced registrations, respective cells in the enhanced common 2D occupancy grid, thereby resulting in the navigation global map.

According to some examples, the method includes generating a fused local occupancy map, an inflated global map, and an inflated local map at block 5018. For example, the fusion and inflation module 4616 illustrated in FIG. 46 may generate a fused local occupancy map, an inflated global map, and an inflated local map. These maps may be created from the lidar data, the navigation global map, and the local occupancy map. The fused local occupancy map may include lidar data and information from the navigation global map and the local occupancy map, making the local occupancy map useful for obstacle avoidance. The inflated global map may include buffer regions for the robot around obstacles. The inflated local map may be based on the fused local occupancy map, which includes buffer regions for the robot around obstacles.

According to some examples, the method includes receiving the inflated global map, the robot pose, and the inflated local map at block 5020. For example, the robot brain 4700 illustrated in FIG. 47 may receive the inflated global map, the robot pose, and the inflated local map.

According to some examples, the method includes generating robot action commands based on at least one of the inflated global map, the robot pose, and the inflated local map at block 5022. For example, the robot brain 4700 illustrated in FIG. 47 may generate robot action commands based on at least one of the inflated global map, the robot pose, and the inflated local map. In one embodiment, the robot brain may receive an interface signal from a robot user interface. The robot brain may then generate the robot action commands based on at least one of the inflated global map, the robot pose, the inflated local map, and the interface signal.

According to some examples, the method includes receiving the robot action commands at block 5024. For example, the action module 4800 illustrated in FIG. 48 may receive the robot action commands.

According to some examples, the method includes controlling robot actuators in response to the robot action commands at block 5026. For example, the action module 4800 illustrated in FIG. 48 may control robot actuators in response to the robot action commands.

FIG. 51 illustrates a video-feed segmentation routine 5100 in accordance with one embodiment. Although the example video-feed segmentation routine 5100 depicts a particular sequence of operations, the sequence may be altered without departing from the scope of the present disclosure. For example, some of the operations depicted may be performed in parallel or in a different sequence that does not materially affect the function of the video-feed segmentation routine 5100. In other examples, different components of an example device or system that implements the video-feed segmentation routine 5100 may perform functions at substantially the same time or in a specific sequence.

According to some examples, the method includes receiving and processing live video with depth at block 5102. The live video feed may capture an environment to be tidied. For example, the mobile computing device 5122 may be configured to receive and process live video with depth using a camera configured as part of the mobile computing device 5122 in conjunction with the robotic control system. This live video may be used to begin mapping the environment to be tidied, and to determine characteristics of objects within the environment. Alternatively, the robotic control system such as has been previously disclosed may be configured to receive and process live video with depth using their cameras in conjunction with the robotic control system. This may support the robot's initialization, configuration, and operation as disclosed herein. The live video feed may include images of a scene 5110 across the environment to be tidied. These may be processed to display an augmented reality view to a user on a global map of the environment to be tidied.

According to some examples, the method includes running a panoptic segmentation model 5108 to assign labels at block 5104. For example, the panoptic segmentation model 5108 illustrated in FIG. 51 may run a model to assign labels. The model may assign a semantic label (such as an object type), an instance identifier, and a movability attribute (such as static, movable, and tidyable) for each pixel in an image of a scene 5110 (such as is displayed in a frame of captured video). The panoptic segmentation model 5108 may be configured as part of the logic of the robotic control system in one embodiment. The panoptic segmentation model 5108 may in this manner produce a segmented image 5112 for each image of a scene 5110. Elements detected in the segmented image 5112 may in one embodiment be labeled as shown:
10. floor
11. rug
12. bedframe
13. nightstand
14. drawer
15. bedspread
16. box
17. lamp
18. books
19. picture
20. wall
21. curtains
22. headboard
23. pillow
24. stuffed animal
25. painting

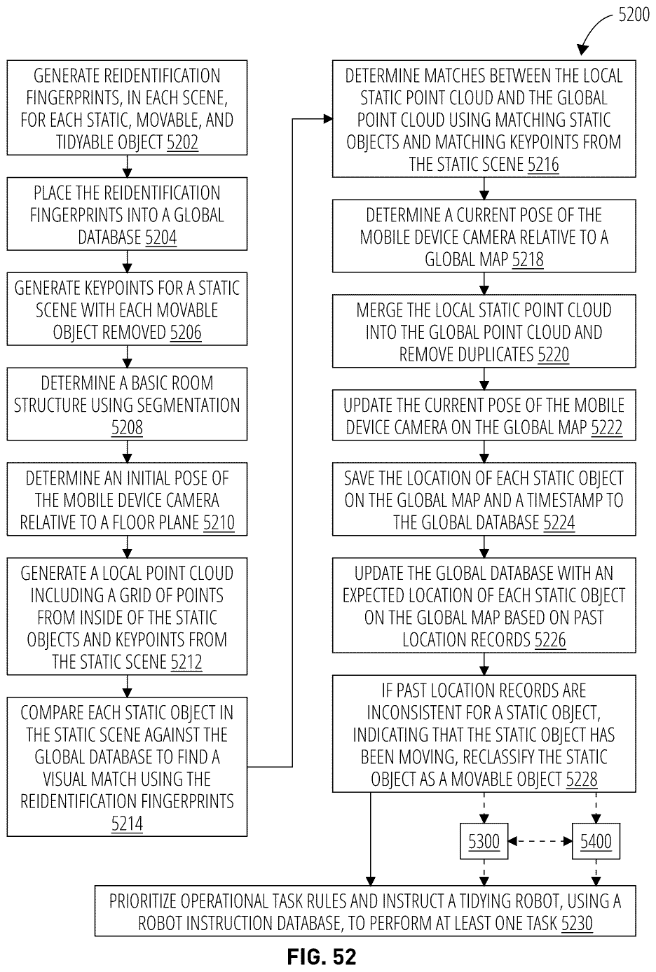

According to some examples, the method includes separating the segmented image into static objects 5116, movable objects 5118, and tidyable objects 5120 at block 5106. For example, the robotic control system may separate static, movable, and tidyable objects. Using the segmented image 5112 and assigned labels, static structures in the represented scene, such as floors, walls, and large furniture, may be separated out as static objects 5116 from movable objects 5118 like chairs, doors, and rugs, and tidyable objects 5120 such as toys, books, and clothing. Upon completion of the video-feed segmentation routine 5100, the mobile mobile computing device 5122, robotic control system 2500, and robotic control system may act to perform the static object identification routine 5200 illustrated in FIG. 52 based on the objects separated into static objects, movable objects, and tidyable objects 5114.

FIG. 52 illustrates a static object identification routine 5200 in accordance with one embodiment. The mobile device, such as a user's smartphone or tablet or the tidying robot, may use a mobile device camera to detect static objects in order to localize itself within the environment, since such objects may be expected to remain in the same position.
The indoor room structure such as the floor segmentation, wall segmentation, and ceiling segmentation may be used to orient the mobile device camera relative to the floor plane. This may provide the relative vertical position and orientation of the mobile device camera relative to the floor, but not necessarily an exact position on the map.
Scale invariant keypoints may be generated using the pixels in the segmented image 5112 that correspond with static objects, and these keypoints may be stored as part of a local point cloud.
Reidentification fingerprints may also be generated for each static object in the image frame and stored as part of a local point cloud.
Matching takes place between the local point cloud (based on the current mobile device camera frame) and the global point cloud (based on visual keypoints and static objects on the global map). This is used to localize the mobile device camera relative to the global map.

The mobile device camera may be the cameras mounted on the tidying robot as previously described. The mobile device camera may also be a camera configured as part of a user's smartphone, tablet, or other commercially available mobile computing device.

Although the example static object identification routine 5200 depicts a particular sequence of operations, the sequence may be altered without departing from the scope of the present disclosure. For example, some of the operations depicted may be performed in parallel or in a different sequence that does not materially affect the function of the static object identification routine 5200. In other examples, different components of an example device or system that implements the static object identification routine 5200 may perform functions at substantially the same time or in a specific sequence. This static object identification routine 5200 may be performed by the robotic control system.

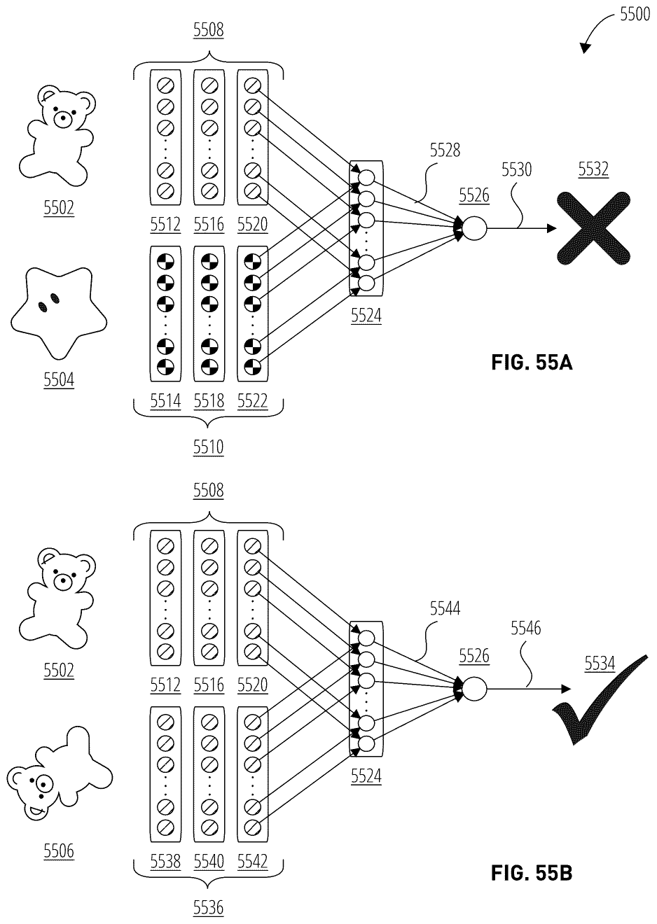

According to some examples, the method includes generating reidentification fingerprints, in each scene, for each static, movable, and tidyable object at block 5202. This may be performed using a segmented image including static scene structure elements and omitting other elements. These reidentification fingerprints may act as query sets (query object fingerprints 5508) used in the object identification with fingerprints 5500 process described with respect to FIG. 55A and FIG. 55B. According to some examples, the method includes placing the reidentification fingerprints into a global database at block 5204. The global database may store data for known static, movable, and tidyable objects. This data may include known object fingerprints to be used as described with respect to FIG. 55A and FIG. 55B.

According to some examples, the method includes generating keypoints for a static scene with each movable object removed at block 5206. According to some examples, the method includes determining a basic room structure using segmentation at block 5208. The basic room structure may include at least one of a floor, a wall, and a ceiling. According to some examples, the method includes determining an initial pose of the mobile device camera relative to a floor plane at block 5210.

According to some examples, the method includes generating a local point cloud including a grid of points from inside of the static objects and keypoints from the static scene at block 5212. According to some examples, the method includes comparing each static object in the static scene against the global database to find a visual match using the reidentification fingerprints at block 5214. This may be performed as described with respect to object identification with fingerprints 5500 of FIG. 55A and FIG. 55B. According to some examples, the method includes determining matches between the local static point cloud and the global point cloud using matching static objects and matching keypoints from the static scene at block 5216.

According to some examples, the method includes determining a current pose of the mobile device camera relative to a global map at block 5218. The global map may be a previously saved map of the environment to be tidied. According to some examples, the method includes merging the local static point cloud into the global point cloud and remove duplicates at block 5220. According to some examples, the method includes updating the current pose of the mobile device camera on the global map at block 5222.

According to some examples, the method includes saving the location of each static object on the global map and a timestamp to the global database at block 5224. In one embodiment, new reidentification fingerprints for the static objects may also be saved to the global database. The new reidentification fingerprints to be saved may be filtered to reduce the number of fingerprints saved for an object.

According to some examples, the method includes updating the global database with an expected location of each static object on the global map based on past location records at block 5226. According to some examples, if past location records are inconsistent for a static object, indicating that the static object has been moving, the method includes reclassifying the static object as a movable object at block 5228.

Reclassifying the static object as a movable object may include generating an inconsistent static object location alert. The inconsistent static object location alert may be provided to the robotic control system of a tidying robot, as feedback to refine, simplify, streamline, or reduce the amount of data transferred to instruct the tidying robot to perform at least one robot operation. The static object may then be reclassified as a movable object by updating the object's movability attribute in the global database. The global map may also be updated to reflect the reclassified movable object. Operational task rules may be prioritized based on the movability attributes and/or the updated movability attributes, thereby optimizing the navigation of the tidying robot or increasing the efficiency in power utilization by the tidying robot.

According to some examples, the method includes instructing a tidying robot, using a robot instruction database, to perform at least one task at block 5230. Tasks may include sorting objects on the floor, tidying specific objects, tidying a cluster of objects, pushing objects to the side of a room, executing a sweep pattern, and executing a vacuum pattern.

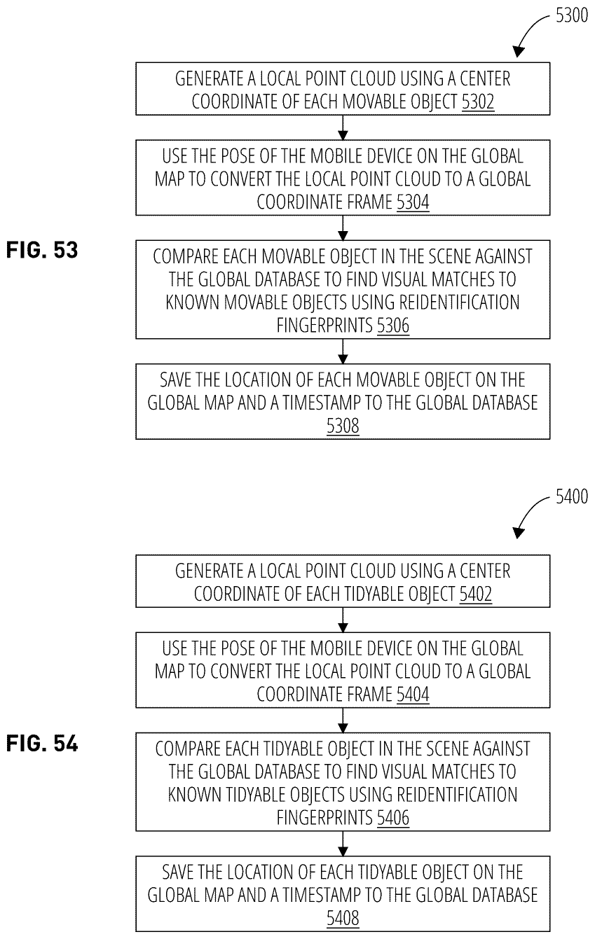

In one embodiment, the robotic control system may perform steps to identify moveable objects or tidyable objects after it has identified static objects. The static object identification routine 5200 may in one embodiment be followed by the movable object identification routine 5300 or the tidyable object identification routine 5400 described below with respect to FIG. 53 and FIG. 54, respectively. Either of these processes may continue on to the performance of the other, or to the instruction of the tidying robot at block 5230.

FIG. 53 illustrates a movable object identification routine 5300 in accordance with one embodiment. Although the example movable object identification routine 5300 depicts a particular sequence of operations, the sequence may be altered without departing from the scope of the present disclosure. For example, some of the operations depicted may be performed in parallel or in a different sequence that does not materially affect the function of the movable object identification routine 5300. In other examples, different components of an example device or system that implements the movable object identification routine 5300 may perform functions at substantially the same time or in a specific sequence.

According to some examples, the method includes generating a local point cloud using a center coordinate of each movable object at block 5302. According to some examples, the method includes using the pose of the mobile device (either a user's mobile computing device or the tidying robot) on the global map to convert the local point cloud to a global coordinate frame at block 5304. According to some examples, the method includes comparing each movable object in the scene against the global database to find visual matches to known movable objects using reidentification fingerprints at block 5306.

According to some examples, the method includes saving the location of each movable object on the global map and a timestamp to the global database at block 5308. In one embodiment, new reidentification fingerprints for the movable objects may also be saved to the global database. The new reidentification fingerprints to be saved may be filtered to reduce the number of fingerprints saved for an object.

FIG. 54 illustrates a tidyable object identification routine 5400 in accordance with one embodiment. Although the example tidyable object identification routine 5400 depicts a particular sequence of operations, the sequence may be altered without departing from the scope of the present disclosure. For example, some of the operations depicted may be performed in parallel or in a different sequence that does not materially affect the function of the tidyable object identification routine 5400. In other examples, different components of an example device or system that implements the tidyable object identification routine 5400 may perform functions at substantially the same time or in a specific sequence.

According to some examples, the method includes generating a local point cloud using a center coordinate of each tidyable object at block 5402. According to some examples, the method includes using the pose of the mobile device (either a user's mobile computing device or the tidying robot) on the global map to convert the local point cloud to a global coordinate frame at block 5404. According to some examples, the method includes comparing each tidyable object in the scene against the global database to find visual matches to known tidyable objects using reidentification fingerprints at block 5406.

According to some examples, the method includes saving the location of each tidyable object on the global map and a timestamp to the global database at block 5408. In one embodiment, new reidentification fingerprints for the tidyable objects may also be saved to the global database. The new reidentification fingerprints to be saved may be filtered to reduce the number of fingerprints saved for an object. In one embodiment, the user may next use an AR user interface to identify home locations for tidyable objects. These home locations may also be saved in the global database.

FIG. 55A and FIG. 55B illustrate object identification with fingerprints 5500 in accordance with one embodiment. FIG. 55A shows an example where a query set of fingerprints does not match the support set. FIG. 55B shows an example where the query set does match the support set.

A machine learning algorithm called meta-learning may be used to re-identify objects detected after running a panoptic segmentation model 5108 on a frame from an image of a scene 5110 as described with respect to FIG. 51. This may also be referred to as few-shot learning.

Images of objects are converted into embeddings using a convolutional neural network (CNN). The embeddings may represent a collection of visual features that may be used to compare visual similarity between two images. In one embodiment, the CNN may be specifically trained to focus on reidentifying whether an object is an exact visual match (i.e., determine if it is an image of the same object).

A collection of embeddings that represent a particular object may be referred to as a re-identification fingerprint. When re-identifying an object, a support set or collection of embeddings for each known object and a query set including several embeddings for the object being re-identified may be used. For example, for query object 5502, query object fingerprint 5508 may comprise the query set and may include query object embedding 5512, query object embedding 5516, and query object embedding 5520. Known objects 5504 and 5506 may each be associated with known object fingerprint 5510 and known object fingerprint 5536, respectively. Known object fingerprint 5510 may include known object embedding 5514, known object embedding 5518, and known object embedding 5522. Known object fingerprint 5536 may include known object embedding 5538, known object embedding 5540, and known object embedding 5542.

Embeddings may be compared in a pairwise manner using a distance function to generate a distance vector that represents the similarity of visual features. For example, distance function 5524 may compare the embeddings of query object fingerprint 5508 and known object fingerprint 5510 in a pairwise manner to generate distance vectors 5528. Similarly, the embeddings of query object fingerprint 5508 and known object fingerprint 5536 may be compared pairwise to generate distance vectors 5544.

A probability of match may then be generated using a similarity function that takes all the different distance vector(s) as input. For example, similarity function 5526 may use distance vectors 5528 as input to generate a probability of a match 5530 for query object 5502 and known object 5504. The similarity function 5526 may likewise use distance vectors 5544 as input to generate a probability of a match 5546 for query object 5502 and known object 5506. Note that because an object may look visually different when viewed from different angles it is not necessary for all of the distance vector(s) to be a strong match.

Additional factors may also be taken into account when determining the probability of a match such as object position on the global match and the object type as determined by the panoptic segmentation model. This is especially important when a small support set is used.

Taking these factors into account, the probability of a match 5530 may indicate no match 5532 between query object 5502 and known object 5504. On the other hand, the probability of a match 5546 may indicate a match 5534 between query object 5502 and known object 5506. Query object 5502 may thus be re-identified with high confidence as known object 5506 in one embodiment.

Once an object has been re-identified with high confidence, embeddings from the query set (query object fingerprint 5508) may be used to update the support set (known object fingerprint 5536). This may improve the reliability of re-identifying an object again in the future. However, the support set may not grow indefinitely and may have a maximum number of samples.

In one embodiment, a prototypical network may be chosen, where different embeddings for each object in the support set are combined into an “average embedding” or “representative embedding” which may then be compared with the query set to generate a distance vector as an input to help determine the probability of a match. In one embodiment, more than one “representative embedding” for an object may be generated if the object looks visually different from different angles.

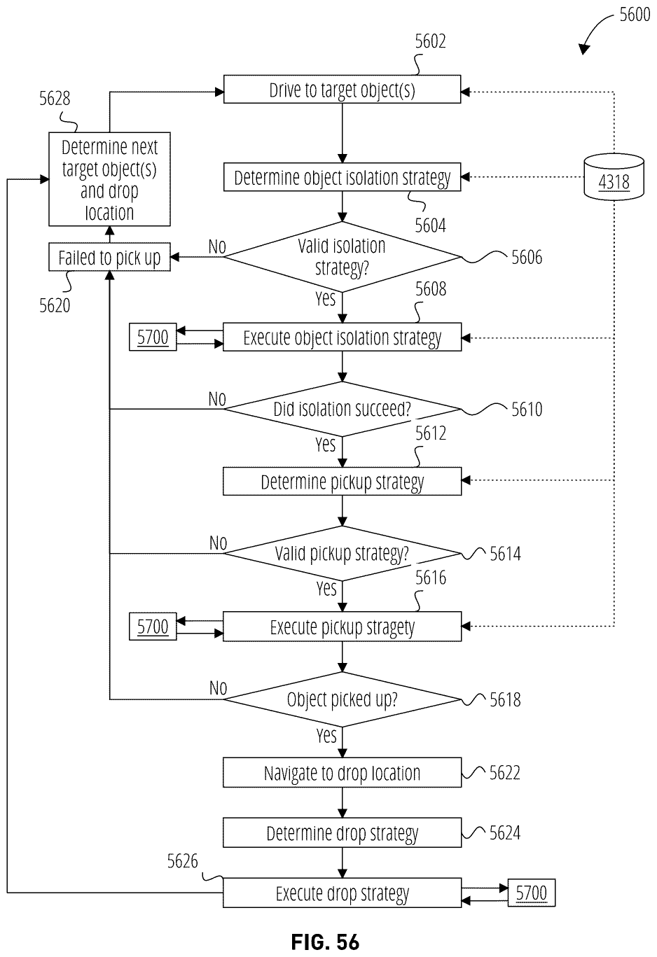

FIG. 56 illustrates a main navigation, collection, and deposition process 5600 in accordance with one embodiment. According to some examples, the method includes driving to target object(s) at block 5602. For example, the tidying robot 1600 such as that introduced with respect to FIG. 16A may drive to target object(s) using a local map or global map to navigate to a position near the target object(s), relying upon observations, current robot state, current object state, and sensor data 4318 determined as illustrated in FIG. 43.

According to some examples, the method includes determining an object isolation strategy at block 5604. For example, the robotic control system 2500 illustrated in FIG. 25 may determine an object isolation strategy in order to separate the target object(s) from other objects in the environment based on the position of the object(s) in the environment. The object isolation strategy may be determined using a machine learning model or a rules based approach, relying upon observations, current robot state, current object state, and sensor data 4318 determined as illustrated in FIG. 43. In some cases, object isolation may not be needed, and related blocks may be skipped. For example, in an area containing few items to be picked up and moved, or where such items are not in a proximity to each other, furniture, walls, or other obstacles, that would lead to interference in picking up target objects, object isolation may not be needed.

In some cases, a valid isolation strategy may not exist. For example, the robotic control system 2500 illustrated in FIG. 25 may be unable to determine a valid isolation strategy. If it is determined at decision block 5606 that there is no valid isolation strategy, the target object(s) may be marked as failed to pick up at block 5620. The main navigation, collection, and deposition process 5600 may then advance to block 5628, where the next target object(s) are determined.

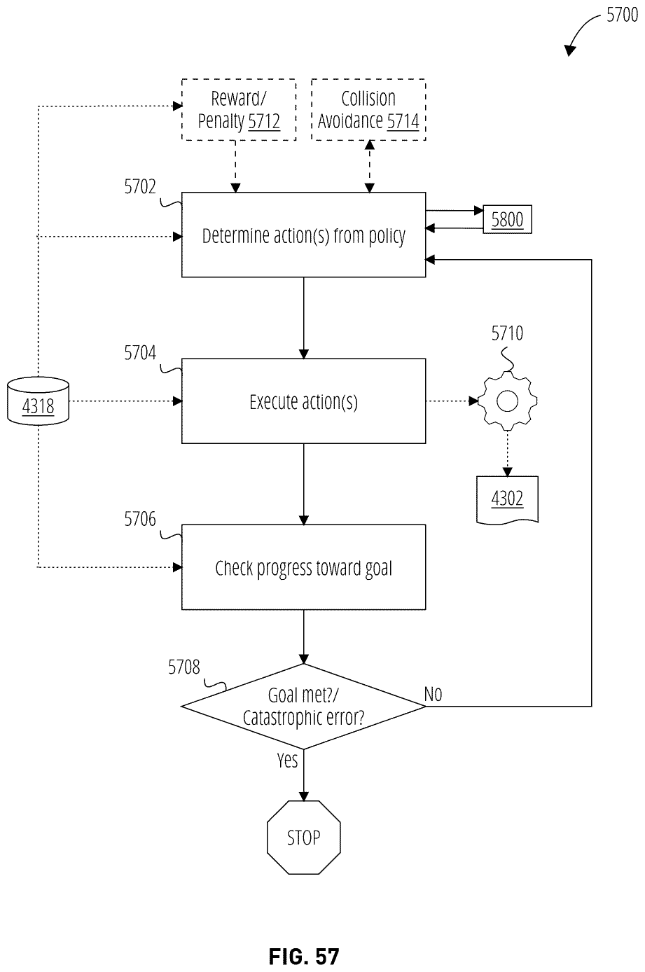

If there is a valid isolation strategy determined at decision block 5606, the tidying robot 1600 such as that introduced with respect to FIG. 16A may execute the object isolation strategy to separate the target object(s) from other objects at block 5608. The isolation strategy may follow strategy steps for isolation strategy, pickup strategy, and drop strategy 5700 illustrated in FIG. 57. The isolation strategy may be a reinforcement learning based strategy using rewards and penalties in addition to observations, current robot state, current object state, and sensor data 4318, or a rules based strategy relying upon observations, current robot state, current object state, and sensor data 4318 determined as illustrated in FIG. 43. Reinforcement learning based strategies relying on rewards and penalties are described in greater detail with reference to FIG. 57.

Rules based strategies may use conditional logic to determine the next logic based on observations, current robot state, current object state, and sensor data 4318 such as are developed in FIG. 43. Each rules based strategy may have a list of available actions it may consider. In one embodiment, a movement collision avoidance system may be used to determine the range of motion involved with each action. Rules based strategies for object isolation may include:
Navigating robot to a position facing the target object(s) to be isolated, but far enough away to open grabber pad arms and grabber pads and lower the shovel
Opening the grabber pad arms and grabber pads, lowering the grabber pad arms and grabber pads, and lowering the shovel
Turning robot slightly in-place so that target object(s) are centered in a front view
Opening grabber pad arms and grabber pads to be slightly wider than target object(s)
Driving forward slowly until the end of the grabber pad arms and grabber pads is positioned past the target object(s)
Slightly closing the grabber pad arms and grabber pads into a V-shape so that the grabber pad arms and grabber pads surround the target object(s)
Driving backwards 100 centimeters, moving the target object(s) into an open space

According to some examples, the method includes determining whether or not the isolation succeeded at decision block 5610. For example, the robotic control system 2500 illustrated in FIG. 25 may determine whether or not the target object(s) were successfully isolated. If the isolation strategy does not succeed, the target object(s) may be marked as failed to pickup at block 5620. The main navigation, collection, and deposition process 5600 advances to block 5628, where a next target object is determined. In some embodiments, rather than determining a next target object, a different strategy may be selected for the same target object. For example, if target object(s) are not able to be isolated by the current isolation strategy, a different isolation strategy may be selected and isolation retried.

If the target object(s) were successfully isolated, the method then includes determining a pickup strategy at block 5612. For example, the robotic control system 2500 illustrated in FIG. 25 may determine the pickup strategy. The pickup strategy for the particular target object(s) and location may be determined using a machine learning model or a rules based approach, relying upon observations, current robot state, current object state, and sensor data 4318 determined as illustrated in FIG. 43.

In some cases, a valid pickup strategy may not exist. For example, the robotic control system 2500 illustrated in FIG. 25 may be unable to determine a valid pickup strategy. If it is determined at decision block 5614 that there is no valid pickup strategy, the target object(s) may be marked as failed to pick up at block 5620, as previously noted. The pickup strategy may need to take into account:
An initial default position for the grabber pad arms and the shovel before starting pickup
A floor type detection for hard surfaces versus carpet, which may affect pickup strategies
A final shovel and grabber pad arm position for carrying

If there is a valid pickup strategy determined at decision block 5614, the tidying robot 1600 such as that introduced with respect to FIG. 16A may execute a pickup strategy at block 5616. The pickup strategy may follow strategy steps for isolation strategy, pickup strategy, and drop strategy 5700 illustrated in FIG. 57. The pickup strategy may be a reinforcement learning based strategy or a rules based strategy, relying upon observations, current robot state, current object state, and sensor data 4318 determined as illustrated in FIG. 43. Rules based strategies for object pickup may include:
Navigating the robot to a position facing the target object(s), but far enough away to open the grabber pad arms and grabber pads and lower the shovel
Opening the grabber pad arms and grabber pads, lowering the grabber pad arms and grabber pads, and lowering the shovel
Turning the robot slightly in-place so that the target object(s) are centered in the front view
Driving forward until the target object(s) are in a “pickup zone” against the edge of the shovel
Determining a center location of target object(s) against the shovel-on the right, left or center
   If on the right, closing the right grabber pad arm and grabber pad first with the left grabber pad arm and grabber pad closing behind
   Otherwise, closing the left grabber pad arm and grabber pad first with the right grabber pad arm and grabber pad closing behind
Determining if target object(s) were successfully pushed into the shovel
   If yes, then pickup was successful
   If no, lift grabber pad arms and grabber pads and then try again at an appropriate part of the strategy.

According to some examples, the method includes determining whether or not the target object(s) were picked up at decision block 5618. For example, the robotic control system 2500 illustrated in FIG. 25 may determine whether or not the target object(s) were picked up. Pickup success may be evaluated using:
Object detection within the area of the shovel and grabber pad arms (i.e., the containment area as previously illustrated) to determine if the object is within the shovel/grabber pad arms/containment area
Force feedback from actuator force feedback sensors indicating that the object is retained by the grabber pad arms
Tracking motion of object(s) during pickup into area of shovel and retaining the state of those object(s) in memory (memory is often relied upon as objects may no longer be visible when the shovel is in its carrying position)
Detecting an increased weight of the shovel during lifting indicating the object is in the shovel
Utilizing a classification model for whether an object is in the shovel
Using force feedback, increased weight, and/or a dedicated camera to re-check that an object is in the shovel while the robot is in motion

If the pickup strategy fails, the target object(s) may be marked as failed to pick up at block 5620, as previously described. If the target object(s) were successfully picked up, the method includes navigating to drop location at block 5622. For example, the tidying robot 1600 such as that introduced with respect to FIG. 16A may navigate to a predetermined drop location. The drop location may be a container or a designated area of the ground or floor. Navigation may be controlled by a machine learning model or a rules based approach.

According to some examples, the method includes determining a drop strategy at block 5624. For example, the robotic control system 2500 illustrated in FIG. 25 may determine a drop strategy. The drop strategy may need to take into account the carrying position determined for the pickup strategy. The drop strategy may be determined using a machine learning model or a rules based approach. Rules based strategies for object drop may include:
Navigate the robot to a position 100 centimeters away from the side of a bin
Turn the robot in place to align it facing the bin
Drive toward the bin maintaining an alignment centered on the side of the bin
Stop three centimeters from the side of the bin
Verify that the robot is correctly positioned against the side of the bin
   If yes, lift the shovel up and back to drop target object(s) into the bin
   If no, drive away from bin and restart the process

Object drop strategies may involve navigating with a rear camera if attempting a back drop, or with the front camera if attempting a forward drop.

According to some examples, the method includes executing the drop strategy at block 5626. For example, the tidying robot 1600 such as that introduced with respect to FIG. 16A may execute the drop strategy. The drop strategy may follow strategy steps for isolation strategy, pickup strategy, and drop strategy 5700 illustrated in FIG. 57. The drop strategy may be a reinforcement learning based strategy or a rules based strategy. Once the drop strategy has been executed at block 5626, the method may proceed to determining the next target object(s) at block 5628. For example, the robotic control system 2500 illustrated in FIG. 25 may determine next target object(s). Once new target object(s) have been determined, the process may be repeated for the new target object(s).

Strategies such as the isolation strategy, pickup strategy, and drop strategy referenced above may be simple strategies, or may incorporate rewards and collision avoidance elements. These strategies may follow general approaches such as the strategy steps for isolation strategy, pickup strategy, and drop strategy 5700 illustrated in FIG. 57.

In some embodiments, object isolation strategies may include:
Using grabber pad arms and grabber pads on the floor in a V-shape to surround object(s) and backing up
Precisely grasping the object(s) and backing up with grabber pad arms and grabber pads in a V-shape
Loosely rolling a large object away with grabber pad arms and grabber pads elevated
Spreading out dense clutter by loosely grabbing a pile and backing up
Placing a single grabber pad arm/grabber pad on the floor between target object(s) and clutter, then turning
Putting small toys in the shovel, then dropping them to separate them
Using a single grabber pad arm/grabber pad to move object(s) away from a wall

In some embodiments, pickup strategies may include:
Closing the grabber pad arms/grabber pads on the floor to pick up a simple object
Picking up piles of small objects like small plastic building blocks by closing grabber pad arms/grabber pads on the ground
Picking up small, rollable objects like balls by batting them lightly on their tops with grabber pad arms/grabber pads, thus rolling them into the shovel
Picking up deformable objects like clothing using grabber pad arms/grabber pads to repeatedly compress the object(s) into the shovel
Grabbing an oversized, soft object like a large stuffed animal by grabbing and compressing it with the grabber pad arms/grabber pads
Grabbing a large ball by rolling it and holding it against the shovel with raised grabber pad arms/grabber pads
Picking up flat objects like puzzle pieces by passing the grabber pads over them sideways to cause instability
Grasping books and other large flat objects
Picking up clothes with grabber pad arms/grabber pads, lifting them above the shovel, and then dropping them into the shovel
Rolling balls by starting a first grabber pad arm movement and immediately starting a second grabber pad arm movement

In some embodiments, drop strategies may include:
Back dropping into a bin
Front dropping into a bin
Forward releasing onto the floor
Forward releasing against a wall
Stacking books or other flat objects
Directly dropping a large object using grabber pad arms/grabber pads instead of relying on the shovel

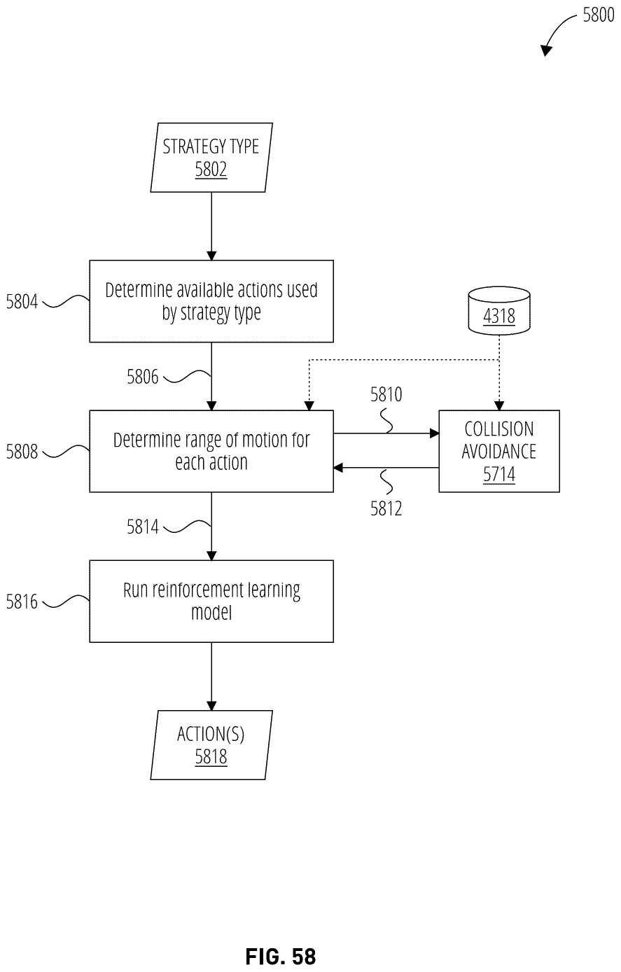

FIG. 57 illustrates strategy steps for isolation strategy, pickup strategy, and drop strategy 5700 in accordance with one embodiment. According to some examples, the method includes determining action(s) from a policy at block 5702. For example, the robotic control system 2500 illustrated in FIG. 25 may determine action(s) from the policy. The next action(s) may be based on the policy along with observations, current robot state, current object state, and sensor data 4318. The determination may be made through the process for determining an action from a policy 5800 illustrated in FIG. 58.

In one embodiment, strategies may incorporate a reward or penalty 5712 in determining action(s) from a policy at block 5702. These rewards or penalties 5712 may primarily be used for training the reinforcement learning model and, in some embodiments, may not apply to ongoing operation of the robot. Training the reinforcement learning model may be performed using simulations or by recording the model input/output/rewards/penalties during robot operation. Recorded data may be used to train reinforcement learning models to choose actions that maximize rewards and minimize penalties. In some embodiments, rewards or penalties 5712 for object pickup using reinforcement learning may include:
Small penalty added every second
Reward when target object(s) first touches edge of shovel
Reward when target object(s) pushed fully into shovel
Penalty when target object(s) lost from shovel
Penalty for collision with obstacle or wall (exceeding force feedback maximum)
Penalty for picking up non-target object
Penalty if robot gets stuck or drives over object

In some embodiments, rewards or penalties 5712 for object isolation (e.g., moving target object(s) away from a wall to the right) using reinforcement learning may include:
Small penalty added every second
Reward when right grabber pad arm is in-between target object(s) and wall
Reward when target object(s) distance from wall exceeds ten centimeters
Penalty for incorrectly colliding with target object(s)
Penalty for collision with obstacle or wall (exceeding force feedback maximum)
Penalty if robot gets stuck or drives over object

In some embodiments, rewards or penalties 5712 for object dropping using reinforcement learning may include:
Small penalty added every second
Reward when robot correctly docks against bin
Reward when target object(s) is successfully dropped into bin
Penalty for collision that moves bin
Penalty for collision with obstacle or wall (exceeding force feedback maximum)
Penalty if robot gets stuck or drives over object

In at least one embodiment, techniques described herein may use a reinforcement learning approach where the problem is modeled as a Markov decision process (MDP) represented as a tuple (S, O, A, P, r, Y), where S is the set of states in the environment, O is the set of observations, A is the set of actions, P: S×A×S→ [symbol] is the state transition probability function, r: S×A→ [symbol] is the reward function, and y is a discount factor.

In at least one embodiment, the goal of training may be to learn a deterministic policy π: O→A such that taking action aₜ=π(oₜ) at time t maximizes the sum of discounted future rewards from state sₜ:

$${R}_{t} = {\sum }_{i = t}^{∞} {γ}^{i - t} r ( {s}_{i} , {a}_{i} )$$

In at least one embodiment, after taking action aₜ, the environment transitions from state sₜ, to state sₜ₊₁ by sampling from P. In at least one embodiment, the quality of taking action at in state sₜ is measured by Q(sₜ, aₜ)= [symbol] [Rₜ|sₜ, aₜ], known as the Q-function.

In one embodiment, data from a movement collision avoidance system 5714 may be used in determining action(s) from a policy at block 5702. Each strategy may have an associated list of available actions which it may consider. A strategy may use the movement collision avoidance system to determine the range of motion for each action involved in executing the strategy. For example, the movement collision avoidance system may be used to see if the shovel may be lowered to the ground without hitting the grabber pad arms or grabber pads (if they are closed under the shovel), an obstacle such as a nearby wall, or an object (like a ball) that may have rolled under the shovel.

According to some examples, the method includes executing action(s) at block 5704. For example, the tidying robot 1600 such as that introduced with respect to FIG. 16A may execute the action(s) determined from block 5702. The actions may be based on the observations, current robot state, current object state, and sensor data 4318. the actions may be performed through motion of the robot motors and other actuators 5710 of the tidying robot 1600. The real world environment 4302 may be affected by the motion of the tidying robot 1600. The changes in the environment 4302 may be detected as described with respect to FIG. 43.

According to some examples, the method includes checking progress toward a goal at block 5706. For example, the robotic control system 2500 illustrated in FIG. 25 may check the progress of the tidying robot 1600 toward the goal. If this progress check determines that the goal of the strategy has been met, or that a catastrophic error has been encountered at decision block 5708, execution of the strategy will be stopped. If the goal has not been met and no catastrophic error has occurred, the strategy may return to block 5702.

FIG. 58 illustrates process for determining an action from a policy 5800 in accordance with one embodiment. The process for determining an action from a policy 5800 may take into account a strategy type 5802, and may, at block 5804 determined the available actions to be used based on the strategy type 5802. Reinforcement learning algorithms or rules based algorithms may take advantage of both simple actions and pre-defined composite actions. Examples of simple actions controlling individual actuators may include:
Moving the left grabber pad arm to a new position (rotating up or down)
Moving the left grabber pad wrist to a new position (rotating left or right)
Moving the right grabber pad arm to a new position (rotating up or down)
Moving the right grabber pad wrist to a new position (rotating left or right)
Lifting the shovel to a new position (rotating up or down)
Changing the shovel angle (with a second motor or actuator for front dropping)
Driving a left wheel
Driving a right wheel

Examples of pre-defined composite actions may include:
Driving the robot following a path to a position/waypoint
Turning the robot in place left or right
Centering the robot with respect to object(s)
Aligning grabber pad arms with objects' top/bottom/middle
Driving forward until an object is against the edge of the shovel
Closing both grabber pad arms, pushing object(s) with a smooth motion
Lifting the shovel and grabber pad arms together while grasping object(s)
Closing both grabber pad arms, pushing object(s) with a quick tap and slight release
Setting the shovel lightly against the floor/carpet
Pushing the shovel down against the floor/into the carpet
Closing the grabber pad arms until resistance is encountered/pressure is applied and hold that position
Closing the grabber pad arms with vibration and left/right turning to create instability and slight bouncing of flat objects over shovel edge

At block 5808, the process for determining an action from a policy 5800 may take the list of available actions 5806 determined at block 5804, and may determine a range of motion 5812 for each action. The range of motion 5812 may be determined based on the observations, current robot state, current object state, and sensor data 4318 available to the robot control system. Action types 5810 may also be indicated to the movement collision avoidance system 5714, and the movement collision avoidance system 5714 may determine the range of motion 5812.

Block 5808 of process for determining an action from a policy 5800 may determine an observations list 5814 based on the ranges of motion 5812 determined. An example observations list 5814 may include:
Detected and categorized objects in the environment
Global or local environment map
State 1: Left arm position 20 degrees turned in
State 2: Right arm position 150 degrees turned in
State 3: Target object 15 centimeters from shovel edge
State 4: Target object 5 degrees right of center
Action 1 max range: Drive forward 1 centimeter max
Action 2 max range: Drive backward 10 centimeters max
Action 3 max range: Open left arm 70 degrees max
Action 4 max range: Open right arm 90 degrees max
Action 5 max range: Close left arm 45 degrees max
Action 6 max range: Close right arm 0 degrees max
Action 7 max range: Turn left 45 degrees max
Action 8 max range: Turn right 45 degrees max

At block 5816, a reinforcement learning model may be run based on the observations list 5814. The reinforcement learning model may return action(s) 5818 appropriate for the strategy the tidying robot 1600 is attempting to complete based on the policy involved.

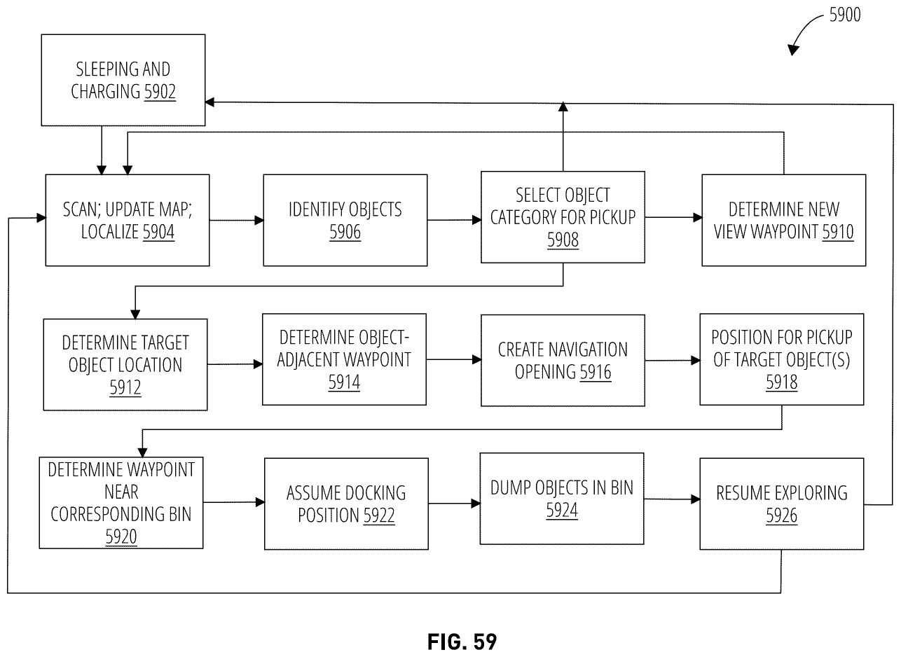

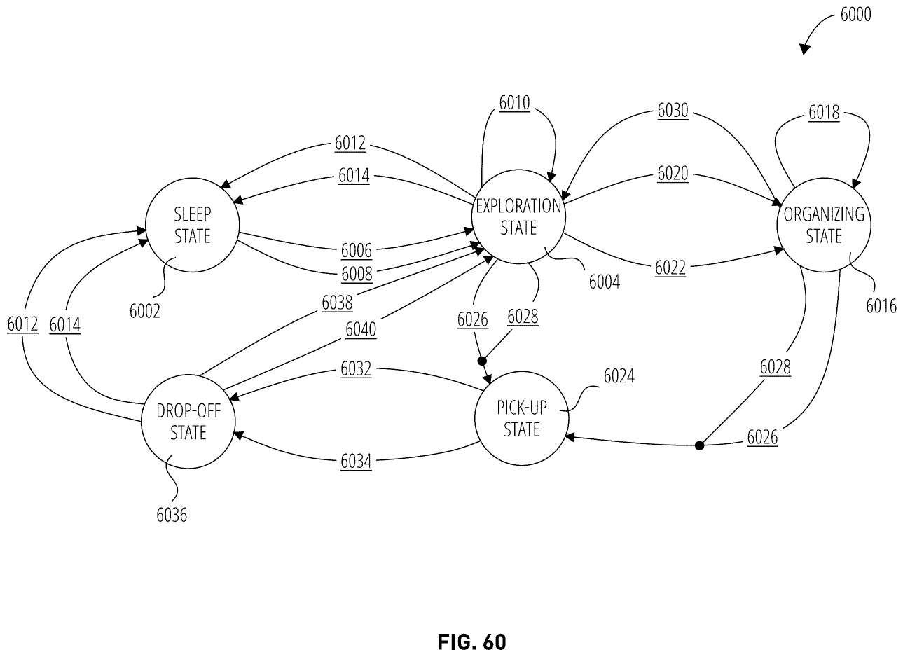

FIG. 59 also depicts a robotic process 5900 in one embodiment, in which the robotic system sequences through an embodiment of a state space map 6000 as depicted in FIG. 60.

The sequence begins with the robot sleeping (sleep state 6002) and charging at the base station (block 5902). The robot is activated, e.g., on a schedule, and enters an exploration mode (environment exploration state 6004, activation action 6006, and schedule start time 6008). In the environment exploration state 6004, the robot scans the environment using cameras (and other sensors) to update its environmental map and localize its own position on the map (block 5904, explore for configured interval 6010). The robot may transition from the environment exploration state 6004 back to the sleep state 6002 on condition that there are no more objects to pick up 6012, or the battery is low 6014.

From the environment exploration state 6004, the robot may transition to the object organization state 6016, in which it operates to move the items on the floor to organize them by category 6018. This transition may be triggered by the robot determining that objects are too close together on the floor 6020, or determining that the path to one or more objects is obstructed 6022. If none of these triggering conditions is satisfied, the robot may transition from the environment exploration state 6004 directly to the object pick-up state 6024 on condition that the environment map comprises at least one drop-off container for a category of objects 6026, and there are unobstructed items for pickup in the category of the container 6028. Likewise the robot may transition from the object organization state 6016 to the object pick-up state 6024 under these latter conditions. The robot may transition back to the environment exploration state 6004 from the object organization state 6016 on condition that no objects are ready for pick-up 6030.

In the environment exploration state 6004 and/or the object organization state 6016, image data from cameras is processed to identify different objects (block 5906). The robot selects a specific object type/category to pick up, determines a next waypoint to navigate to, and determines a target object and location of type to pick up based on the map of environment (block 5908, block 5910, and block 5912).

In the object pick-up state 6024, the robot selects a goal location that is adjacent to the target object(s) (block 5914). It uses a path planning algorithm to navigate itself to that new location while avoiding obstacles. The robot actuates left and right pusher arms to create an opening large enough that the target object may fit through, but not so large that other unwanted objects are collected when the robot drives forwards (block 5916). The robot drives forwards so that the target object is between the left and right pusher arms, and the left and right pusher arms work together to push the target object onto the collection shovel (block 5918).

The robot may continue in the object pick-up state 6024 to identify other target objects of the selected type to pick up based on the map of environment. If other such objects are detected, the robot selects a new goal location that is adjacent to the target object. It uses a path planning algorithm to navigate itself to that new location while avoiding obstacles, while carrying the target object(s) that were previously collected. The robot actuates left and right pusher arms to create an opening large enough that the target object may fit through, but not so large that other unwanted objects are collected when the robot drives forwards. The robot drives forwards so that the next target object(s) are between the left and right pusher arms. Again, the left and right pusher arms work together to push the target object onto the collection shovel.

On condition that all identified objects in category are picked up 6032, or if the shovel is at capacity 6034, the robot transitions to the object drop-off state 6036 and uses the map of the environment to select goal location that is adjacent to bin for the type of objects collected and uses a path planning algorithm to navigate itself to that new location while avoiding obstacles (block 5920). The robot backs up towards the bin into a docking position where back of the robot is aligned with the back of the bin (block 5922). The robot lifts the shovel up and backwards rotating over a rigid arm at the back of the robot (block 5924). This lifts the target objects up above the top of the bin and dumps them into the bin.

From the object drop-off state 6036, the robot may transition back to the environment exploration state 6004 on condition that there are more items to pick up 6038, or it has an incomplete map of the environment 6040. the robot resumes exploring and the process may be repeated (block 5926) for each other type of object in the environment having an associated collection bin.

The robot may alternatively transition from the object drop-off state 6036 to the sleep state 6002 on condition that there are no more objects to pick up 6012 or the battery is low 6014. Once the battery recharges sufficiently, or at the next activation or scheduled pick-up interval, the robot resumes exploring and the process may be repeated (block 5926) for each other type of object in the environment having an associated collection bin.

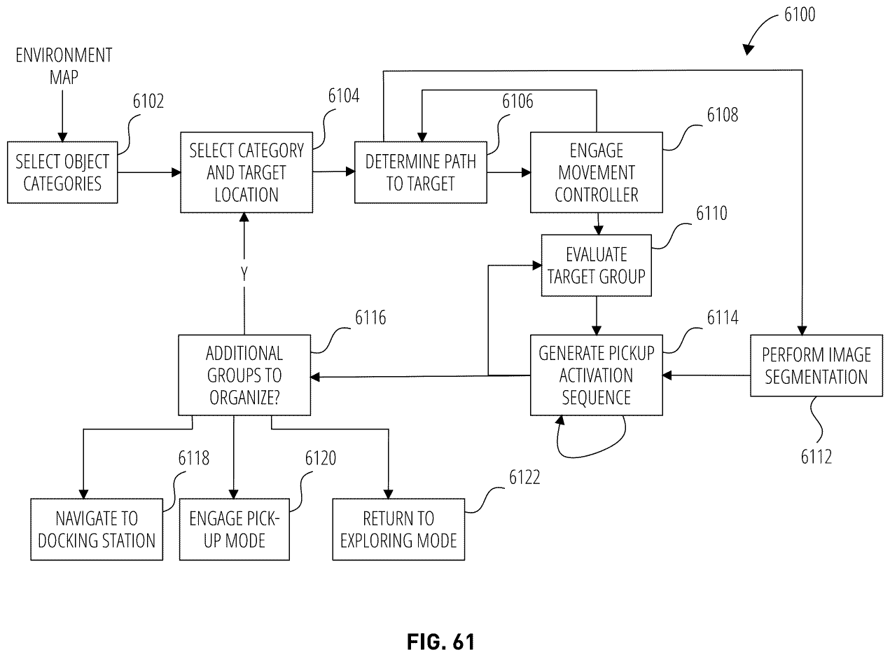

FIG. 61 depicts a robotic control algorithm 6100 for a robotic system in one embodiment. The robotic control algorithm 6100 begins by selecting one or more category of objects to organize (block 6102). Within the selected category or categories, a grouping is identified that determines a target category and starting location for the path (block 6104). Any of a number of well-known clustering algorithms may be utilized to identify object groupings within the category or categories.

A path is formed to the starting goal location, the path comprising zero or more waypoints (block 6106). Movement feedback is provided back to the path planning algorithm. The waypoints may be selected to avoid static and/or dynamic (moving) obstacles (objects not in the target group and/or category). The robot's movement controller is engaged to follow the waypoints to the target group (block 6108). The target group is evaluated upon achieving the goal location, including additional qualifications to determine if it may be safely organized (block 6110).

The robot's perception system is engaged (block 6112) to provide image segmentation for determination of a sequence of activations generated for the robot's manipulators (e.g., arms) and positioning system (e.g., wheels) to organize the group (block 6114). The sequencing of activations is repeated until the target group is organized, or fails to organize (failure causing regression to block 6110). Engagement of the perception system may be triggered by proximity to the target group. Once the target group is organized, and on condition that there is sufficient battery life left for the robot and there are more groups in the category or categories to organize, these actions are repeated (block 6116).

In response to low battery life the robot navigates back to the docking station to charge (block 6118). However, if there is adequate battery life, and on condition that the category or categories are organized, the robot enters object pick-up mode (block 6120), and picks up one of the organized groups for return to the drop-off container. Entering pickup mode may also be conditioned on the environment map comprising at least one drop-off container for the target objects, and the existence of unobstructed objects in the target group for pick-up. On condition that no group of objects is ready for pick up, the robot continues to explore the environment (block 6122).

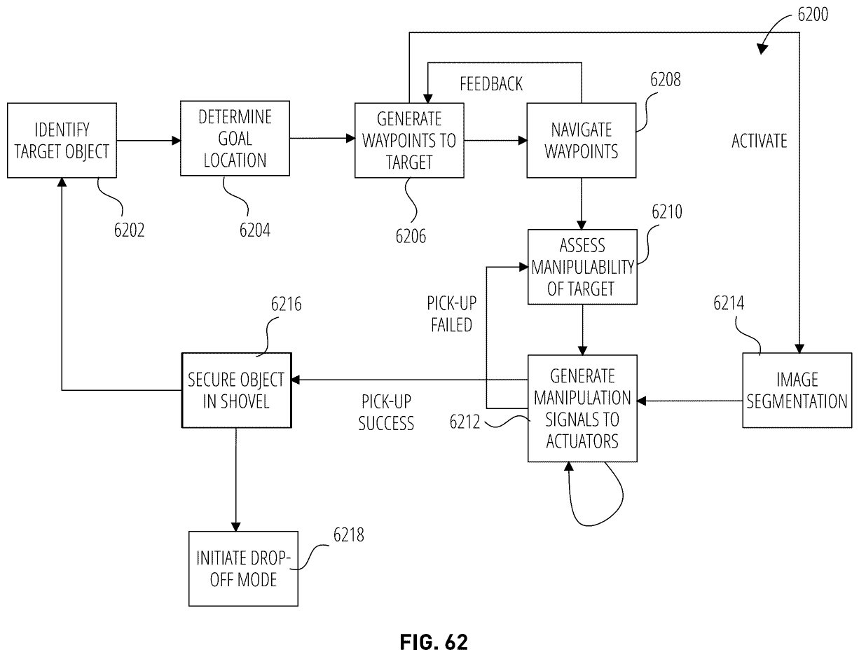

FIG. 62 depicts a robotic control algorithm 6200 for a robotic system in one embodiment. A target object in the chosen object category is identified (6202) and a goal location for the robot is determined as an adjacent location of the target object (6204). A path to the target object is determined as a series of waypoints (6206) and the robot is navigated along the path while avoiding obstacles (6208).

Once the adjacent location is reached, as assessment of the target object is made to determine if may be safely manipulated (6210). On condition that the target object may be safely manipulated, the robot is operated to lift the object using the robot's manipulator arm, e.g., shovel (6212). The robot's perception module may by utilized at this time to analyze the target object and nearby objects to better control the manipulation (6214).

The target object, once on the shovel or other manipulator arm, is secured (6216). On condition that the robot does not have capacity for more objects, or it's the last object of the selected category(ies), object drop-off mode is initiated (6218). Otherwise the robot may begin the process again (6202).

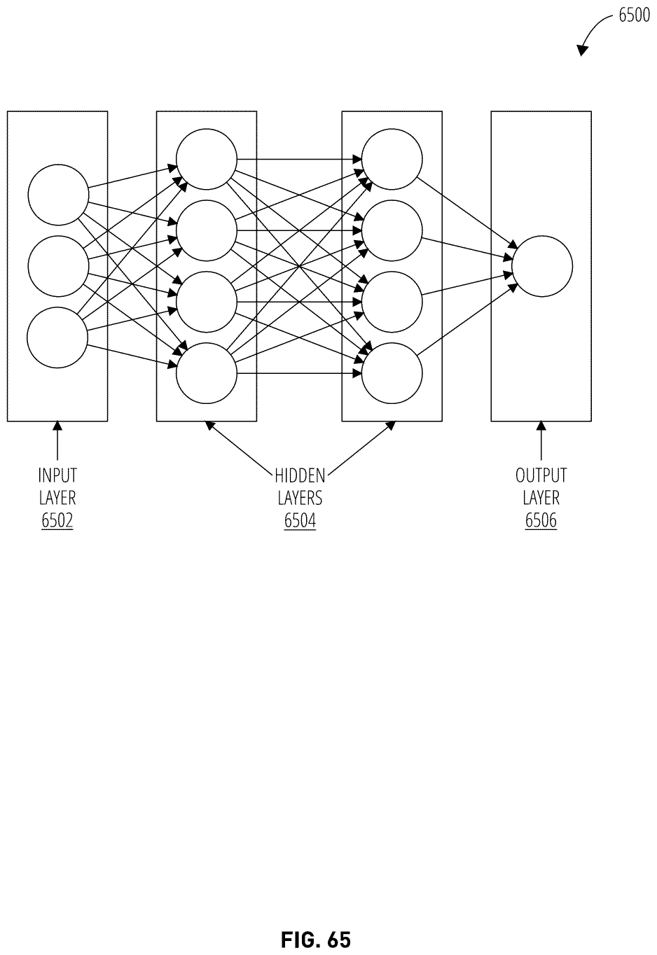

FIG. 63 illustrates the training and deployment of a deep neural network 6300, such as the basic deep neural network 6500 illustrated in FIG. 65, according to at least one embodiment. In at least one embodiment, untrained neural network 6306 is trained using a training dataset 6302. In at least one embodiment, training framework 6304 is a PyTorch framework, whereas in other embodiments, training framework 6304 is a TensorFlow, Boost, Caffe, Microsoft Cognitive Toolkit/CNTK, MXNet, Chainer, Keras, Deeplearning4j, or another training framework. In at least one embodiment, training framework 6304 trains an untrained neural network 6306 and allows it to be trained using processing resources described herein to generate a trained neural network 6308. In at least one embodiment, weights may be chosen randomly or by pre-training using a deep belief network. In at least one embodiment, training may be performed in either a supervised, partially supervised, or unsupervised manner.

In at least one embodiment, untrained neural network 6306 is trained using supervised learning, wherein training dataset 6302 includes an input paired with a desired output for the input, or where training dataset 6302 includes input having a known output and an output of untrained neural network 6306 is manually graded. In at least one embodiment, untrained neural network 6306 is trained in a supervised manner, processes inputs from training dataset 6302, and compares resulting outputs against a set of expected or desired outputs. In at least one embodiment, errors are then propagated back through untrained neural network 6306. In at least one embodiment, training framework 6304 adjusts weights that control untrained neural network 6306. In at least one embodiment, training framework 6304 includes tools to monitor how well untrained neural network 6306 is converging towards a model, such as trained neural network 6308, suitable to generating correct answers, such as in result 6312, based on input data such as a new dataset 6310. In at least one embodiment, training framework 6304 trains untrained neural network 6306 repeatedly while adjusting weights to refine an output of untrained neural network 6306 using a loss function and adjustment algorithm, such as stochastic gradient descent. In at least one embodiment, training framework 6304 trains untrained neural network 6306 until untrained neural network 6306 achieves the desired accuracy. In at least one embodiment, trained neural network 6308 may then be deployed to implement any number of machine learning operations.

In at least one embodiment, untrained neural network 6306 is trained using unsupervised learning, wherein untrained neural network 6306 attempts to train itself using unlabeled data. In at least one embodiment, an unsupervised learning training dataset 6302 will include input data without any associated output data or “ground truth” data. In at least one embodiment, untrained neural network 6306 may learn groupings within training dataset 6302 and may determine how individual inputs are related to other data in the training dataset 6302. In at least one embodiment, unsupervised training may be used to generate a self-organizing map in a trained neural network 6308 capable of performing operations useful in reducing the dimensionality of the new dataset 6310. In at least one embodiment, unsupervised training may also be used to perform anomaly detection, which allows the identification of data points in new dataset 6310 that deviate from normal patterns of new dataset 6310.

In at least one embodiment, semi-supervised learning may be used, which is a technique in which training dataset 6302 includes a mix of labeled and unlabeled data. In at least one embodiment, training framework 6304 may be used to perform incremental learning, such as through transferred learning techniques. In at least one embodiment, incremental learning allows trained neural network 6308 to adapt to new dataset 6310 without forgetting knowledge instilled within trained neural network 6308 during initial training. A trained neural network 6308 such as the one described may be used as the basis for AI and ML models such as may be used in computational systems to analyze complex data and provide results based on that analysis productive toward the improved knowledge or task action performance of people and computational and robotic systems.

The following figures set forth, without limitation, exemplary artificial intelligence-based systems that may be used to implement at least one embodiment.

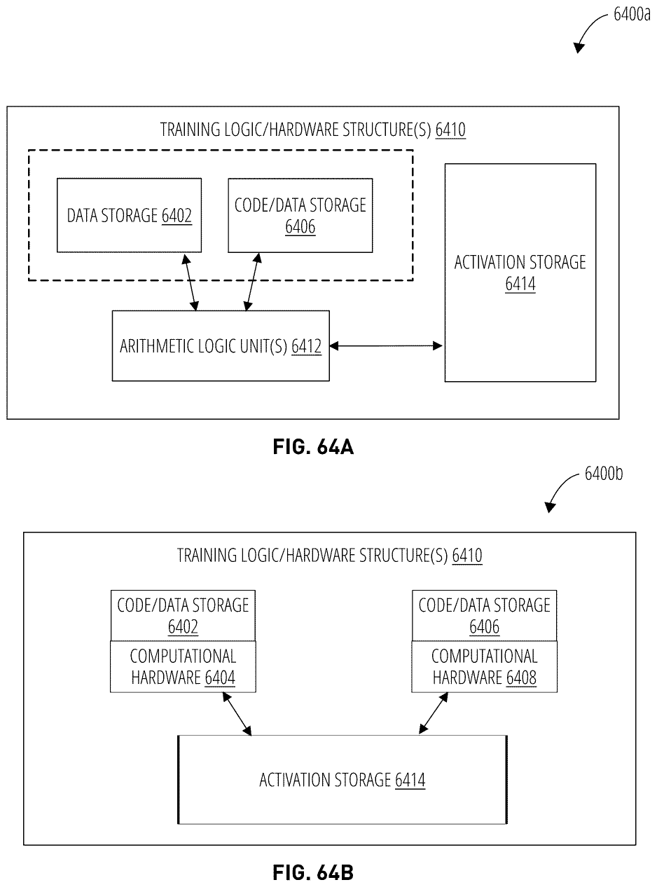

FIG. 64A illustrates inference/training logic 6400a used to perform inferencing and/or training operations associated with one or more embodiments. Details regarding training logic/hardware structure 6410 are provided below in conjunction with FIG. 64A and/or FIG. 64B.

In at least one embodiment, training logic/hardware structure 6410 may include, without limitation, code/data storage 6402 to store forward and/or output weight and/or input/output data, and/or other parameters to configure neurons or layers of a neural network trained and/or used for inferencing in aspects of one or more embodiments. In at least one embodiment, training logic/hardware structure 6410 may include or be coupled to code/data storage 6402 to store graph code or other software to control the timing and/or order in which weight and/or other parameter information is to be loaded to configure logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment code/data storage 6402 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code/data storage 6402 may be included with other on-chip or off-chip data storage, including a processor's L1, L2, or L3 cache or system memory.

In at least one embodiment, any portion of code/data storage 6402 may be internal or external to one or more processors or other hardware logic devices or circuits. In at least one embodiment, code/data storage 6402 may be cache memory, dynamic randomly addressable memory (DRAM), static randomly addressable memory (SRAM), non-volatile memory (e.g., flash memory), or other storage. In at least one embodiment, a choice of whether code/data storage 6402 is internal or external to a processor, for example, or comprising DRAM, SRAM, flash, or some other storage type may depend on available storage on-chip versus off-chip, latency needs of training and/or inferencing functions being performed, batch size of data used in inferencing and/or training of a neural network, or some combination of these factors.

In at least one embodiment, training logic/hardware structure 6410 may include, without limitation, a code/data storage 6406 to store backward and/or output weight and/or input/output data corresponding to neurons or layers of a neural network trained and/or used for inferencing in aspects of one or more embodiments. In at least one embodiment, code/data storage 6406 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic/hardware structure 6410 may include or be coupled to code/data storage 6406 to store graph code or other software to control the timing and/or order in which weight and/or other parameter information is to be loaded to configure logic, including integer and/or floating point units (collectively, arithmetic logic units (ALUs)).

In at least one embodiment, code, such as graph code, causes loading of weight or other parameter information into processor ALUs based on an architecture of a neural network to which such code corresponds. In at least one embodiment, any portion of code/data storage 6406 may be included with other on-chip or off-chip data storage, including a processor's L1, L2, or L3 cache or system memory. In at least one embodiment, any portion of code/data storage 6406 may be internal or external to one or more processors or other hardware logic devices or circuits. In at least one embodiment, code/data storage 6406 may be cache memory, DRAM, SRAM, non-volatile memory (e.g., flash memory), or other storage. In at least one embodiment, a choice of whether code/data storage 6406 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, code/data storage 6402 and code/data storage 6406 may be separate storage structures. In at least one embodiment, code/data storage 6402 and code/data storage 6406 may be a combined storage structure. In at least one embodiment, code/data storage 6402 and code/data storage 6406 may be partially combined and partially separate. In at least one embodiment, any portion of code/data storage 6402 and code/data storage 6406 may be included with other on-chip or off-chip data storage, including a processor's L1, L2, or L3 cache or system memory.

In at least one embodiment, training logic/hardware structure 6410 may include, without limitation, one or more arithmetic logic units 6412, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 6414 that are functions of input/output and/or weight parameter data stored in code/data storage 6402 and/or code/data storage 6406. In at least one embodiment, activations stored in activation storage 6414 are generated according to linear algebraic and or matrix-based mathematics performed by arithmetic logic units 6412 in response to performing instructions or other code, wherein weight values stored in code/data storage 6406 and/or code/data storage 6402 are used as operands along with other values, such as bias values, gradient information, momentum values, or other parameters or hyperparameters, any or all of which may be stored in code/data storage 6406 or code/data storage 6402 or another storage on or off-chip.

In at least one embodiment, arithmetic logic units 6412 are included within one or more processors or other hardware logic devices or circuits, whereas in another embodiment, arithmetic logic units 6412 may be external to a processor or other hardware logic device or circuit that uses them (e.g., a co-processor). In at least one embodiment, arithmetic logic units 6412 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or code/data storage 6402, code/data storage 6406, and activation storage 6414 may share a processor or other hardware logic device or circuit, whereas, in another embodiment, they may be in different processors or other hardware logic devices or circuits, or some combination of same and different processors or other hardware logic devices or circuits. In at least one embodiment, any portion of activation storage 6414 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logic circuits.

In at least one embodiment, activation storage 6414 may be cache memory, DRAM, SRAM, non-volatile memory (e.g., flash memory), or other storage. In at least one embodiment, activation storage 6414 may be completely or partially within or external to one or more processors or other logic circuits. In at least one embodiment, a choice of whether activation storage 6414 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, the training logic/hardware structure 6410 illustrated in FIG. 64A may be used in conjunction with an application-specific integrated circuit (ASIC), such as a TensorFlow® Processing Unit from Google, an inference processing unit (IPU) from Graphcore™, or a Nervana® (e.g., “Lake Crest) processor from Intel Corp. In at least one embodiment, the training logic/hardware structure 6410 illustrated in FIG. 64A may be used in conjunction with central processing unit (CPU) hardware, graphics processing unit (GPU) hardware, or other hardware, such as field programmable gate arrays (FPGAs).

FIG. 64B illustrates inference/training logic 6400b, according to at least one embodiment. In at least one embodiment, training logic/hardware structure 6410 may include, without limitation, hardware logic in which computational resources are dedicated or otherwise exclusively used in conjunction with weight values or other information corresponding to one or more layers of neurons within a neural network. In at least one embodiment, the training logic/hardware structure 6410 illustrated in FIG. 64B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, the training logic/hardware structure 6410 illustrated in FIG. 64B may be used in conjunction with central processing unit (CPU) hardware, graphics processing unit (GPU) hardware, or other hardware, such as field programmable gate arrays (FPGAs). In at least one embodiment, training logic/hardware structure 6410 includes, without limitation, code/data storage 6402 and code/data storage 6406, which may be used to store code (e.g., graph code), weight values and/or other information, including bias values, gradient information, momentum values, and/or other parameter or hyperparameter information. In at least one embodiment illustrated in FIG. 64B, each of code/data storage 6402 and code/data storage 6406 is associated with a dedicated computational resource, such as computational hardware 6404 and computational hardware 6408, respectively. In at least one embodiment, each of computational hardware 6404 and computational hardware 6408 comprises one or more ALUs that perform mathematical functions, such as linear algebraic functions, on information stored in code/data storage 6402 and code/data storage 6406, respectively, the result of which is stored in activation storage 6414.

In at least one embodiment, each of code/data storage 6402 and 6406 and corresponding computational hardware 6404 and 6408, respectively, correspond to different layers of a neural network, such that resulting activation from one storage/computational pair 6402/6404 of code/data storage 6402 and computational hardware 6404 is provided as an input to a next storage/computational pair 6406/6408 of code/data storage 6406 and computational hardware 6408, in order to mirror a conceptual organization of a neural network. In at least one embodiment, each of the storage/computational pairs 6402/6404 and 6406/6408 may correspond to more than one neural network layer. In at least one embodiment, additional storage/computation pairs (not shown) subsequent to or in parallel with storage/computation pairs 6402/6404 and 6406/6408 may be included in training logic/hardware structure 6410.

FIG. 65 illustrates a basic deep neural network 6500 in accordance with one embodiment. A basic deep neural network 6500 is based on a collection of connected units or nodes called artificial neurons which loosely model the neurons in a biological brain. Each connection, like the synapses in a biological brain, may transmit a signal from one artificial neuron to another. An artificial neuron that receives a signal may process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is sent if the aggregate signal crosses that threshold. Typically, artificial neurons are aggregated into layers. Different layers may perform different kinds of transformations on their inputs. Signals travel from the first layer (the input layer 6502), to the last layer (the output layer 6506), possibly after traversing one or more intermediate layers, called hidden layers 6504.

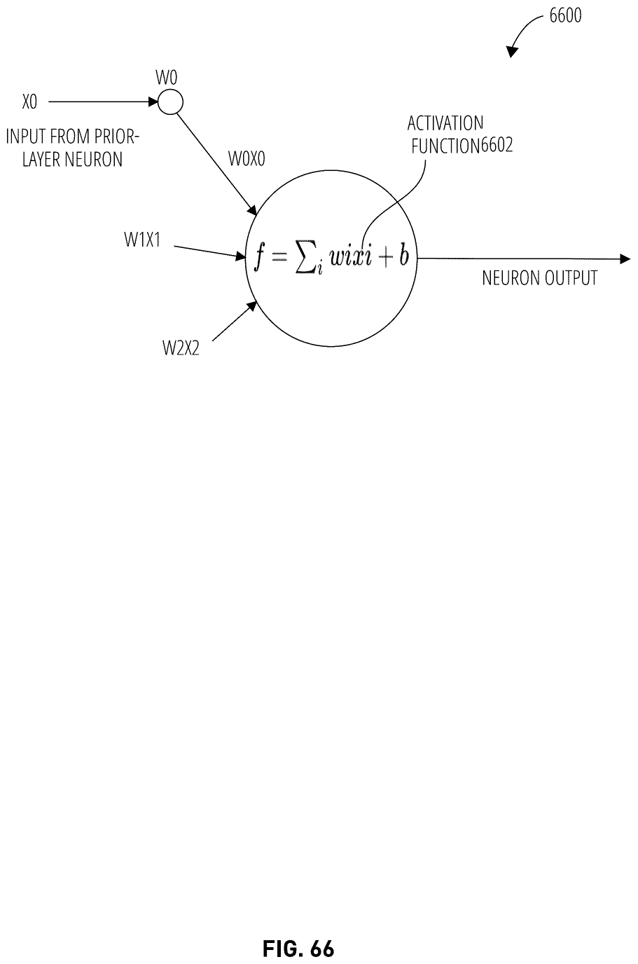

Referring to FIG. 66, an artificial neuron 6600 receiving inputs from predecessor neurons consists of the following components:
inputs xᵢ;
weights wᵢ applied to the inputs;
an optional threshold (b), which stays fixed unless changed by a learning function; and
an activation function 6602 that computes the output from the previous neuron inputs and threshold, if any.

An input neuron has no predecessor but serves as input interface for the whole network of artificial neurons 6600, such as may form a basic deep neural network 6500. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 6602 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

FIG. 67 illustrates an exemplary convolutional neural network 6700. The convolutional neural network 6700 arranges its neurons in three dimensions (width, height, depth), as visualized in convolutional layer 6702. Every layer of the convolutional neural network 6700 transforms a 3D volume of inputs to a 3D output volume of neuron activations. In this example, the input layer 6704 encodes the image, so its width and height would be the dimensions of the image, and the depth would be 3 (Red, Green, Blue channels). The convolutional layer 6702 further transforms the outputs of the input layer 6704, and the output layer 6706 transforms the outputs of the convolutional layer 6702 into one or more classifications of the image content.

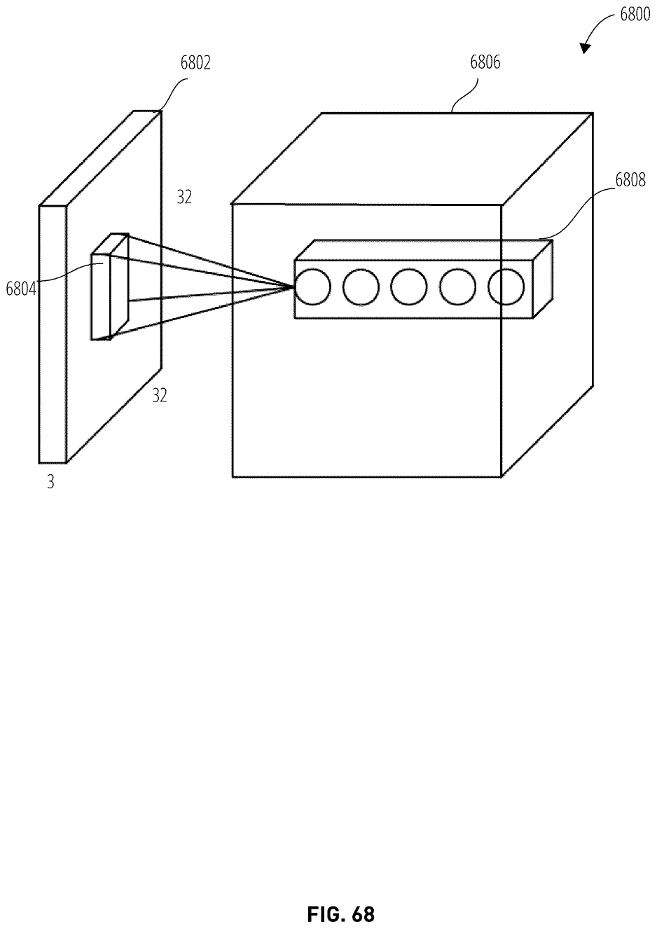

FIG. 68 illustrates an exemplary convolutional neural network layers 6800 in more detail. An example subregion of the input layer region 6804 of an input layer region 6802 region of an image is analyzed by a set of convolutional layer subregion 6808 in the convolutional layer 6806. The input layer region 6802 is 32×32 neurons long and wide (e.g., 32×32 pixels), and three neurons deep (e.g., three color channels per pixel). Each neuron in the convolutional layer 6806 is connected to a local region in the input layer region 6802 spatially (in height and width), but to the full depth (i.e. all color channels if the input is an image). Note, there are multiple neurons (five in this example) along the depth of the convolutional layer subregion 6808 that analyzes the subregion of the input layer region 6804 of the input layer region 6802, in which each neuron of the convolutional layer subregion 6808 may receive inputs from every neuron of the subregion of the input layer region 6804.

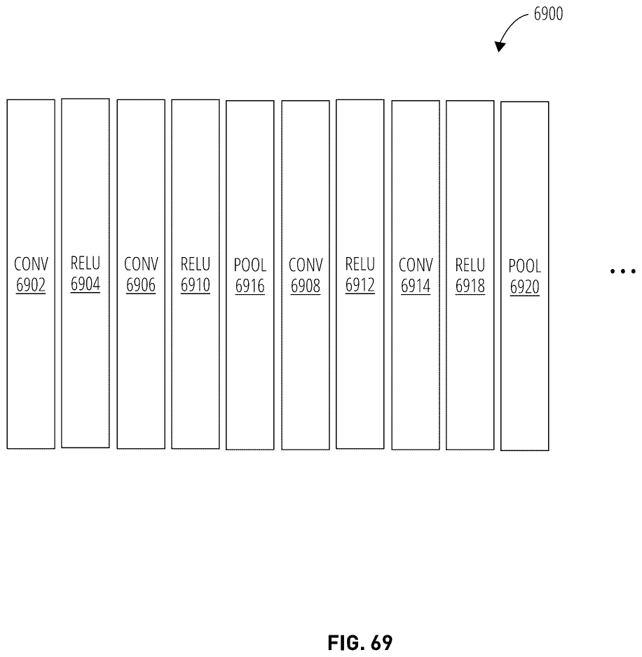

FIG. 69 illustrates a popular form of a CNN known as a VGG net 6900. The initial convolution layer 6902 stores the raw image pixels and the final pooling layer 6920 determines the class scores. Each of the intermediate convolution layers (convolution layer 6906, convolution layer 6908, and convolution layer 6914) and rectifier activations (RELU layer 6904, RELU layer 6910, RELU layer 6912, and RELU layer 6918) and intermediate pooling layers (pooling layer 6916, pooling layer 6920) along the processing path is shown as a column.

The VGG net 6900 replaces the large single-layer filters of basic CNNs with multiple 3×3 sized filters in series. With a given receptive field (the effective area size of input image on which output depends), multiple stacked smaller size filters may perform better at image feature classification than a single layer with a larger filter size, because multiple non-linear layers increase the depth of the network which enables it to learn more complex features. In a VGG net 6900 each pooling layer may be as small as 2×2.

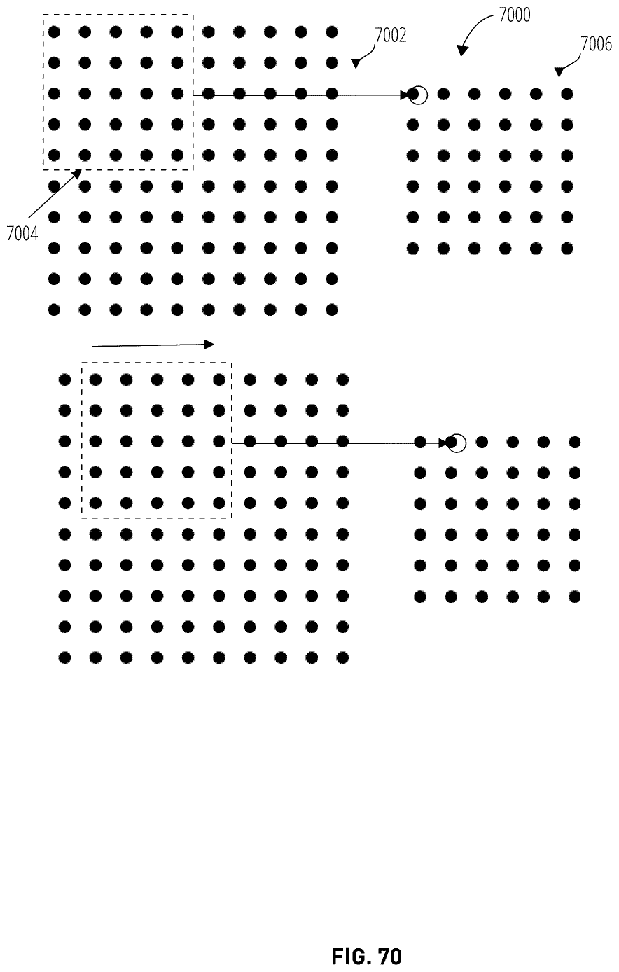

FIG. 70 illustrates a convolution layer filtering 7000 that connects the outputs from groups of neurons in a convolution layer 7002 to neurons in a next layer 7006. A receptive field is defined for the convolution layer 7002, in this example sets of 5×5 neurons. The collective outputs of each neuron the receptive field are weighted and mapped to a single neuron in the next layer 7006. This weighted mapping is referred to as the filter 7004 for the convolution layer 7002 (or sometimes referred to as the kernel of the convolution layer 7002). The filter 7004 depth is not illustrated in this example (i.e., the filter 7004 is actually a cubic volume of neurons in the convolution layer 7002, not a square as illustrated). Thus what is shown is a “slice” of the full filter 7004. The filter 7004 is slid, or convolved, around the input image, each time mapping to a different neuron in the next layer 7006. For example FIG. 70 shows how the filter 7004 is stepped to the right by 1 unit (the “stride”), creating a slightly offset receptive field from the top one, and mapping its output to the next neuron in the next layer 7006. The stride can be and often is other numbers besides one, with larger strides reducing the overlaps in the receptive fields, and hence further reducing the size of the next layer 7006. Every unique receptive field in the convolution layer 7002 that can be defined in this stepwise manner maps to a different neuron in the next layer 7006. Thus, if the convolution layer 7002 is 32×32×3 neurons per slice, the next layer 7006 may be as small as 28×28×1 neurons to cover all the receptive fields of the convolution layer 7002. This is referred to as an activation map or feature map. There is thus a reduction in layer complexity from the filtering. There are 784 different ways that a 5×5 filter can uniquely fit on a 32×32 convolution layer 7002, so the next layer 7006 may be 28×28. The depth of the convolution layer 7002 is also reduced from 3 to 1 in the next layer 7006.

The number of total layers to use in a CNN, the number of convolution layers, the filter sizes, and the values for strides at each layer are examples of “hyperparameters” of the CNN.

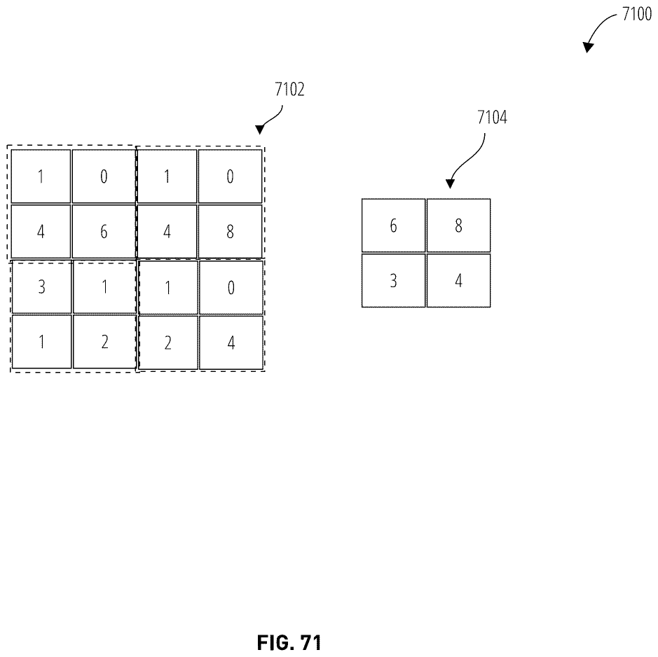

FIG. 71 illustrates a pooling layer function 7100 with a 2×2 receptive field and a stride of two. The pooling layer function 7100 is an example of the maxpool pooling technique. The outputs of all the neurons in a particular receptive field of the input layer 7102 are replaced by the maximum valued one of those outputs in the pooling layer 7104. Other options for pooling layers are average pooling and L2-norm pooling. The reason to use a pooling layer is that once a specific feature is recognized in the original input volume (there will be a high activation value), its exact location is not as important as its relative location to the other features. Pooling layers can drastically reduce the spatial dimension of the input layer 7102 from that point forward in the neural network (the length and the width change but not the depth). This serves two main purposes. The first is that the amount of parameters or weights is greatly reduced thus lessening the computation cost. The second is that it will control overfitting. Overfitting refers to when a model is so tuned to the training examples that it is not able to generalize well when applied to live data sets.

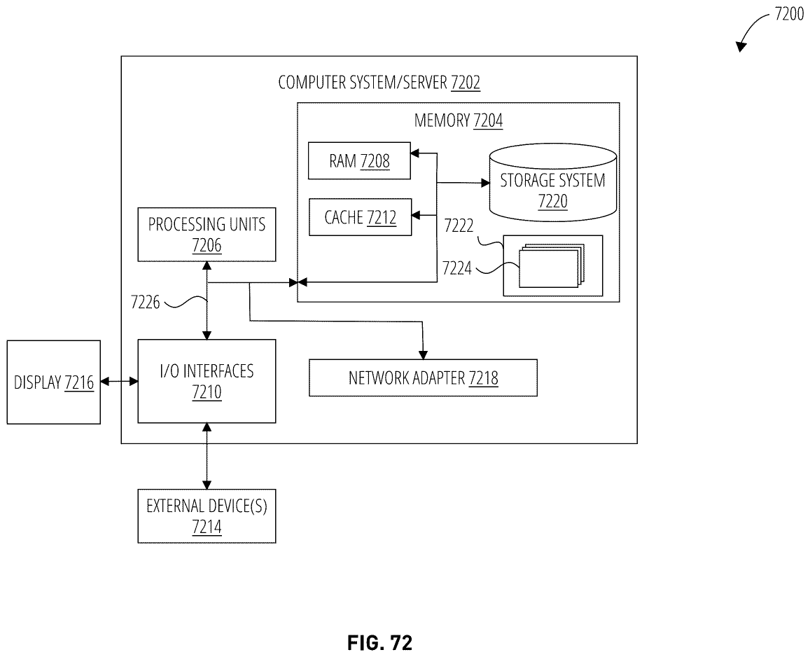

As shown in FIG. 72, computer system/server 7202 in cloud computing node 7200 is shown in the form of a general-purpose computing device. The components of computer system/server 7202 may include, but are not limited to, one or more processors or processing units 7206, a system memory 7204, and a bus 7226 that couples various system components, including system memory 7204, to processing units 7206.

Bus 7226 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 7202 typically includes a variety of computer system readable media. Such media may be any available media that is accessible by computer system/server 7202, and it includes both volatile and non-volatile media, removable and non-removable media.

System memory 7204 may include computer system readable media in the form of volatile memory, such as Random access memory (RAM) 7208 and/or cache memory 7212. Computer system/server 7202 may further include other removable/non-removable, volatile/non-volatile computer system storage media. By way of example, a storage system 7220 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media may be provided. In such instances, each may be connected to bus 7226 by one or more data media interfaces. As will be further depicted and described below, system memory 7204 may include at least one program product having a set (e.g., at least one) of program modules that are configured to carry out the functions of the present disclosure.

Program/utility 7222 having a set (at least one) of program modules 7224 may be stored in system memory 7204 by way of example, and not limitation, as well as an operating system, one or more application programs, other program modules, and program data. Each of the operating system, one or more application programs, other program modules, and program data or some combination thereof, may include an implementation of a networking environment. Program modules 7224 generally carry out the functions and/or methodologies of the present disclosure as described herein.

Computer system/server 7202 may also communicate with one or more external devices 7214 such as a keyboard, a pointing device, a display 7216, etc.; one or more devices that allow a user to interact with computer system/server 7202; and/or any devices (e.g., network card, modem, etc.) that allow computer system/server 7202 to communicate with one or more other computing devices. Such communication may occur via I/O interfaces 7210. Computer system/server 7202 may communicate with one or more networks such as a local area network (LAN), a general wide area network (WAN), and/or a public network (e.g., the Internet) via network adapter 7218. As depicted, network adapter 7218 communicates with the other components of computer system/server 7202 via bus 7226. It may readily be understood that although not shown, other hardware and/or software components may be used in conjunction with computer system/server 7202. Examples include, but are not limited to: microcode, device drivers, redundant processing units, external disk drive arrays, RAID systems, tape drives, and data archival storage systems, etc.

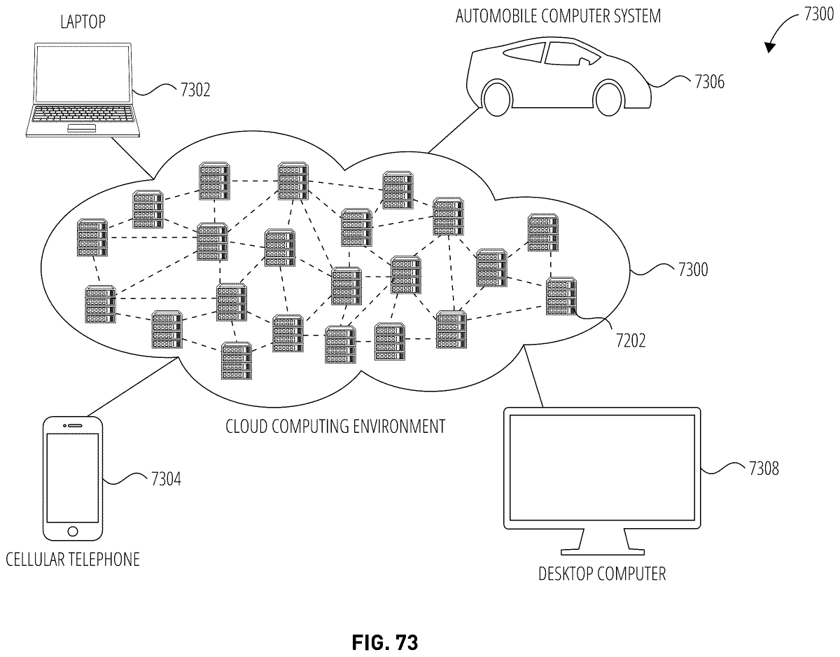

Referring now to FIG. 73, illustrative cloud computing environment 7300 is depicted. As shown, cloud computing environment 7300 comprises one or more cloud computing nodes 7200 with which computing devices such as, for example, a laptop 7302, a personal digital assistant (PDA) or cellular telephone 7304, an automobile computer system 7306, and/or a desktop computer 7308 may communicate. This allows for infrastructure, platforms, and/or software to be offered as services from cloud computing environment 7300, so that each client need not separately maintain such resources. It is understood that the types of computing devices shown in FIG. 73 are intended to be illustrative and that a cloud computing environment 7300 may communicate with any type of computerized device over any type of network and/or network/addressable connection (e.g., using a web browser).

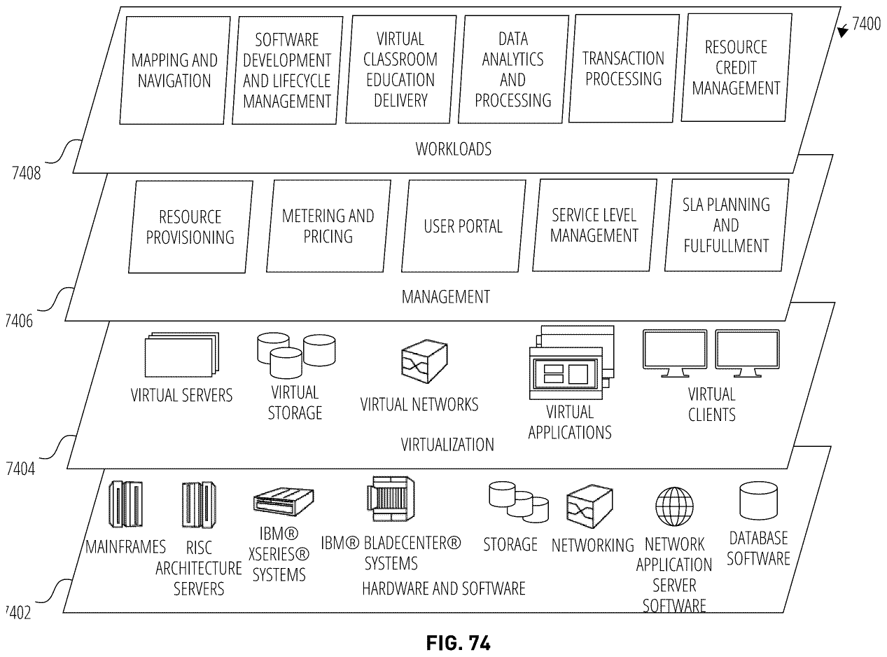

Referring now to FIG. 74, a set of functional abstraction layers provided by a cloud computing environment 7300 such as is illustrated in FIG. 73. It may be understood in advance that the components, layers, and functions shown in FIG. 74 are intended to be illustrative, and the present disclosure is not limited thereto. As depicted, the following layers and corresponding functions are provided:

Hardware and software layer 7402 includes hardware and software components. Examples of hardware components include mainframes. In one example, IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation in the United States, other countries, or both.)

Virtualization layer 7404 provides an abstraction layer from which the following exemplary virtual entities may be provided: virtual servers; virtual storage; virtual networks, including virtual private networks; virtual applications; and virtual clients.

Management layer 7406 provides the exemplary functions described below. Resource provisioning provides dynamic procurement of computing resources and other resources that are utilized to perform tasks within the Cloud computing environment. Metering and Pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that desired service levels are met. Service Level Agreement (SLA) planning and fulfillment provides pre-arrangement for, and procurement of, Cloud computing resources for which a future need is anticipated in accordance with an SLA.

Workloads layer 7408 provides functionality for which the Cloud computing environment is utilized. Examples of workloads and functions which may be provided from this layer include: mapping and navigation; software development and lifecycle management; virtual classroom education delivery; data analytics processing; transaction processing; and resource credit management. As mentioned above, all of the foregoing examples described with respect to FIG. 74 are illustrative, and the present disclosure is not limited to these examples.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A method comprising:
identifying objects and parts of the objects in an imaged environment of a tidying robot;
wherein the tidying robot is configured with:
a chassis;
a capture and containment system including:
a scoop;
pusher pads including a first pusher pad and a second pusher pad;
pusher pad arms including a first pusher pad arm and a second pusher pad arm;
a gripper arm;
a lifting column configured to raise and lower the capture and containment system through extension and retraction of a lifting column linear actuator;
detecting landmarks on the objects and the parts of the objects, wherein the landmarks are distinctive points;
highlighting the landmarks detected, using affordance heatmaps, where robot actions can be executed to manipulate the objects and the parts of the objects;
determining tasks needed to complete a work strategy in the imaged environment;
evaluating the attributes of a task step;
selecting, using a keypoint solver, specific contact or manipulation points available under step constraints;
identifying, using a motion planner, robot motions that will perform the robot actions of the task step by engaging the contact or manipulation points;
recording, using a state updater, task progress;
logging task step success or task step failure.

2. The method of claim 1, further comprising:
receiving, by an artificial intelligence (AI) model, skill definition data,
wherein a skill is a stored series of robot actions and action parameters by which the tidying robot completes the task step, and
wherein the skill definition data includes a skill name, a skill start condition, a skill success condition, and at least one skill failure condition;
receiving, by the AI model, skill input data representing a target environment in which the skill is to be performed, wherein the skill input data includes depth measurement data;
collecting at least one successful demonstration of the skill, wherein the skill is executed and the skill success condition is detected;
saving the series of robot actions performed during the at least one successful demonstration as a learned skill;
configuring, with the AI model, a robotic control system of the tidying robot with the learned skill; and
invoking, by the AI model, a performance of the learned skill by the tidying robot.

3. The method of claim 2, wherein the skill input data further includes at least one of image data, segmented image data, robot state data, and force feedback data.

4. The method of claim 2, further comprising at least one of:
configuring the AI model with a common feature set for use in performing a plurality of skills,
wherein the common feature set includes at least one of a distance between a target object and a target region, a maximum alignment error, contact force magnitude, a distance to an obstacle, a joint limit margin, and a motion smoothness, and
wherein the common feature set is computed from the skill input data;
computing the common feature set from the skill input data; and
computing at least one of an end effector delta pose and a gripper command using the skill input data.

5. The method of claim 2, further comprising:
collecting at least one failed demonstration of the skill, wherein the skill is executed and the at least one skill failure condition is detected; and
using the at least one failed demonstration to guide improvement of the AI model.

6. The method of claim 5, wherein at least one of the at least one successful demonstration and the at least one failed demonstration is collected as the tidying robot iterates upon performing the learned skill during at least one of autonomous operation and semi-autonomous operation in a controlled target environment.

7. The method of claim 5, wherein at least one of the at least one successful demonstration and the at least one failed demonstration is collected as the AI model invokes execution of the skill in a simulation environment.

8. The method of claim 5, further comprising:
performing learned skills in a modified target environment that includes at least one of:
a new environment layout; and
new target objects;
collecting and retaining additional successful demonstrations and additional failed demonstrations; and
using the additional successful demonstrations and the additional failed demonstrations to guide improvement of the AI model.

9. The method of claim 2, further comprising:
wherein the skill definition data includes at least one natural language command by which the AI model directs the tidying robot to perform the skill;
wherein the skill input data includes a natural language embedding;
collecting at least one failed demonstration of the skill, wherein the skill is executed and the at least one skill failure condition is detected; and
using the at least one failed demonstration to guide improvement of the AI model;
wherein the at least one skill failure condition includes a negative natural language command experience, including:
correct tidying robot motions paired with an incorrect natural language command;
selection of a wrong target object in response to the natural language command;
execution of the wrong skill in response to the natural language command;
failure to execute the skill in response to an unfamiliar phrasing of the natural language command;
detection of a collision; and
application of excessive force by an actuator of the tidying robot.

10. A method comprising:
receiving, by an artificial intelligence (AI) model, skill definition data,
wherein a skill is a stored series of robot actions and action parameters by which a tidying robot completes a task step, and
wherein the skill definition data includes a skill name, a skill start condition, a skill success condition, and at least one skill failure condition;
receiving, by the AI model, skill input data representing a target environment in which the skill is to be performed, wherein the skill input data includes depth measurement data;
collecting at least one successful demonstration of the skill, wherein the skill is executed and the skill success condition is detected;
saving the series of robot actions performed during the at least one successful demonstration as a learned skill;
configuring, with the AI model, a robotic control system of the tidying robot with the learned skill, the tidying robot comprising:
a chassis;
a capture and containment system including:
a scoop;
pusher pads including a first pusher pad and a second pusher pad;
pusher pad arms including a first pusher pad arm and a second pusher pad arm;
a gripper arm; and
a lifting column configured to raise and lower the capture and containment system through extension and retraction of a lifting column linear actuator; and
invoking, by the AI model, a performance of the learned skill by the tidying robot.

11. The method of claim 10, wherein the skill input data further includes at least one of image data, segmented image data, robot state data, and force feedback data.

12. The method of claim 10, further comprising at least one of:
configuring the AI model with a common feature set for use in performing a plurality of skills,
wherein the common feature set includes at least one of a distance between a target object and a target region, a maximum alignment error, contact force magnitude, a distance to an obstacle, a joint limit margin, and a motion smoothness, and
wherein the common feature set is computed from the skill input data;
computing the common feature set from the skill input data; and
computing at least one of an end effector delta pose and a gripper command using the skill input data.

13. The method of claim 10, further comprising:
collecting at least one failed demonstration of the skill, wherein the skill is executed and the at least one skill failure condition is detected; and
using the at least one failed demonstration to guide improvement of the AI model.

14. The method of claim 13, wherein at least one of the at least one successful demonstration and the at least one failed demonstration is collected by:
receiving, by the tidying robot, a series of external control signals directing the tidying robot through execution of the skill;
recording real-time skill input data updates as the skill is executed by the tidying robot; and
providing the real-time skill input data updates to the AI model as real-time feedback.

15. The method of claim 13, wherein at least one of the at least one successful demonstration and the at least one failed demonstration is collected as the tidying robot iterates upon performing the learned skill during at least one of autonomous operation and semi-autonomous operation in a controlled target environment.

16. The method of claim 13, wherein at least one of the at least one successful demonstration and the at least one failed demonstration is collected as the AI model invokes execution of the skill in a simulation environment.

17. The method of claim 13, further comprising:
performing learned skills in a modified target environment that includes at least one of:
a new environment layout; and
new target objects;
collecting and retaining additional successful demonstrations and additional failed demonstrations; and
using the additional successful demonstrations and the additional failed demonstrations to guide improvement of the AI model.

18. The method of claim 10, wherein the skill definition data includes at least one natural language command by which the AI model directs the tidying robot to perform the skill; and
wherein the skill input data includes a natural language embedding.

19. The method of claim 18, further comprising:
collecting at least one failed demonstration of the skill, wherein the skill is executed and the at least one skill failure condition is detected; and
using the at least one failed demonstration to guide improvement of the AI model;
wherein the at least one skill failure condition includes a negative natural language command experience, including:
correct tidying robot motions paired with an incorrect natural language command;
selection of a wrong target object in response to the natural language command;
execution of the wrong skill in response to the natural language command;
failure to execute the skill in response to an unfamiliar phrasing of the natural language command;
detection of a collision; and
application of excessive force by an actuator of the tidying robot.

20. The method of claim 10, further comprising:
receiving, by the AI model, at least one of an external approval signal and an external rejection signal; and
refining, by the AI model, the learned skill using the at least one of the external approval signal and the external rejection signal.
